(19) United States
(12) Patent Application Publication
(10) Pub. No.: US 2025/0181319 A1
(43) Pub. Date: Jun. 5, 2025

(54) TECHNIQUES FOR RESOLVING DATA FIELDS AVAILABLE AT POINTS IN A SOFTWARE APPLICATION

(71) Applicant: Ab Initio Technology LLC, Lexington, MA (US)

(72) Inventors: Garth Allen Dickie, Framingham, MA (US); Luke Bryant Sciarappa, Somerville, MA (US); Zachary James Miller, Los Angeles, CA (US); Ian Robert Schechter, Sharon, MA (US)

(21) Appl. No.: 18/964,167

(22) Filed: Nov. 29, 2024

Related U.S. Application Data
(60) Provisional application No. 63/642,380, filed on May 3, 2024.
(60) Provisional application No. 63/605,456, filed on Dec. 1, 2023.

(51) Int. Cl. G06F 8/33; G06F 8/34

(52) U.S. Cl. CPC G06F 8/33; G06F 8/34

(57) ABSTRACT

Some embodiments relate to generating a list of data fields referenceable at a point in a graph (there are different lists for each point). This list may be used as part of programming a dataflow graph to select data (e.g., at an input node of a component to select data processed in that component). One aspect relates to display of the list of data fields, because some of the data field names may be overloaded. Accordingly, the data fields may be presented hierarchically if necessary, showing the source for each overloaded data field name. Otherwise, the user may select whether the list of referenceable fields is grouped by source.

### CROSS-REFERENCE TO RELATED APPLICATIONS

This application claims priority to and the benefit of U.S. Provisional Patent Application No. 63/642,380, filed on May 3, 2024, entitled “TECHNIQUES FOR RESOLVING DATA FIELDS AVAILABLE AT POINTS IN A SOFTWARE APPLICATION.” This application also claims priority to and the benefit of U.S. Provisional Patent Application No. 63/605,456, filed on Dec. 1, 2023, entitled “TECHNIQUES FOR RESOLVING DATA FIELDS AVAILABLE AT POINTS IN A SOFTWARE APPLICATION.” The contents of these applications are incorporated herein by reference in their entirety.

### FIELD

Aspects of the present disclosure relate to techniques for enabling the efficient development of data processing applications in a programming environment in which software applications are developed as dataflow graphs. In a graphical user interface (GUI) in which a user provides input specifying a dataflow graph representing a software application, the techniques dynamically determine valid data fields available at different points in the dataflow graph for use in operations.

### BACKGROUND

Modern data processing systems manage vast amounts of data (e.g., millions, billions, or trillions of data records) and manage how these data may be accessed (e.g., created, updated, read, or deleted). A large institution (e.g., a multinational bank, global technology company, etc.) may have millions of datasets. For example, the datasets may store transaction records, documents, tables, files, or any other suitable type of data. As another example, the datasets may store “metadata” which is data that contains information about other data (e.g., stored in the same data processing system and/or another data processing system) and/or processes (e.g., in the same data processing system and/or another data processing system). For example, a data processing system may store metadata about credit card transaction data stored in a table of a credit card company's database. Non-limiting examples of such metadata include information indicating the size of the table in memory, when the table was created, when the table was last updated, the number of rows and/or columns in the table, where the table is stored, who has permission to read, update, delete and/or perform any other suitable action(s) with respect to the table, and/or a description of data stored in the table.

A data processing system may execute software applications to support various functions. The software applications may perform operations using data from datasets as part of executing such functions. For example, a company may develop software application programs to analyze transaction data. As another example, a bank may develop software application programs that support various aspects of its business such as programs that generate credit reports, bank account history, transaction reports, and/or other data. Software applications may also be used to extract information from datasets.

A software application may perform operations using data stored in one or more fields of one or more datasets. A field of a dataset may also be referred to herein as a “data field”. For example, a data field may be represented by a column in a table. As another example, a data field may be an attribute for which values are stored in documents (e.g., JSON files, XML files, and/or other documents). A software application may access values from a data field to perform operations. For example, a software application for an e-commerce website may access a data table column storing transaction values over a time period to perform operations using the transaction values.

When writing an application, a programmer may need to specify the data to be used in a particular operation. This can be complicated especially when there are many datasets, each with many fields. This complexity is further compounded if fields in different datasets share the same names, which frequently occurs when data processing is being performed with multiple datasets. Moreover, processes in the application may modify values associated with a field such that the values associated with the same field may have different values in different portions of the application.

Incorrectly specifying a data field to be used in a particular operation can lead to unintended or incorrect results when the application is executed.

### SUMMARY

Some embodiments relate to generating a listing of references to data fields that are available at a point in a dataflow graph specifying a software application. This list may be used as part of programming the dataflow graph to specify data fields that are to be used in operations of the dataflow graph.

One aspect relates to the display of the listing of references to data fields. In some cases, there may be ambiguity as to which data field a data field name refers to (e.g., because the name is shared by multiple different data fields from different datasets, or a data field flows through multiple paths in a dataflow graph that result in different versions of the data field). Accordingly, the references to the data fields may be presented to disambiguate data fields from one another if necessary (e.g., by displaying a hierarchical listing that indicates a source of data fields with names that may be ambiguous). Otherwise, the user may select whether the list of referenceable fields is grouped by source.

A second aspect is what is included within the concept of the “source” of data fields when generating the list of references to data fields available at a point. A source may refer to a dataset or one or more upstream components in a dataflow graph. For example, the records in a data source containing a named field may be different than the records read from that field and then processed through a join or filter component, even though the processed records have the same named field that originated from the same data source. Accordingly, presenting the same named field that arrives at a point from different paths is necessary for ensuring that the graph is programmed to produce the desired result.

Some embodiments provide a method, performed by a data processing system, for efficient development of a software application program that processes data from one or more datasets, the software application program developed as a dataflow graph having components representing operations and links representing flows of data. The method comprises using at least one computer hardware processor to perform: providing a graphical development environment configured to receive user input specifying one or more data fields to use at one or more points in the dataflow graph, the graphical development environment including a graphical user interface (GUI) displaying the dataflow graph; processing a topology of at least a portion of the dataflow graph upstream of a point in the dataflow graph to identify a plurality of data fields available at the point in the dataflow graph; presenting, in the GUI, references to the plurality of data fields available at the point in the dataflow graph, the presenting comprising: identifying one or more paths through one or more of the components of the dataflow graph by which the plurality of data fields reaches the point; and generating a display of the references to the plurality of data fields based on the one or more paths through one or more of the components of the dataflow graph by which the plurality of data fields reaches the point.

Some embodiments provide a system for efficient development of a software application program that processes data from one or more datasets, the software application program developed as a dataflow graph having components representing operations and links representing flows of data. The system comprising at least one computer hardware processor configured to perform: providing a graphical development environment configured to receive user input specifying one or more data fields to use at one or more points in the dataflow graph, the graphical development environment including a graphical user interface (GUI) displaying the dataflow graph; processing a topology of at least a portion of the dataflow graph upstream of a point in the dataflow graph to identify a plurality of data fields available at the point in the dataflow graph; presenting, in the GUI, references to the plurality of data fields available at the point in the dataflow graph, the presenting comprising: identifying one or more paths through one or more of the components of the dataflow graph by which the plurality of data fields reaches the point; and generating a display of the references to the plurality of data fields based on the one or more paths through one or more of the components of the dataflow graph by which the plurality of data fields reaches the point.

Some embodiments provide a non-transitory computer-readable storage medium storing instructions that, when executed by at least one computer hardware processor, cause the at least one computer hardware processor to perform a method comprising: providing a graphical development environment configured to receive user input specifying one or more data fields to use at one or more points in the dataflow graph, the graphical development environment including a graphical user interface (GUI) displaying the dataflow graph; processing a topology of at least a portion of the dataflow graph upstream of a point in the dataflow graph to identify a plurality of data fields available at the point in the dataflow graph; presenting, in the GUI, references to the plurality of data fields available at the point in the dataflow graph, the presenting comprising: identifying one or more paths through one or more of the components of the dataflow graph by which the plurality of data fields reaches the point; and generating a display of the references to the plurality of data fields based on the one or more paths through one or more of the components of the dataflow graph by which the plurality of data fields reaches the point.

Some embodiments provide a method, performed by a data processing system, for efficient development of a software application program that processes data from one or more datasets, the software application program developed as a dataflow graph having components representing operations and links representing flows of data. The method comprises using at least one computer hardware processor to perform: providing a graphical development environment configured to receive user input specifying one or more data fields to use at one or more points in the dataflow graph, the graphical development environment including a graphical user interface (GUI) displaying the dataflow graph; processing a topology of at least a portion of the dataflow graph upstream of a point in the dataflow graph to identify a plurality of data fields available at the point in the dataflow graph, the processing comprising: identifying different paths in the dataflow graph by which two of the plurality of data fields reach the point, the two data fields sharing a common name; and differentiating between the two data fields based on the different paths by which the two data fields reach the point.

Some embodiments provide a system for efficient development of a software application program that processes data from one or more datasets, the software application program developed as a dataflow graph having components representing operations and links representing flows of data. The system comprising at least one computer hardware processor configured to perform: providing a graphical development environment configured to receive user input specifying one or more data fields to use at one or more points in the dataflow graph, the graphical development environment including a graphical user interface (GUI) displaying the dataflow graph; processing a topology of at least a portion of the dataflow graph upstream of a point in the dataflow graph to identify a plurality of data fields available at the point in the dataflow graph, the processing comprising: identifying different paths in the dataflow graph by which two of the plurality of data fields reach the point, the two data fields sharing a common name; and differentiating between the two data fields based on the different paths by which the two data fields reach the point.

Some embodiments provide a non-transitory computer-readable storage medium storing instructions that, when executed by at least one computer hardware processor, cause the at least one computer hardware processor to perform a method comprising: providing a graphical development environment configured to receive user input specifying one or more data fields to use at one or more points in the dataflow graph, the graphical development environment including a graphical user interface (GUI) displaying the dataflow graph; processing a topology of at least a portion of the dataflow graph upstream of a point in the dataflow graph to identify a plurality of data fields available at the point in the dataflow graph, the processing comprising: identifying different paths in the dataflow graph by which two of the plurality of data fields reach the point, the two data fields sharing a common name; and differentiating between the two data fields based on the different paths by which the two data fields reach the point.

Some embodiments provide a method, performed by a data processing system, for efficient development of a software application program that processes data from one or more datasets, the software application program developed as a dataflow graph having components representing operations and links representing flows of data. The method comprises using at least one computer hardware processor to perform: providing a graphical development environment configured to receive user input specifying one or more data fields to use at one or more point in the dataflow graph, the graphical development environment including a graphical user interface (GUI) displaying the dataflow graph; processing a topology of at least a portion of the dataflow graph upstream of a point in the dataflow graph to identify a plurality of data fields available at the point, the processing comprising: generating a data structure indicating one or more paths through one or more components of the dataflow graph by which the plurality of data fields reach the point; and identifying the plurality of data fields available at the point using the data structure; and presenting, in the GUI, references to the plurality of data fields available at the point.

Some embodiments provide a system for efficient development of a software application program that processes data from one or more datasets, the software application program developed as a dataflow graph having components representing operations and links representing flows of data. The system comprising at least one computer hardware processor configured to perform: providing a graphical development environment configured to receive user input specifying one or more data fields to use at one or more point in the dataflow graph, the graphical development environment including a graphical user interface (GUI) displaying the dataflow graph; processing a topology of at least a portion of the dataflow graph upstream of a point in the dataflow graph to identify a plurality of data fields available at the point, the processing comprising: generating a data structure indicating one or more paths through one or more components of the dataflow graph by which the plurality of data fields reach the point; and identifying the plurality of data fields available at the point using the data structure; and presenting, in the GUI, references to the plurality of data fields available at the point.

Some embodiments provide a non-transitory computer-readable storage medium storing instructions that, when executed by at least one computer hardware processor, cause the at least one computer hardware processor to perform a method comprising: providing a graphical development environment configured to receive user input specifying one or more data fields to use at one or more point in the dataflow graph, the graphical development environment including a graphical user interface (GUI) displaying the dataflow graph; processing a topology of at least a portion of the dataflow graph upstream of a point in the dataflow graph to identify a plurality of data fields available at the point, the processing comprising: generating a data structure indicating one or more paths through one or more components of the dataflow graph by which the plurality of data fields reach the point; and identifying the plurality of data fields available at the point using the data structure; and presenting, in the GUI, references to the plurality of data fields available at the point.

Some embodiments provide a method, performed by a data processing system, for efficient development of a software application program that processes data from one or more datasets, the software application program developed as a dataflow graph having components representing operations and links representing flows of data. The method comprises using at least one computer hardware processor to perform: providing a graphical development environment configured to receive user input specifying one or more data fields to use at one or more points in the dataflow graph, the graphical development environment including a graphical user interface (GUI) displaying the dataflow graph; identifying, in the dataflow graph, paths through one or more components of the dataflow graph by which data fields reach a plurality of points in the dataflow graph; and determining, based on the paths through one or more components of the dataflow graph by which the data fields reach the plurality of points in the dataflow graph, data fields available at each of the plurality of points in the dataflow graph, the determining comprising: for each of the plurality of points: determining whether any data field available at the point shares its name with another data field available at the point; and when it is determined that at least two data fields available at the point share a common name, differentiating the at least two data fields based on respective source datasets and/or paths in the dataflow graph from which the at least two data fields arrive at the point.

Some embodiments provide a system for efficient development of a software application program that processes data from one or more datasets, the software application program developed as a dataflow graph having components representing operations and links representing flows of data. The system comprising at least one computer hardware processor configured to perform: providing a graphical development environment configured to receive user input specifying one or more data fields to use at one or more points in the dataflow graph, the graphical development environment including a graphical user interface (GUI) displaying the dataflow graph; identifying, in the dataflow graph, paths through one or more components of the dataflow graph by which data fields reach a plurality of points in the dataflow graph; and determining, based on the paths through one or more components of the dataflow graph by which the data fields reach the plurality of points in the dataflow graph, data fields available at each of the plurality of points in the dataflow graph, the determining comprising: for each of the plurality of points: determining whether any data field available at the point shares its name with another data field available at the point; and when it is determined that at least two data fields available at the point share a common name, differentiating the at least two data fields based on respective source datasets and/or paths in the dataflow graph from which the at least two data fields arrive at the point.

Some embodiments provide a non-transitory computer-readable storage medium storing instructions that, when executed by at least one computer hardware processor, cause the at least one computer hardware processor to perform a method comprising: providing a graphical development environment configured to receive user input specifying one or more data fields to use at one or more points in the dataflow graph, the graphical development environment including a graphical user interface (GUI) displaying the dataflow graph; identifying, in the dataflow graph, paths through one or more components of the dataflow graph by which data fields reach a plurality of points in the dataflow graph; and determining, based on the paths through one or more components of the dataflow graph by which the data fields reach the plurality of points in the dataflow graph, data fields available at each of the plurality of points in the dataflow graph, the determining comprising: for each of the plurality of points: determining whether any data field available at the point shares its name with another data field available at the point; and when it is determined that at least two data fields available at the point share a common name, differentiating the at least two data fields based on respective source datasets and/or paths in the dataflow graph from which the at least two data fields arrive at the point.

The foregoing is a non-limiting summary.

### BRIEF DESCRIPTION OF DRAWINGS

FIG. 1A shows a data processing system and software (SW) application development GUI provided by the data processing system for specification of a dataflow graph defining a SW application.

FIG. 1B shows the dataflow graph of FIG. 1A with a processing component added to it and an indication of fields that would be available from the output of the processing component.

FIG. 1C shows the dataflow graph of FIG. 1B with additional processing components added and an indication of fields that would be available from the output of one of the additional processing components.

FIG. 2A shows a data processing system including a field resolver module configured to identify fields available at points in a dataflow graph, according to some embodiments of the technology described herein.

FIG. 2B shows the field resolver module of FIG. 2A differentiating fields available at a point in the dataflow graph after the addition of processing components, according to some embodiments of the technology described herein.

FIG. 2C illustrates operation of the field resolver module of the data processing system of FIGS. 2A-2B, according to some embodiments of the technology described herein.

FIG. 2D shows a field presentation interface displaying references to data fields available at a point in the dataflow graph of FIG. 2B, according to some embodiments of the technology described herein.

FIG. 2E shows a field presentation interface with another display of references to the data fields available at the point in the dataflow graph of FIG. 2B, according to some embodiments of the technology described herein.

FIG. 3A illustrates an example of the field resolver module identifying references to data fields to be displayed in a field presentation interface, according to some embodiments of the technology described herein.

FIG. 3B illustrates another example of the field resolver module identifying references to data fields to be displayed in a field presentation interface, according to some embodiments of the technology described herein.

FIG. 4A illustrates an example of generating a data structure indicating a path through which a data field becomes available at a first point in a dataflow graph, according to some embodiments of the technology described herein.

FIG. 4B illustrates an example of generating a data structure indicating a path through which a data field becomes available at a second point in the dataflow graph of FIG. 4A, according to some embodiments of the technology described herein.

FIG. 5A shows a dataflow graph and an example data structure indicating a path through which a data field becomes available at a point in the dataflow graph, according to some embodiments of the technology described herein.

FIG. 5B illustrates an example of generating a data structure indicating a path through which a data field becomes available at a first point in a dataflow graph, according to some embodiments of the technology described herein.

FIG. 5C illustrates an example of generating a data structure indicating paths through which data fields become available at a second point in the dataflow graph of FIG. 5C, according to some embodiments of the technology described herein.

FIG. 5D illustrates an example of generating a data structure indicating paths through which data fields become available at a third point in the dataflow graph of FIGS. 5A-5B, according to some embodiments of the technology described herein.

FIG. 6 illustrates an example of resolving ambiguity between a data field name and a name of a processing component of a dataflow graph in a data structure indicating data fields available at a point in the dataflow graph, according to some embodiments of the technology described herein.

FIGS. 7A-7E illustrate an example of combining of two data structures to generate a data structure that indicates paths through which data fields reach an output of a join component in a dataflow graph, according to some embodiments of the technology described herein.

FIGS. 8A-8E illustrate an example of combining two data structures to generate a data structure that indicates paths through which data fields reach the output of a gather component in a dataflow graph, according to some embodiments of the technology described herein.

FIGS. 9A-9D illustrate another example of combining two data structures to generate a data structure that indicates paths through which data fields reach the output of a gather component in a dataflow graph, according to some embodiments of the technology described herein.

FIG. 10A shows an example GUI through which a user can provide input to specify a dataflow graph defining a SW application, according to some embodiments of the technology described herein.

FIG. 10B shows the GUI of FIG. 10A including a menu displayed in response to user selection of a point in the dataflow graph of FIG. 10A, according to some embodiments of the technology described herein.

FIG. 10C shows the GUI of FIG. 10A with a display of references to data fields available at the point in the dataflow graph, according to some embodiments of the technology described herein.

FIG. 11 shows an example display of references to data fields available at a point in a dataflow graph, according to some embodiments of the technology described herein.

FIG. 12 shows a GUI displaying a preview of data from data fields available at a selected point in a dataflow graph, according to some embodiments of the technology described herein.

FIG. 13 shows a GUI for specifying an operation performed by a processing component of a dataflow graph, according to some embodiments of the technology described herein.

FIG. 14 shows another GUI for specifying an operation performed by a processing component of a dataflow graph, according to some embodiments of the technology described herein.

FIG. 15 shows a GUI with a suggested structure in which to store data output by a dataflow graph, according to some embodiments of the technology described herein.

FIG. 16 shows interactions among the components of the data processing system of FIGS. 2A-2E, according to some embodiments of the technology described herein.

FIG. 17 shows an example dataflow graph, according to some embodiments of the technology described herein.

FIG. 18 shows an example process for presenting references to data fields available at a point in a dataflow graph displayed in a GUI of a software development environment, according to some embodiments of the technology described herein.

FIG. 19 shows an example process for processing a topology of at least a portion of a dataflow graph to identify data fields available at the point in the dataflow graph, according to some embodiments of the technology described herein.

FIG. 20 shows an example process for determining data fields available at points in a dataflow graph, according to some embodiments of the technology described herein.

FIG. 21 is a block diagram of an illustrative computing system that may be used in implementing some embodiments of the technology described herein.

The foregoing is a non-limiting summary.

### DETAILED DESCRIPTION

A data processing system may use software application programs to process data. Some data processing systems have programs formatted as dataflow graphs, which is used as an example of a software application program herein. A dataflow graph may include: (1) components (also referred to as “processing components”) representing data processing operations to be performed on input data; and (2) “links” between the components representing flows of data. A component of a dataflow graph may include one or more ports through which the component receives data and/or one or more output ports through which the component outputs data.

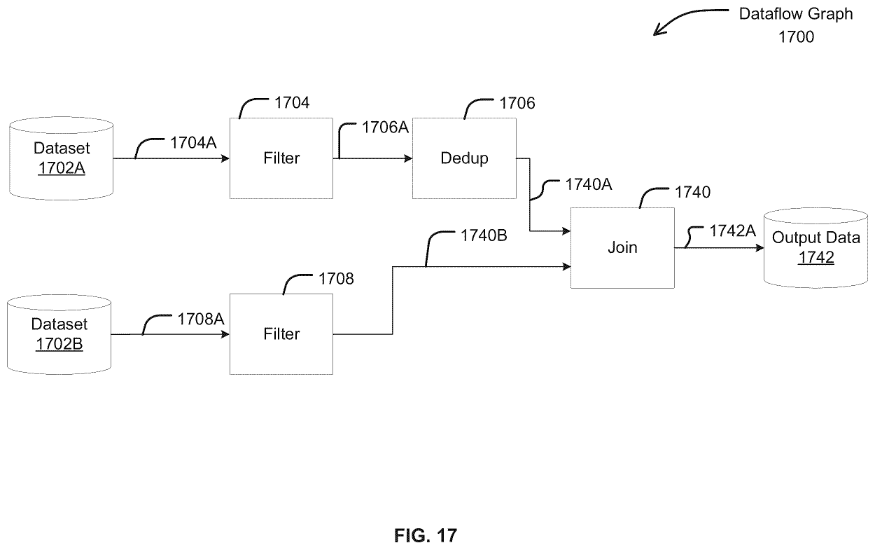

To illustrate, FIG. 17 is an example dataflow graph 1700 of a software application program, according to some embodiments of the technology described herein. The dataflow graph 1700 receives data from input datasets 1702A, 1702B. Data from dataset 1702A is provided to a filtering operation at component 1704 as indicated by the link 1704A. The output of the filtering operation at component 1704 is then provided as input to a deduplication operation at component 1706 as indicated by the link 1706A. Data from dataset 1702B is provided to a filtering operation at component 1708 as indicated by link 1708A. The outputs of the deduplication operation at component 1706 and the filter operation at component 1708 are then provided as inputs to a join operation at component 1740 as indicated by the links 1740A, 1740B. The output of the join operation 1740 is then provided to an output dataset 1742 as indicated by link 1742A.

A dataflow graph may include one or more paths through one or more processing components in the dataflow graph. For example, the dataflow graph 1700 of FIG. 17 includes a path between the dataset 1702A and the output dataset 1752, where the path includes link 1704A, component 1704, link 1706A, component 1706, link 1740A, component 1740, and link 1742A. As another example, the dataflow graph 1700 includes a path between the dataset 1702B and the output dataset 1742, where the path includes link 1708A, component 1708, link 1740B, component 1740, and link 1742A. Each of these paths represents a flow of data in a software application defined by the dataflow graph 1700. A dataflow graph may be compiled into an executable software application and then executed.

Example operations that may be performed by a component in a dataflow graph include filter, join, group by, select, update, deduplicate, union, or any other suitable type of operation.

A dataflow graph may include several (e.g., tens, hundreds, or thousands) of input datasets, each with multiple data fields. The dataflow graph may further include multiple paths of processing in the dataflow graph. A path may refer to a portion of a dataflow graph between a first point and a second point in the data flow graph, where the portion includes at least one processing component and/or links that, if followed, connect the first point to the second point. As a dataflow graph is developed by a user, fields may become available through various different components and paths in the dataflow graph.

A data processing system may allow a user to develop a dataflow graph using a set of components that represent respective operations. A user may develop the dataflow graph by laying out the components and connecting them with links. As part of developing the dataflow graph, the user may need to specify which fields are used for an operation at a component and/or which fields are output by the component.

One problem in the development of a dataflow graph is that there may be ambiguity about which fields are to be processed and/or output by a component of a dataflow graph. For example, two fields from multiple different datasets may share the same name. Thus, it is unclear which of the two fields needs to be processed and/or output by a component to be available for downstream component(s). As another example, a field from a dataset may have passed through multiple different paths in the dataflow graph upstream of a component. Thus, it is unclear which version of the field needs to be processed and/or output by the component. Some conventional programming environments dealt with this ambiguity by enabling the programmer to specify, at any point along a path, which fields would propagate along the path such that they would be available for selection downstream of that location. The inventors recognized a downside of this approach is that the programmer might unintentionally restrict propagation of a field that might be needed at a downstream location, resulting in a programmer selecting the incorrect field or needing to rework the program. Other programming environments dealt with this situation by making all fields available. Thus, all fields that are input to a given component are made available at the output.

One solution to the above problem may be for a user to track field names as a user is developing a dataflow graph. However, this is not a viable approach because it is impractical for a user to keep track of which data fields are available at different points in the dataflow graph. For example, data fields may be accessed from input datasets, generated by components, and/or modified by components throughout the dataflow graph (e.g., by introduction of additional data field(s), filtering of data field(s), and/or other operations). Thus, it is not feasible for a user to keep track of the source of data fields available at each point in the dataflow graph based on field names. Even if a user could track the names of data fields available at different points in a dataflow graph, there are often cases in which the field names are ambiguous (e.g., because data fields from different datasets have the same name, or a particular data field has been processed in two different paths of the dataflow graph that each output a different modification of the data field). These factors require a user to spend time investigating which data fields are available at points. These factors also result in erroneous or unintended operation of the dataflow graph because a user may not understand which fields are available at a point in the dataflow graph. This causes improper functionality of a software application program compiled from the dataflow graph and time to revise the dataflow graph (e.g., to correct and error or otherwise modify functionality of the software application).

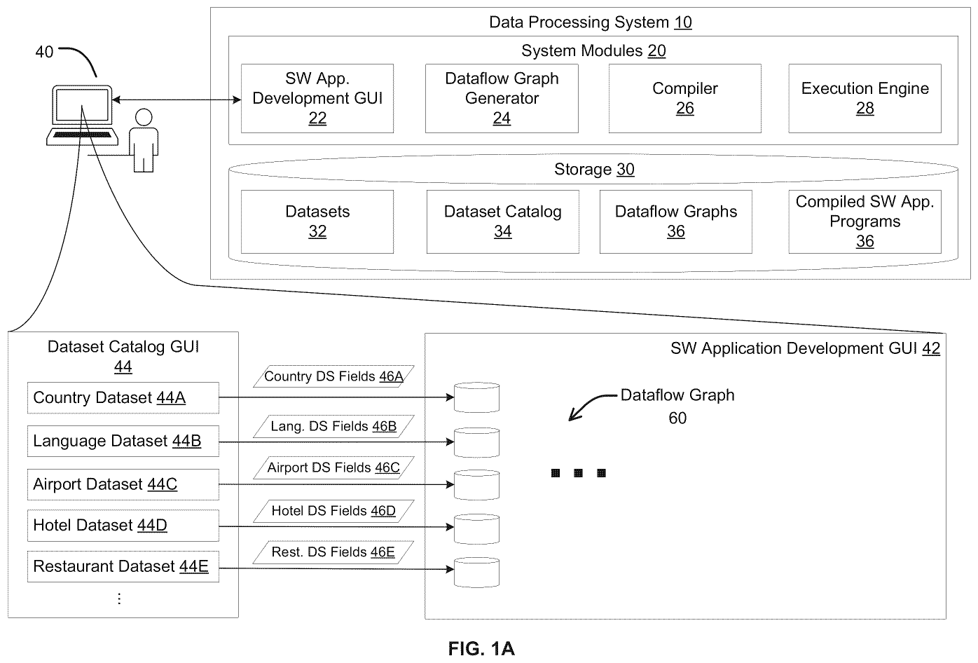

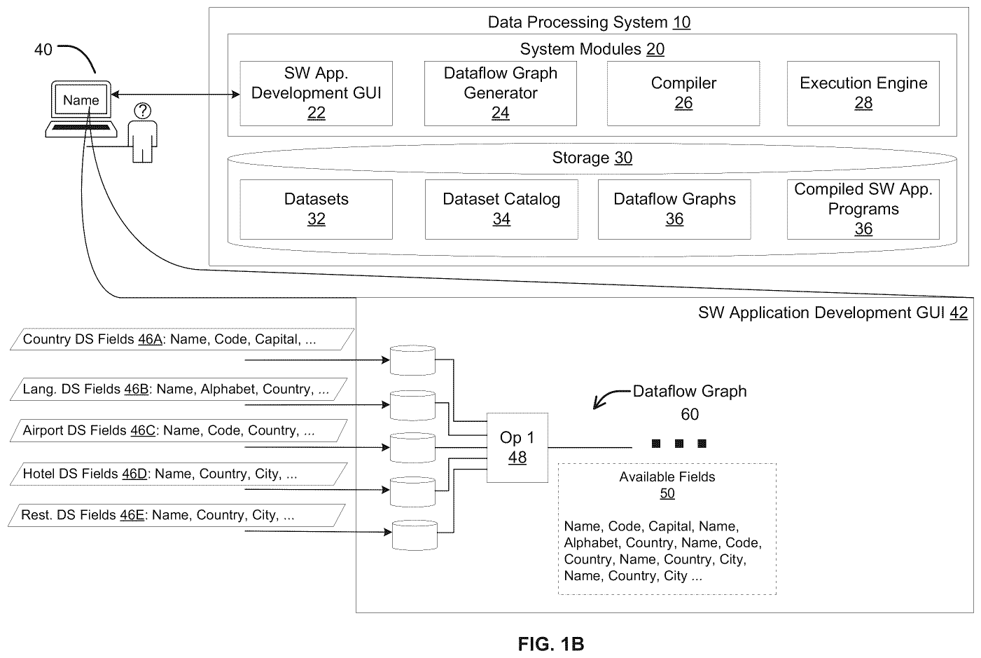

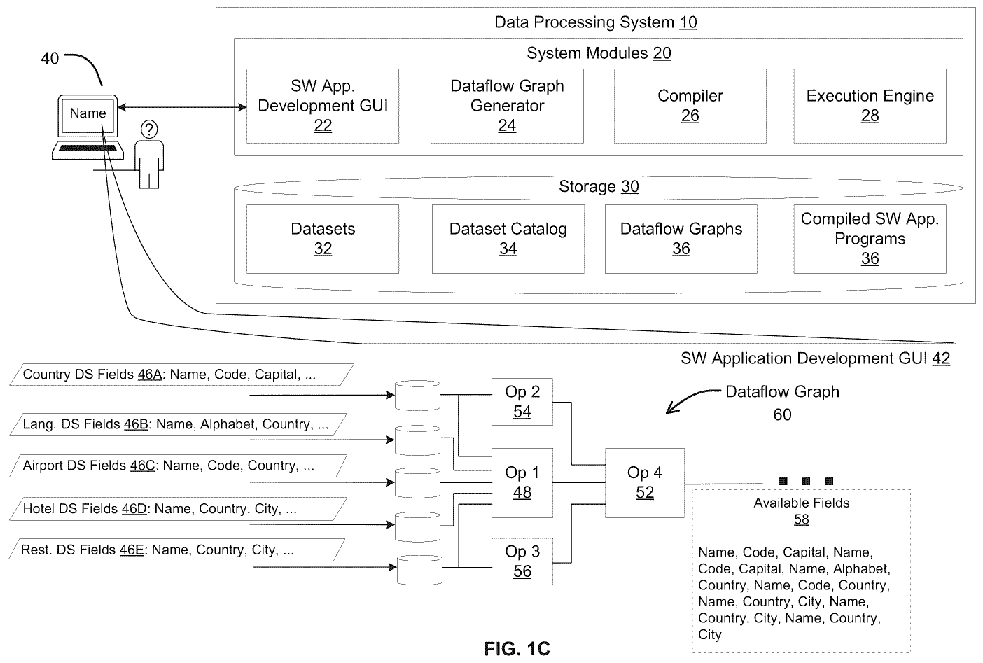

The above-described problem with conventional systems is illustrated with reference to FIGS. 1A-1B.

FIG. 1A shows a data processing system 10 and a SW application development GUI provided by the data processing system for specification of a dataflow graph defining a SW application. The data processing system 10 has system modules 20 that include: (1) a SW application development GUI module 22 configured to provide the SW application development GUI 42 in which a user can develop a dataflow graph 60, (2) a dataflow graph generator configured to generate the dataflow graph 60 based on user input obtained through the SW application development GUI 42, (3) a compiler 26 configured to compile the dataflow graph into an executable software application program, and (4) an execution engine configured to execute compiled software application programs. The data processing system 10 includes data storage 30. The data storage 30 stores datasets 32, a dataset catalog 34 that includes entries storing information for accessing respective datasets, dataflow graphs 36 (e.g., generated by the dataflow graph generator 24), and compiled software application programs 36.

FIG. 1A further shows a SW application development GUI 42 (e.g., generated by the SW application development GUI module 22) provided to a computing device 40. The SW application development GUI 42 can be used by a user of the device 40 to develop a dataflow graph 60. For example, the SW application development GUI 42 may include a canvas on which the user can lay out the dataflow graph 60 by specifying operations, links between them and datasets that may be accessed by the application. Using the GUI, a user may in some cases specify parameters of the components of the graph 60.

In the example of FIG. 1A, the data processing system 10 further provides a dataset catalog GUI 44 through which the user can access entries in the dataset catalog 34 that provide access to various datasets (e.g., by storing computer-readable instructions for accessing the datasets). The entries can be used to specify datasets as input to the dataflow graph 60. As shown in FIG. 1A, entries 44A, 44B, 44C, 44D, 44E are used to specify respective datasets as inputs in the dataflow graph 60. In the example of FIG. 1A, the entries 44A, 44B, 44C, 44D, 44E are each associated with an input component in the dataflow graph 60. Entry 44A corresponds to a country dataset (DS), entry 44B corresponds to a language dataset, entry 44C corresponds to an airport dataset, entry 44D corresponds to a hotel dataset 44D, and entry 44E corresponds to a restaurant dataset. Each of the datasets may store its own respective set of fields. Accordingly, the dataflow graph 60 receives, as input, the country dataset fields 46A, the language dataset fields 46B, the airport dataset fields 46C, the hotel dataset fields 46D, and the restaurant dataset fields 46E.

FIG. 1B shows the dataflow graph 60 of FIG. 1A with a processing component 48 added (e.g., based on input received through the SW application development GUI 42 from the device 40) and an indication of fields 50 that would be available at the output of the component 48. In the example of FIG. 1B, all the datasets are provided as input to the component 48. Accordingly, the component 48 is configured to receive: the country dataset fields 46A (which include Name, Code, and Capital), the language dataset fields 46B (which include Name, Alphabet, and Country), the airport dataset fields 46C (which include Name, Code, and Country), the hotel dataset fields 46D (which include Name, Country, and City), and the restaurant dataset fields 46E (which include Name, Country, City). The available fields 50 at the output of the component 48 include all of the dataset fields 46A, 46B, 46C, 46D, 46E. As evident from FIG. 1B, there are several field name collisions. For example, all of the datasets have a Name field. Thus, the term “Name” may refer to multiple different fields in different datasets. As another example, the country dataset fields 46A and the airport dataset fields 46C both include a Code field. Thus, the term “Code” may refer to multiple different fields in different datasets.

FIG. 1C shows the dataflow graph of FIGS. 1A-1B with additional processing components 52, 54, 56 added and an indication of fields 58 that would be available from the output of the component 52. The inputs to the component 52 include the output of the component 48 (which includes the fields from all the input datasets after performance of a first operation), the output of component 54 (which includes the country dataset fields 46A after performance of a second operation), and the output of component 56 (which includes the restaurant dataset fields 46E after performance of a third operation). The fields 58 available at the output of the component 52 comprise the union of all these outputs. However, the available fields 58 include multiple different versions of different fields that result from performing the operations of upstream components 48, 54, 56. A user developing the dataflow graph 60 does not have any way of discerning the different versions of the fields that are generated by the different upstream processing paths.

The inventors have developed techniques to address the above-described problem. The techniques may include processing a topology of a dataflow graph upstream of a given point to resolve which fields are available at the point, and present them in a manner that clarifies any ambiguities in the field names (e.g., due to collision of field names from different datasets and/or field(s) being propagated to the point through multiple processing paths). Data fields available at the point may be accessible to a component downstream of the point. For a particular point in a dataflow graph, a user may be provided a listing of references to available data fields from which the user may select one or more fields to use in an operation. A SW application program may access multiple datasets (e.g., tens or hundreds) each with a large number (e.g., hundreds) of data fields that can be used in operations performed by the software application. By providing the available data fields at each point with ambiguities resolved, the techniques reduce the likelihood of erroneous or unintended development of a dataflow graph (e.g., which results in failure or unintended operation of a software application compiled from the dataflow graph). Moreover, the data fields can be indicated with attributes about the data fields such as a data type of values stored in the data fields to facilitate development of software applications.

Efficiently obtaining the set of available data fields at points in a dataflow graph is complex because the availability of the data fields may depend on upstream components of a dataflow graph. The upstream components may access data from multiple different datasets that have common data field names, introduce new data fields, and/or modify data in fields. Accordingly, a user may inadvertently specify incorrectly the intended data field at a point in the graph, for any number of reasons, such as an inability to recognize which data fields are available at a particular point in a dataflow graph or to differentiate data fields that share a common name despite storing different data.

To address the above-described challenges, the inventors developed new techniques that provide for an efficient, scalable, and widely applicable automated approach for identifying data fields that are available for use at points in a dataflow graph. Optionally, the techniques further present references to the data fields in a way that resolves ambiguities in field names. The system analyzes path(s) through component(s) of a dataflow graph to identify data field(s) available at a particular point by processing a topology of the dataflow graph upstream of the point. The system determines references to the identified data field(s) (e.g., that can be presented in a software application development interface for a user). The system differentiates between data fields that share the same name based on the paths through which each data field reaches the point. Accordingly, such data fields can be disambiguated for a user. For example, data fields may be disambiguated by indicating sources of the data fields in a listing of references to data fields provided to the user.

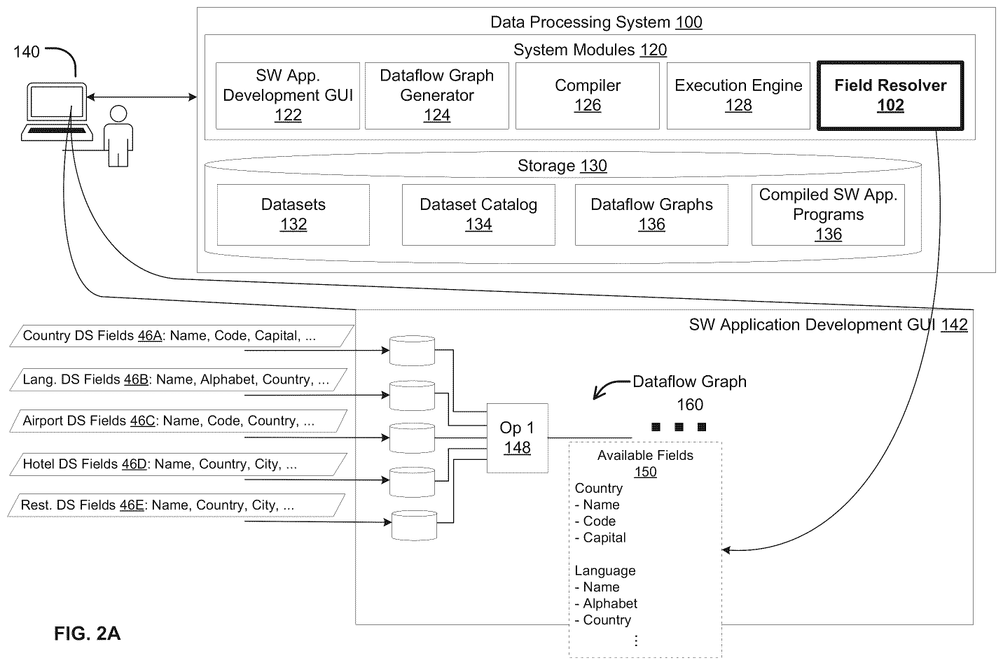

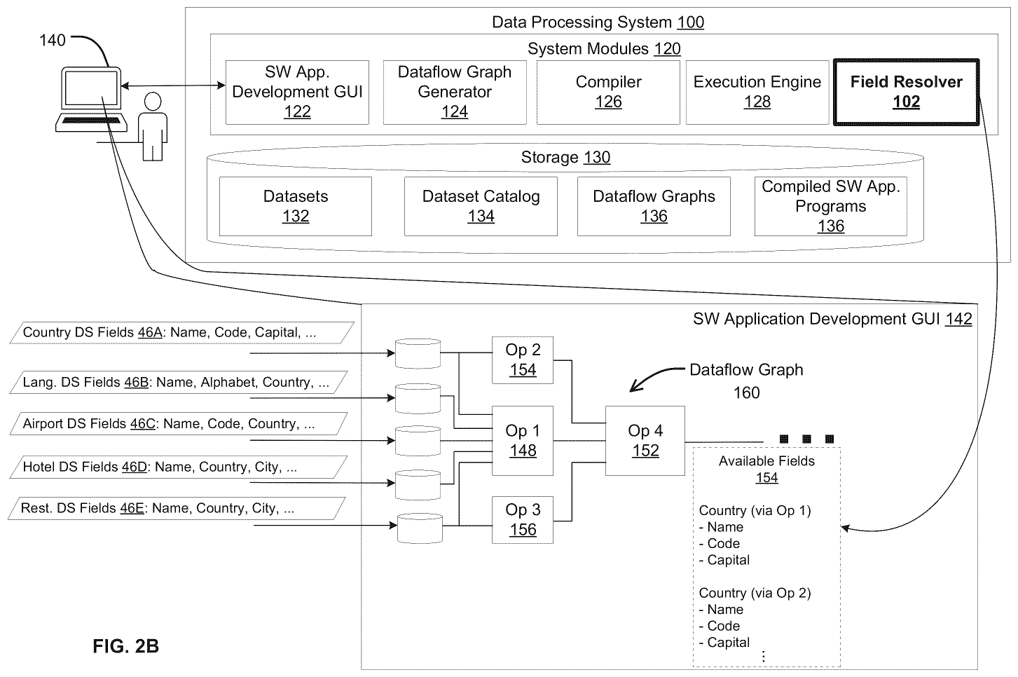

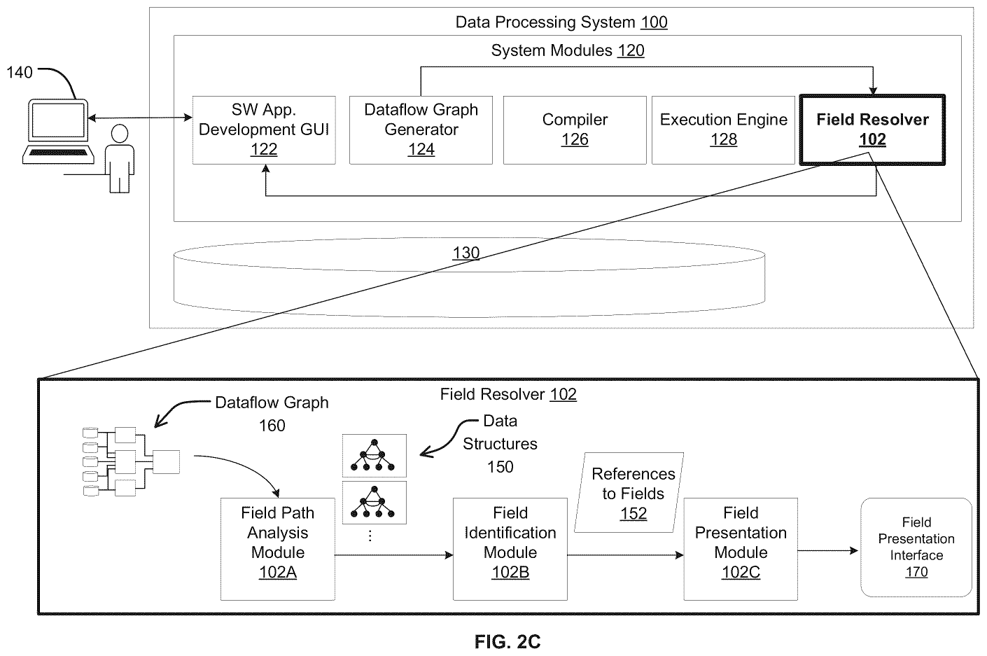

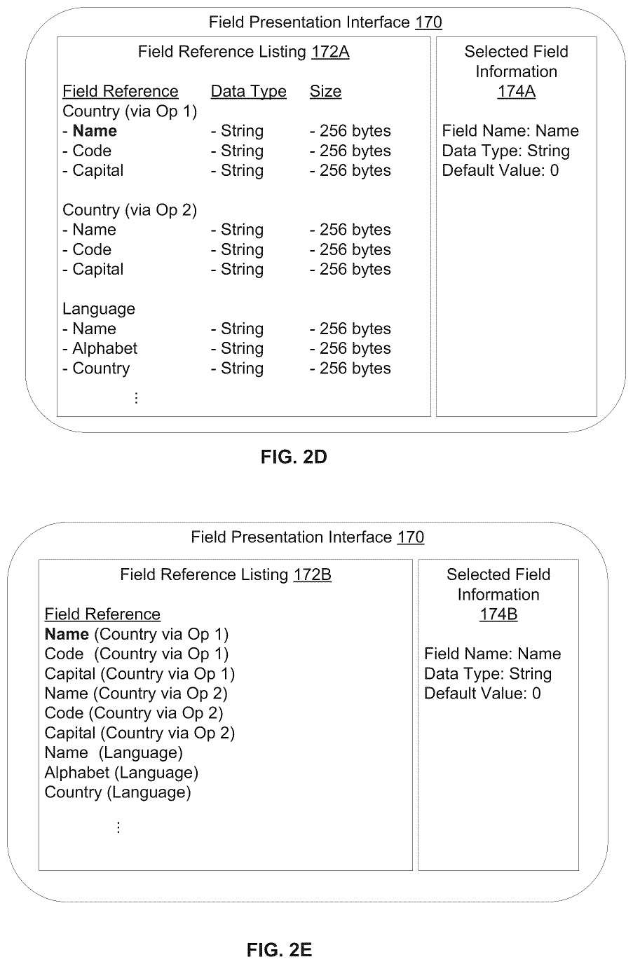

FIG. 2A shows a data processing system 100 including a field resolver module 102 configured to identify fields available at a point in a dataflow graph, according to some embodiments of the technology described herein. In some embodiments, the field resolver module 102 may be configured to dynamically identify the fields during development (e.g., creation and/or editing) of the dataflow graph 60. For example, the field resolver module 102 may identify and present the available fields in response to a request for fields available at the point (e.g., based on a user command or action performed in the SW application development GUI 142). The field resolve 102 may be configured to process the topology of the dataflow graph upstream of the point to: (1) identify fields available at the point, and (2) resolve any ambiguities in field names.

In the example of FIG. 2A, the dataflow graph 160 includes inputs that receive respective sets of fields including the country dataset fields 146A, the language dataset fields 46B, the airport dataset fields 46C, the hotel dataset fields 46D, and the restaurant dataset fields 46E. Each of the sets of fields is provided as input to the component 148 to perform a first operation. Accordingly, the output of the component 148 is a union of the input fields. In the example of FIG. 2A, the field resolver module 102: (1) identifies the fields and their source datasets, and (2) disambiguates the fields based on their source datasets. As shown in FIG. 2A, the field resolver module 102 groups field names with their source datasets. The available fields 150 include: (1) the fields Name, Code, and Capital belonging to the Country dataset, and (2) the fields Name, Alphabet, and Country belonging to the Language dataset. Accordingly, the field resolver module 102 has differentiated between the Name field of the country dataset and the Name field of the language dataset.

FIG. 2B shows the field resolver module 102 of the data processing system 100 of FIG. 2A differentiating fields available at a point in the dataflow graph 160 after the addition of processing components 152, 154, 156, according to some embodiments of the technology described herein. The component 152 receives, as input, fields output from the components 148, 154, 156. Accordingly, the component 152 may receive different versions of the fields that are generated based on the operations performed by each of the components 148, 154, 156. The field resolver module 102 distinguishes the paths through which sets of fields arrive at the output of component 152. For example, the component 152 receives the country dataset fields 46A from the component 148 after performing a first operation and the country dataset fields 46A from the component 154 after performing a second operation. The field resolver module 102 has identified these different paths. The available fields 154 determined by the field resolver module 102 thus include the country dataset fields Name, Code, and Capital received via the first operation component (i.e., component 148) and the country dataset fields Name, Code, and Capital received via the second operation component (i.e., component 154).

In some embodiments, the data processing system may process a topology of a portion of a dataflow graph upstream of a point to identify data fields available at the point. The data processing system may identify path(s) through component(s) of the dataflow graph by which the data fields reach the point. The data processing system may differentiate between data fields that share a common name based on the different paths by which they reach the point. The data processing system may identify a source (e.g., a dataset and/or a component of the dataflow graph) from which the data fields reach the point. In some embodiments, the data processing system may present references to the data fields available at a point (e.g., in a software application development GUI). For example, the data processing system may present a listing of references to the data fields along with attributes of the data fields (e.g., data type of values stored therein, default values, delimiters, formatting, and/or other attributes).

In some embodiments, the data processing system may process a topology of a dataflow graph upstream of a point to identify data fields available at the point. The data processing system may process the topology by generating a data structure (e.g., a tree structure) indicating path(s) through component(s) of dataflow graph by which the data fields reach the point. The data processing system may use the data structure identify the data fields available at the point and to determine references to the data fields. The data processing system may use the data structure to disambiguate data fields (e.g., that share the same name despite coming from different sources).

In some embodiments, the data processing system may efficiently process the topology of a dataflow graph to identify data fields that are currently available at points in the dataflow graph. The data processing system may determine data fields available at each of the points based on paths by which the data fields reach the points. In some embodiments, the data processing system may process the topology of the dataflow graph by propagating results of processing performed for one point to subsequent downstream points. For example, the data processing system may generate a data structure for one point indicating paths by which data fields reached the point and propagate the data structure to downstream points (e.g., by updating the data structure to obtain the data structures for the downstream points).

In some embodiments, the data processing system determines attributes of data field(s) available at a given point in a dataflow graph. The attributes may include, for each of the data field(s), a data type for the data field. For example, the data type may be an integer, floating point, binary, decimal, Boolean, character, string, enumerated, array, date, time, datetime, timestamp, or another data type. The system may maintain the data type with each data field. In some embodiments, the system may store the data type of a data field as an attribute of the data field along with its name. Accordingly, a node in a data structure representing a data field may store and/or reference a data type for the data field.

In some embodiments, the data processing system uses an identification of data field(s) available at points in a dataflow graph to optimize a software application compiled from the dataflow graph. The data processing system may use the identification of data field(s) to recognize which data fields are referenced in the dataflow graph and which data fields are not referenced. The data processing system may optimize the dataflow graph such that the unreferenced data fields are not read. This reduces the amount of data that is processed by a software application compiled from the optimized dataflow graph relative to a software application that would have been compiled from the unoptimized dataflow graph. Thus, the software application compiled from the optimized dataflow graph is more efficient to execute than a software application executed from a non-optimized dataflow graph.

Following below are more detailed descriptions of various concepts related to, and embodiments of, methods and systems for identifying data fields available for use in a dataflow graph. It should be appreciated that various aspects described herein may be implemented in any of numerous ways. Examples of specific implementations are provided herein for illustrative purposes only. In addition, the various aspects described in the embodiments below may be used alone or in any combination and are not limited to the combinations explicitly described herein.

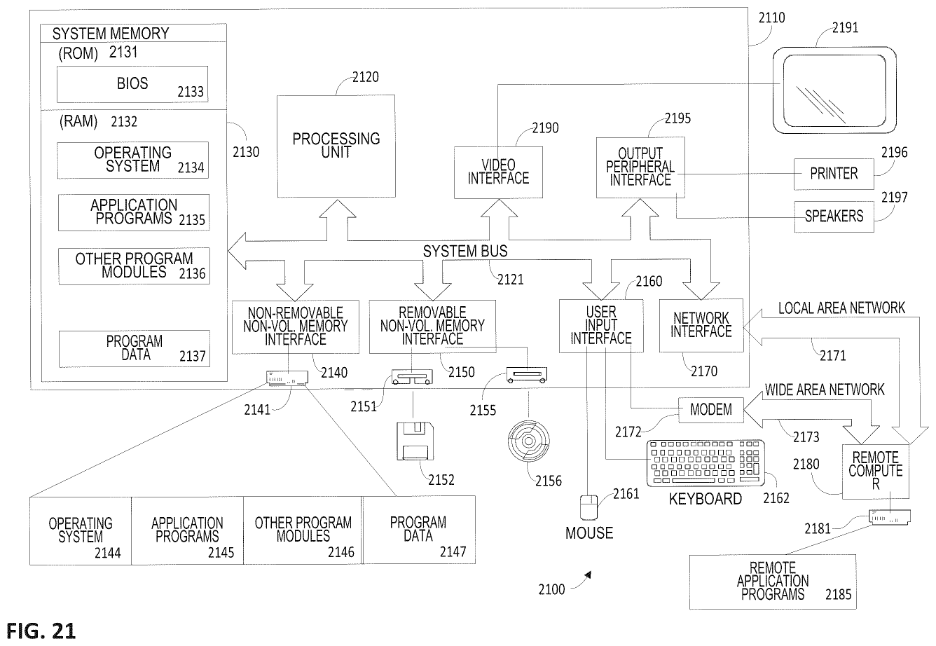

Returning to FIGS. 2A-2B, the data processing system 100 may comprise a computer system (e.g., as described herein with reference to FIG. 21). For example, data processing system 100 may comprise one or more servers and storage hardware. The data processing system may include memory storing data sets and/or access datasets from storage outside of the data processing system. A user of device 140 may develop software applications in the data processing system 100 that perform operations using data from one or more datasets. The software application programs may be developed as dataflow graphs (e.g., dataflow graph 160).

The data processing system 100 may store or access a large number (e.g., thousands or millions) of datasets. Each of the datasets may include multiple (e.g., tens or hundreds) data fields that store data. Further, software applications that use the datasets may generate new data fields for storing data as part of their operations. For example, the data processing system 100 may be used to manage datasets for a multinational bank. The multinational bank may develop thousands of dataflow graphs for processing customer data related to millions of bank accounts. The dataflow graphs may access data fields from datasets and/or generate new data fields. In another example, the data processing system 100 may manage datasets for a credit card company. Users may develop thousands of dataflow graphs for processing transaction data generated from millions of credit card transactions that occur per day. The dataflow graphs may access data fields from datasets and/or generate new data fields. In another example, the data processing system 100 may manage datasets for a travel agency. The datasets may store data about countries, languages, airports, hotels, restaurants, and/or other data for operations of the travel agency.

FIGS. 2A-2B shows an example software application development GUI 142 provided by the data processing system 100 to a device 140. The software application development GUI 142 may receive user input specifying the dataflow graph 160. In FIG. 2A, the user has provided input specifying the dataflow graph 160 shown in the software application development GUI 142. The dataflow graph 160 includes a processing component 148 (labeled “Op 1”) which receives data as inputs (e.g., through input ports). In FIG. 2B, the user of the device 140 has added processing components 152 (labeled “Op 4”), 154 (labeled “Op 2”), 156 (labeled “Op 3”) to the dataflow graph 160. The outputs of components 148, 154, 156 are provided as inputs to the component 152.

As shown in FIG. 2A, the data processing system 100 includes a field resolver module 102. The field resolver module 102 may determine data fields that are available at different points in a dataflow graph. For example, in FIG. 2A, the field resolver module 102 may determine which data fields are available at the output of component 148. As another example, in FIG. 2B, the field resolve 102 may determine which data fields are available at the output of component 154, component 148, component 156, and/or component 152. In some embodiments, the field resolver module 102 may identify available fields at a point in the dataflow graph 160 in response to user input. For example, in response to a request (e.g., received through the SW application development GUI 142) for available fields at a given point in the dataflow graph 160, the field resolver module 102 may process the topology of the dataflow graph 160 upstream of the point to identify the fields available at the point.

In some embodiments, the field resolver module 102 may dynamically resolve the data fields available at points in the dataflow graph 160 while the user provides input in the software application development GUI 142 specifying the dataflow graph 160. The field resolver module 102 may determine which data fields are available at one or more points in response to the addition of components and/or configuration thereof. For example, in response to the user providing input adding component 152 to the dataflow graph 160 and links connecting outputs of components 148, 154, 156 to the component 152, the field resolver module 102 may automatically analyze the resulting path(s) to determine data fields available at the input and/or output of the component 152. In some embodiments, the field resolver module 102 may determine available data fields at a given point in the dataflow graph 160 by processing a topology of a portion of the dataflow graph 160 upstream of the point. For example, the field resolver module 102 may determine data fields available at the output of component 152 by processing the upstream portion of the dataflow graph 160.

In some embodiments, the field resolver module 102 may present a menu to a user in the SW application development GUI 142 (e.g., in response to user input indicating a selection of a point in the dataflow graph 160). For example, the user may provide input selecting an output of component 152. In response to selection of the output component 152, the software application development GUI 142 may display a menu. The menu may include an “Available Fields” option. In response to selection of the “Available Fields” option, the field resolver module 102 may: (1) identify fields available at the output of the component 152, and (2) generate a display of references to data fields available at the output of the component 152 (e.g., as shown in FIG. 2D). The field resolver module 102 may display the available data fields in a manner that clarifies any ambiguities (e.g., resulting in field names). In the example of FIG. 2A, the field resolver module 102 organizes the available fields 150 by source dataset. This clarifies to the user ambiguities resulting from field name collisions across the different dataset fields input to the component 148. In the example of FIG. 2B, the field resolver module 102 organizes the available fields 154 by source dataset and component through which the fields reached the component 152. Thus, the available fields 154 include country dataset fields that reached the component 152 via the component 148 (labeled “Op 1”), and country dataset fields that reached the component 152 via the component 154 (labeled “Op 2”).

In addition to the field resolver module 102, the data processing system 100 of FIGS. 2A-2B includes other system modules 120. The system modules 120 include SW application development GUI module 122, a dataflow graph generator 124, a compiler 126, and an execution engine 126. The data processing system 100 further includes data storage 130.

In some embodiments, the SW application development GUI module 122 may generate the GUI 142 that allows a user to develop a software application program as a dataflow graph. The GUI allows a user to lay out nodes and links of the dataflow graph 160 for the software application program. The GUI 142 may allow the user to save the dataflow graph for compilation and/or execution (e.g., in data storage 130). In some embodiments, the SW application development GUI module 122 may be configured to provide graphical elements representing processing components that can be used in a dataflow graph. For example, the GUI 142 may allow the user to drag graphical elements representing processing components onto a canvas on which the dataflow graph is developed. The SW application development GUI module 122 may be configured to receive input from the user through the GUI 142. In some embodiments, the SW application development GUI module 122 may provide, in the GUI 142, an editor for generating a dataflow graph (also referred to as a “computational graph”) as described in U.S. Pat. No. 11,593,380, which is incorporated by reference herein in its entirety.

The dataflow graph generator 124 may generate dataflow graphs for software application programs. In some embodiments, the dataflow graph generator 124 may generate a dataflow graph by obtaining, through a graphical UI, user input indicating the dataflow graph. The user may lay out nodes and links representing input data sources, data processing operations, outputs, and/or flows of data in the graphical UI.

In some embodiments, the dataflow graph generator 124 may generate dataflow graphs. In some embodiments, the dataflow graph generator 124 may generate a dataflow graph for an application by: (1) obtaining a user definition of a dataflow graph (e.g., in a software application program development UI); and (2) generate the dataflow graph for the application based on the user definition. In some embodiments, the dataflow graph generator 124 may save a user defined dataflow graph as a software application program in the data processing system 100. The software application program may be accessed and executed by the data processing system 100 (e.g., to analyze data or to perform processing as part of a task). In some embodiments, the dataflow graph generator 124 may compile a dataflow graph into a software application program.

In some embodiments, the dataflow graph generator 124 may manage storage of dataflow graphs. The dataflow graph generator 124 may information indicating dataflow graphs. For example, the dataflow graph generator 124 may store information indicating nodes and links of a dataflow graph. The dataflow graph generator 124 may further store configuration parameters for a dataflow graph. For example, the dataflow graph generator 124 may store a name of a dataflow graph, a location (e.g., a file path), and/or other configuration parameters of the dataflow graph. In some embodiments, the dataflow graph generator 124 may generate a file storing a dataflow graph. The file may store information indicating nodes and links of a dataflow graph. The file may indicate operations at nodes in the dataflow graph. For example, the file may indicate one or more data processing operations (e.g., filter, join, rollup, and/or other operation(s)) that are to be performed at nodes in the dataflow graph. The file may further store information indicating input datasets associated with one or more nodes, one or more data links, and/or data processing operations of one or more nodes. In some embodiments, an input node may obtain data from a physical dataset or data output by an executed subgraph (e.g., a catalogued dataflow graph incorporated as a subgraph). In some embodiments, an entry in a dataset catalog may refer to a file storing information about a dataflow graph. The entry may be used to incorporate the dataflow graph into other dataflow graphs (e.g., of other software application programs).

In some embodiments, the compiler module 126 may compile a dataflow graph (e.g., a transformed dataflow graph) for execution (e.g., by the dataflow graph execution engine 128). The compiler module 126 may compile the dataflow graph into an executable software application program that can be executed by the data processing system 100. In some embodiments, the compiler module 126 may store a compiled software application program in data storage of the data processing system 100. The stored software application program may then be executed by the data processing system 100 at a subsequent time. For example, the software application program may be executed in response to a user command and/or programmatically executed.

In some embodiments, the compiler module 126 may transform a dataflow graph into a transformed dataflow graph that can be compiled and executed. The transformed dataflow graph may be more computationally efficient to execute. For example, the original dataflow graph may: (1) include nodes that represent redundant data processing operations; (2) require performing data processing operations whose results are subsequently unused; (3) require unnecessarily performing serial processing in cases where parallel processing is possible; (4) apply a data processing operation to more data than needed in order to obtain a desired result; (5) break out computations over multiple nodes, which significantly increases the computational cost of performing the computations in situations where the data processing for each dataflow graph node is performed by a dedicated thread in a computer program, a dedicated computer program (e.g., a process in an operating system), or a dedicated computing device; (6) require performing a stronger type of data processing operation that requires more computation (e.g., a sort operation, a rollup operation, etc.) when a weaker type of data processing operation that requires less computation (e.g., a sort-within-groups operation, a rollup-within-groups operation, etc.) will suffice; (7) require the duplication of processing efforts; or (8) not include operations or other transformations that are useful or required for processing data, or combinations of them, among others.

In some embodiments, the compiler module 126 may transform a dataflow graph by applying one or more dataflow graph optimization rules to the dataflow graph to improve the computational efficiency of the transformed dataflow graph, such as by removing dead or redundant components (e.g., by removing one or more nodes corresponding to the dead or redundant components), moving filtering steps earlier in the data flow (e.g., by moving one or more nodes corresponding to the filtering components), or narrowing a record, among others. In this way, the compiler module 126 transforms the dataflow graph into an optimized transformed dataflow graph prior to compilation. In some embodiments, the compiler module 126 may use available fields identified by the field resolver module 102 to apply optimizations to a dataflow graph. The compiler module 126 may determine which fields are to be output by the dataflow graph. The compiler module 126 may modify the dataflow graph to remove available fields at different points in the dataflow graph that are not used in generating the output fields.

In some embodiments, the execution engine 128 may execute a dataflow graph (e.g., a compiled by the compiler module 126). In some embodiments, the execution engine 128 may execute a dataflow graph by: (1) generating a set of instructions based on the dataflow graph (e.g., nodes and links of the dataflow graph); and (2) executing the set of instructions. In some embodiments, the execution engine 128 may use a software application program that interprets and executes a dataflow graph. For example, the execution engine 128 may call a program that interprets a dataflow graph and generates computer-executable instructions based on the dataflow graph. Techniques for executing computations encoded by dataflow graphs are described in U.S. Pat. No. 5,966,072, titled “Executing Computations Expressed as Graphs,” and in U.S. Pat. No. 7,716,630, titled “Managing Parameters for Graph-Based Computations,” each of which is incorporated by reference herein in its entirety.

In some embodiments, the execution engine 128 may generate output data obtained as a result of executing a dataflow graph. The execution engine 128 may execute dataflow graph of a dataflow graph dataset to generate output data (e.g., as part of executing a software application program). The output data may then be used by the software application program for subsequent data processing. For example, the software application program may be developed as a first dataflow graph, and the output data generated by executing the dataflow graph from the dataflow graph dataset may be used to perform one or more data processing operations in the first dataflow graph.

The storage 130 may comprise storage hardware. In some embodiments, the storage hardware may include one or more hard drives (e.g., solid state drives, hard disk drives, and/or other types of hard drives). In some embodiments, the storage 130 may comprise one or more databases, one or more data warehouses, and/or one or more data lakes. In some embodiments, the storage 130 may comprise cloud storage. In some embodiments, the storage 130 may be storage of a computer system configured to execute the system modules 120. Although the storage 130 is shown within the data processing system 100, in some embodiments, the storage 130 may be external from a computer system configured to execute the system modules 120.

As shown in FIGS. 2A-2B, the storage 130 stores datasets 132, a dataset catalog 134, dataflow graphs 136, and compiled SW application programs 136 (e.g., compiled from dataflow graphs). In some embodiments, the dataset catalog 134 may include entries associated with datasets. Each entry may include information to access a dataset associated with the entry. For example, the entry may include a reference (e.g., a location) to a dataset in the storage 130 storing the dataset. In another example, the entry may include a reference to a dataset stored external to the storage 130.

In some embodiments, the dataset catalog 134 may provide access to datasets. The dataset catalog may provide a software application program with access to a dataset through an entry associated with the dataset. For example, the SW application development GUI module 122 may generate a dataset catalog GUI allowing users to select entries for incorporating associated datasets into a dataflow graph. In some embodiments, the dataset catalog 134 may provide access to datasets by allowing software application programs to reference entries of the dataset catalog. For example, executable instructions of a software application program may reference entries of the dataset catalog to incorporate datasets. In another example, the data processing system 100 may be configured to execute one or more software application programs that provide information from entries of a dataset catalog to other software application programs.

In some embodiments, the datasets 132 may be stored external to the data processing system 100. For example, the datasets 132 may be stored by an enterprise system from which the data processing system 100 can access the datasets. In some embodiments, the storage 130 may store metadata about the datasets 132.

FIG. 2C illustrates operation of the field resolver module 102 of the data processing system 100 of FIGS. 2A-2B to identify data fields available at different points in a dataflow graph, according to some embodiments of the technology described herein. As shown in FIG. 2C, the field resolver module 102 includes a field identification module 102B, a field path analysis module 102A, and a field presentation module 102C.

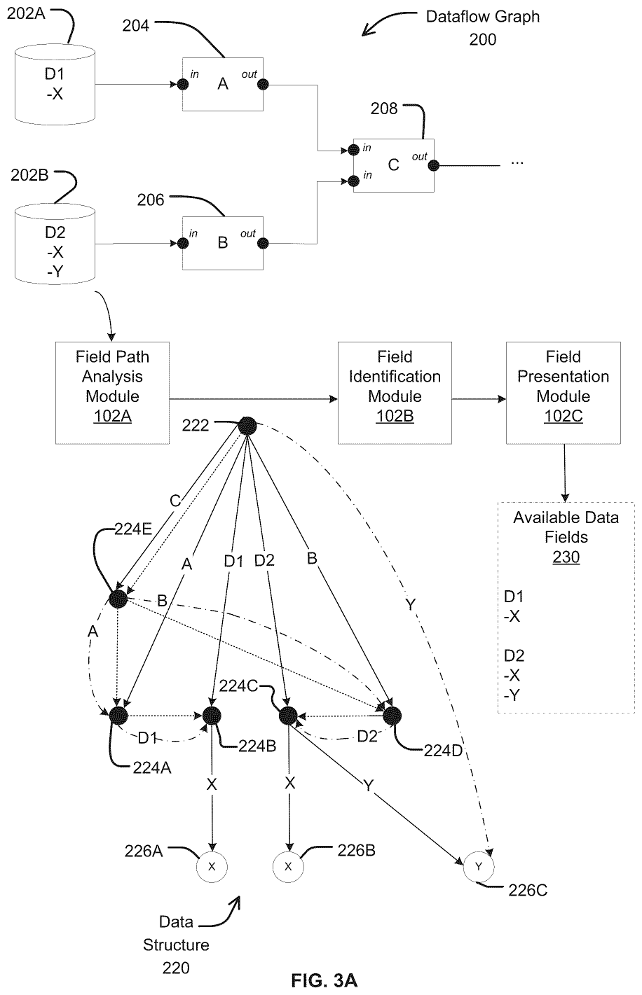

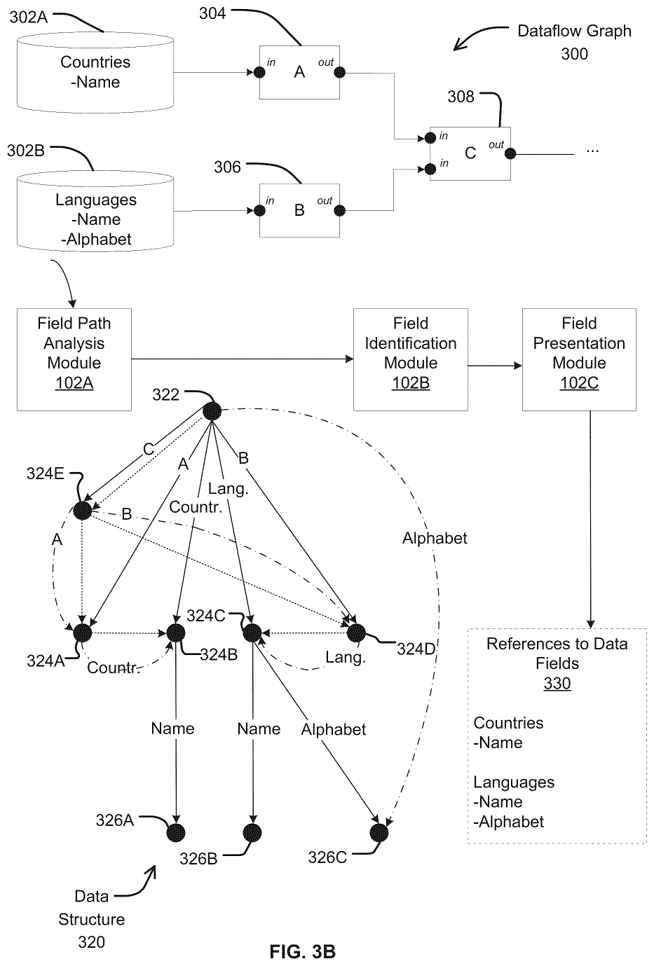

As shown in FIG. 2C, the field path analysis module 102A processes a topology of the dataflow graph 160 and/or portions thereof. The field path analysis module 102A processes a topology (or portion thereof) of the dataflow graph 160 by generating, for a point in the dataflow graph 160 (e.g., for which a user requested available fields), a data structure indicating data fields available at the point and one or more paths through which the data fields reach the point. In some embodiments, a data structure generated for a particular point may be a hierarchical data structure. For example, the data structure may be a tree structure. Example tree structures are described herein with reference to FIGS. 3A-9D.

In some embodiments, the field path analysis module 102A may generate a data structure for a particular point using a data structure generated for a preceding point in a path of the dataflow graph 160. For example, the field path analysis module 102A may generate a data structure for the output of component 152 using a data structure generated for the input to component 152. This may allow the field path analysis module 102A to efficiently generate the data structures for multiple points in the dataflow graph 160 (e.g., without having to generate an entirely new data structure for each point). In some embodiments, the field path analysis module 102A may generate a data structure for a point in the dataflow graph 160. The field path analysis module 102A may generate a data structure for a given point individually without incorporating information from a data structure generated for another point in the path. In some embodiments, the field path analysis module 102A may propagate a change in a data structure generated for one point (e.g., resulting from a change in the dataflow graph) to data structures of subsequent points. This allows the field path analysis module 102A to dynamically maintain an updated set of available fields for all the points according to a current state of the dataflow graph 160.

In some embodiments, a data structure generated by the field path analysis module 102A for a particular point may indicate one or more paths through which data fields reach the point. The path(s) may indicate which component each data field originated from and which component(s) each data field passes through. In some embodiments, the data structure may indicate, for each component in a portion of the dataflow graph 160 upstream of the point, a scope of data fields accessible at the component. A scope of a component may be represented by a node in the data structure referred to herein as a “scope node”. The data structure may include connections (also referred to as “edges”) between scope nodes associated with different components to indicate how a scope of one component flows to another component in the dataflow graph 160.

In some embodiments, the field path analysis module 102A may introduce additional scope nodes into a data structure associated with a point in the dataflow graph. For example, the field path analysis module 102A may introduce scope nodes to represent different processing paths in a dataflow graph (e.g., because a given data field may flow through both processing paths that generate different versions of the data field). If a particular data field is processed in multiple paths, the data in a resulting data field of one path may be different from a resulting data field of another path. The field path analysis module 102A may thus introduce a scope node to capture the different paths of the data field (e.g., to allow the field identification module 102B to differentiate between the data of each path using the data structure).

In some embodiments, a data structure generated by the field path analysis module 102A for a particular point may include nodes representing data fields available at the point. Such nodes may also be referred to herein as “data field nodes”. An edge in a data structure between a scope node and a data field node may indicate that the data field represented by the data field node is introduced by the component (i.e., accessible by subsequent components) represented by the scope node.

In some embodiments, a data structure may include a root node representing a point for which the data structure is generated. The data structure may be traversed along edges from the root node to the data field nodes to determine references to the data fields available at the point. In some embodiments, the data structure may include edge(s) between one or more data field nodes and the root node. One type of edge between the root node and a data field node may be a link edge. A link edge may indicate that the name of a data field represented by the data field node can be used to reference the data field without resulting in ambiguity with another data field (e.g., because the name of the data field is not shared with a data field from any other source).

As shown in FIG. 2C, the field path analysis module 102A generates data structures 150 for different points in the dataflow graph 160. The field identification module 102B uses the data structures 150 to determine references 152 to data fields that are available at each of the points. The field identification module 102B may identify the available data field(s) at a particular point by scanning a data structure associated with the point that encodes the references. The field identification module 102B may determine the data fields represented by the data field nodes in the data structure to be the available data fields at the point. The field identification module 102B may determine references to the data fields available at the point based on edges between the root node and data field nodes.

In some embodiments, the field identification module 102B may determine references 152 to data field(s) available at a particular point in the dataflow graph 160 (e.g., using a data structure generated by the field path analysis module 102A for the point). The field identification module 102B may determine a reference for a particular data field based on edges between a root node of the data structure and a data field node of the data structure representing the particular data field. In some embodiments, when the field identification module 102B identifies a route through a link edge between the root node and the data field node, the field identification module 102B may determine the reference to be a name of the particular data field. The link edge may indicate that there is no ambiguity in the name of the particular data field with that of another data field. In some embodiments, when the field identification module 102B identifies a route through an intermediate scope node, the field identification module 102B may generate a reference based on the intermediate scope node. This may disambiguate the data field from another data field available at the point (e.g., with the same field name). For example, the field identification module 102B may generate a reference indicating a data source of the particular data field to disambiguate the data field from another data field with the same name from a different data source. As another example, the field identification module 102B may generate a reference indicating a path through which the data field arrived at the point to disambiguate the data field from a different version of the data field arriving at the point from another path.

As shown in FIG. 2C, the field identification module 102B generates, for each of multiple points in the dataflow graph 160, references 152 to data fields available at points. The field presentation module 102C presents a display of the references 152 in a GUI (e.g., as described herein with reference to FIGS. 2D-2E). The field presentation module 102C generates listings of references to data fields available at points in the dataflow graph 160. The field presentation module 102C may generate a field presentation interface 170 displaying a field reference listing for a given point.

FIG. 2D shows a field presentation interface 170 showing a display of references to data fields available at the output of the component 152 in the dataflow graph 160 of FIG. 2B, according to some embodiments of the technology described herein. As shown in FIG. 2D, the display includes a field reference listing 172A. The field reference listing 172A shows the name of the data fields available at the point in the dataflow graph grouped by data source. The field reference listing 172A displays references to available fields in a manner that clarifies ambiguous field names.

In some embodiments, the field presentation module 102C may generate the field presentation interface 170 in response to user input. For example, the field presentation module 102C may generate the field presentation interface 170 in response to selection of an “Available Fields” option in the software application development GUI 142 for a particular point. In some embodiments, the field presentation module 102C may generate the field presentation interface 170 in response to selection of a point in the dataflow graph 160.

In some embodiments, the field identification module 102B may track attributes of data fields. For example, the field identification module 102B may track data types of data fields through the paths by which they reach a point. In some embodiments, a data structure corresponding to a point may store or reference attributes for each data field. For example, the data structure may store or reference a data type of each data field in a node representing the data field in the data structure. The data type of a data field may be presented along with a reference to the data field (e.g., by the field presentation module 102C).

In some embodiments, the field presentation module 102C may generate the reference listing to indicate the source of each data field available at a point (e.g., by grouping the data field names by data source). In some embodiments, the field presentation module 102C may generate the reference listing to indicate a data source of some data fields (e.g., to disambiguate data fields with the same name) without indicating the data sources of other fields (e.g., which do not have ambiguous names). In some embodiments, the field presentation module 102C may generate the reference listing to indicate a path through which the data field arrived at the point (e.g., to distinguish another instance of the data field that arrived from a different path). For example, in a field reference listing for a point, the field presentation module 102C may put a parenthetical string adjacent a data field's name in the listing indicating its source (e.g., source dataset and/or path). The field reference listing 172A shows fields available from the country dataset that arrived at the component 152 through Op 1 (i.e., component 154) and fields available from the country dataset that arrived at the component 152 through Op 2 (i.e., component 148).

As shown in FIG. 2D, the field reference listing 172A shows information about each of the data fields including a data type and size of the data field. The field presentation interface 170 further includes a section 174A displaying information about a field selected from the field reference listing 172A. The selected field information section 174A includes a field name, a data type, and a default value of the field. In some embodiments, the selected field information section 174A may display other information about a selected field in addition to or instead of the example information shown in FIG. 2D.

FIG. 2E shows the field presentation interface 170 with another listing references to data fields available at the output of the component 152 in the dataflow graph 160 of FIG. 2B, according to some embodiments of the technology described herein. The field presentation interface 170 includes a field reference listing 172B with a flattened list of references available at the selected point in the dataflow graph. The field presentation interface 170 displays field names that are ambiguous (e.g., due to a field name collision and/or the field arriving at the point through multiple processing paths) with indications of a field source in parenthesis next to the field name. In the example of FIG. 2E, the name field from the country dataset that reached the point through the component 148 is listed as “Name (Country via Op 1)” adjacent to the field name while the name field from the country dataset that reached the point through the component 154 is listed as “Name (Country via Op 2)”. This disambiguates the fields which, despite having the same source dataset, arrive at the point through different processing components. The fields from the language dataset have a parenthetical next to the field names that indicate their source datasets, but not a processing path. This is because the fields from the language dataset arrive at the point through only one processing path. Thus, there is no need to disambiguate based on processing path in addition to source dataset.

The field presentation interface 170 of FIG. 2E further includes a section 174B displaying information about a field selected from the field reference listing 172B. The selected field information section 174B includes a field name, a data type, and a default value of the field. In some embodiments, the selected field information section 174B may display other information about a selected field in addition to or instead of the example information shown in FIG. 2E.

In some embodiments, a field reference listing may disambiguate data fields in one or more ways. For example, the field reference listing may indicate a data source of each field in parenthesis next to the field name. As another example, the field reference listing may include an additional column indicating a source of the data field. As another example, each entry in the field reference listing may be colored differently to disambiguate data fields. This disambiguation prevents the user from confusing the two data fields with the same name. In some embodiments, the field reference listing may disambiguate field names using a combination of multiple techniques.

FIG. 3A illustrates an example of the field identification module 102B of the field resolver module 102 identifying data fields available at a point in a dataflow graph 200, according to some embodiments of the technology described herein. In some embodiments, the dataflow graph 200 may be developed in a software application development environment provided by the data processing system 100.

The dataflow graph 200 includes a component “A” 204 that can access data from a dataset “D1” 202A with a field “X”, and a component “B” 206 that can access data from a dataset “D2” 202B with fields “X” and “Y”. The outputs of components 204, 206 are provided as input to a component “C” 208, which outputs data to an output sink 210.

In the example of FIG. 3A, the field identification module 102B is identifying available data fields at the output of the component “C” 208. Accordingly, the field identification module 102B accesses a data structure 220 generated for the point (e.g., by field path analysis module 102A during development of the dataflow graph 200). In some embodiments, the field identification module 102B may access the data structure 220 from memory of the data processing system 100. In some embodiments, the data structure 220 may be stored in memory of a user's device and the field identification module 102B may access the data structure 220 from the user's device.

As shown in the example of FIG. 2, the data structure 220 is a tree structure. The data structure 220 includes a root node 222, scope nodes 224A, 224B, 224C, 224D, 224E representing scopes of respective components of the dataflow graph 200. The data structure 220 further includes data field nodes 226A, 226B, 226C representing respective data fields that are available at the output of the component “C” 208 in dataflow graph 200. The data structure 220 includes edges connecting respective pairs of nodes. An arrow between a first scope node and a second scope node indicates that the scope represented by the second scope node is within the scope represented by the first scope node.

The scope node 224A represents a scope of data fields that reach the point through component “A” 204. The data structure 220 includes a dotted edge between the scope node 224A and the scope node 224B (which represents the scope of data fields that reach the point through the dataset “D1” 202A). This indicates that the scope obtained through the component “A” 204 includes the scope of data fields in dataset “D1” 202A. Thus, the component “A” 204 has access to the field “X” of dataset “D1” 202A. This is indicated by the dotted edge between scope node 224A and scope node 224B, and the edge labeled “X” between scope node 224B and data field node 226A (which represents the field “X” of dataset “A” 202A).

The scope node 224D represents a scope of data fields that reach the point through component “B” 206. The data structure 220 includes a dotted edge between the scope node 224D and the scope node 224C representing the scope of data fields in dataset “D2” 202B. This indicates that the scope obtained through component “B” 206 includes the scope of dataset “D2” 202B. Thus, the component “B” 206 has access to the field “X” of dataset “D2” 202B and the field “Y” of dataset “D2” 202B. This is indicated by the dotted edge between scope node 224D and scope node 224C, and the connections labeled “X” and “Y” from scope node 224C to respective data field nodes 226B (which represents field “X” of dataset “D2” 202B) and 226C (which represents field “Y” of dataset “D2” 202B).

The scope node 224E represents the scope of data fields that reach the point through component “C” 208. The data structure 220 includes a dotted edge between the scope node 224E and the scope node 224A representing the scope of component “A” 204. This indicates that the scope obtained through component “C” 208 includes the scope of component “A” 204. Thus, the component “C” 208 has access to the fields output by component “A” 204. The data structure 220 further includes a dotted edge between the scope node 224E and the scope node 224D representing the scope of component “B” 206. This indicates that the scope obtained through component “C” 208 includes the scope of component “B” 206. Thus, the component “C” 208 has access to the fields output by component “B” 206.

The data structure 220 additionally includes a link edge labeled “Y” between the root node 222 and the data field node 226C representing the field “Y” of dataset “D2” 202B. This connection indicates that the field name “Y” can be resolved at the output of component 208 without any ambiguity (i.e., because there is no other field named “Y” that is available at the output of component 208). In contrast, there is no link edge between the root node 222 and either of the data field nodes 226A, 226B representing respective data field “X” from dataset “D1” and data field “X” from dataset “D2”.

The field identification module 102B generates references to the data fields available at the output of the component 208 using the data structure 220. For the data field “Y”, the field identification module 102B identifies the link edge between the root node 222 and the data field node 226C that represents the field “Y”. Thus, the field identification module 102B generates the reference “Y” for the field “Y” from dataset “D2” 202B. The field “Y” does not have a name that conflicts with any other field in this example. Thus, in this example, the reference to the data field is simply its name.

Both the dataset “D1” 202A and dataset “D2” 202B include a field named “X”. Thus, the data structure 220 does not include a link edge from the root node 222 to either of the data field nodes 226A, 226B representing respective fields “X” of dataset “D1” 202A and “X” of dataset “D2” 202B. Rather, the root node 222 is: (1) connected to the node 226A representing field “X” of dataset “D1” 202A through an intermediate edge labeled “D1” between the root node 222 and the scope node 224B representing the scope of dataset “D1” 202A; and (2) connected to the node 226B representing field “X” of dataset “D2” 202B through an intermediate connection labeled “D2” between the root node 222 and the scope node 224C representing the scope of dataset “D2” 202B.

Accordingly, the field identification module 102B generates the following references to the two fields named “X”: (1) “X” from “D1”; and (2) “X” from “D2”. As another example, the field identification module 102B may generate the references to the two field names as “D1.X” and “D2.X”. These references 230 to the data fields available at the output of the component “C” 208 may be presented in a software application development GUI (e.g., by field presentation module 102C as described herein with reference to FIGS. 2A-2C). The two fields named “X” may be disambiguated using various techniques described herein. For example, the two field named “X” may be presented as “D1.X” and “D2.X” in a presentation interface, or be displayed hierarchically to indicate one field named “X” sourced from dataset “D1” 202A and another field named “X” sourced from dataset “D2” 202B (e.g., as shown in FIG. 3A).

FIG. 3B illustrates another example of the field identification module 102B of the field resolver module 102 identifying data fields available at a point in a dataflow graph 300, according to some embodiments of the technology described herein. In some embodiments, the dataflow graph 300 may be developed in a software application development environment provided by the data processing system 100.

The dataflow graph 300 includes a component “A” 304 that can access data from a dataset “Country” 302A with a field “Name”, and a component “B” 306 that can access data from a dataset “Language” 302B with fields “Name” and “Alphabet”. The outputs of components 304, 306 are provided as input to a component “C” 308, which outputs data to an output dataset 310.

In the example of FIG. 3B, the field identification module 102B is identifying available data fields at the output of the component “C” 308. Accordingly, the field identification module 102B accesses a data structure 320 generated for the point (e.g., by field path analysis module 102A during development of the dataflow graph 300). In some embodiments, the field identification module 102B may access the data structure 320 from memory of the data processing system 100. In some embodiments, the data structure 320 may be stored in memory of a user's device and the field identification module 102B may access the data structure 320 from the user's device.

As shown in the example of FIG. 3B, the data structure 320 is a tree structure. The data structure 320 includes a root node 322, scope nodes 324A, 324B, 324C, 324D, 324E representing scopes of data fields obtained through different components of the dataflow graph 300. The data structure 320 further includes data field nodes 326A (representing the “Name” field from the “Country” dataset 302A), 326B (representing the “Name” field from the “Language” dataset 302B), and 326C (representing the “Alphabet field from the “Language” dataset 302B).

The scope node 324A represents a scope of data fields that reach the point through component “A” 304. The data structure 320 includes a dotted edge between the scope node 324A and the scope node 324B (which represents the scope of “Country” dataset 302A). This indicates that the scope of data fields obtained through component “A” 304 includes the data fields of the “Country” dataset 302A. Thus, the data fields that reach the point through component “A” 304 include the field “Name” of the “Country” dataset 302A. This is indicated by the connection labeled “Country” between scope node 324A and scope node 324B, and the dotted edge between scope node 324B and data field node 326A (which represents the “Name” field of the “Country” dataset 302A).

The scope node 324D represents a scope of data fields that reach the point through component “B” 306. The data structure 320 includes a dotted edge between the scope node 324D and the scope node 324C representing the scope of the “Language” dataset 302B. This indicates that the scope of data fields that reach the point through component “B” 306 includes the fields of the “Language” dataset 302B. Thus, the data fields that reach the point through component “B” 306 include the field “Name” of the “Language” dataset 302B and the field “Alphabet” of the “Language” dataset 302B. This is indicated by the dotted edge between scope node 324D and scope node 324C, and the connections labeled “Name” and “Alphabet” from scope node 324C to respective data field nodes 326B (which represents field “Name” of the “Language” dataset 302B) and 226C (which represents field “Alphabet” of the “Language” dataset 302B).

The scope node 324E represents the scope of data fields that reach the point through component “C” 308. The data structure 320 includes a dotted edge between the scope node 324E and the scope node 324A representing the scope of component “A” 304. This indicates that the scope obtained through component “C” 308 includes the scope of component “A” 304. Thus, the component “C” 308 has access to the fields output by component “A” 204 (e.g., the field “Name” from the “Country” dataset 302A). The data structure 320 further includes a dotted edge between the scope node 324E and the scope node 324D representing the scope of component “B” 306. This indicates that the scope obtained through component “C” 308 includes the scope of component “B” 306. Thus, the component “C” 308 has access to the fields output by component “B” 306 (e.g., the fields “Name” and “Alphabet” from the “Language” dataset 302B).

The data structure 320 additionally includes a dashed line “Alphabet” between the root node 322 and the data field node 326C representing the field “Alphabet” of the “Alphabet” dataset 302B. This dashed line is a link edge indicating that the field name “Alphabet” can be resolved at the point without any ambiguity.

The field identification module 102B generates references to the data fields available at the output of the component 308 using the data structure 320. For the data field “Alphabet”, the field identification module 102B identifies the link edge between the root node 322 and the data field node 326C that represents the field “Alphabet”. Thus, the field identification module 102B generates the reference “Alphabet” for the field “Alphabet” from the “Language” dataset 302B. The field “Alphabet” does not have a name that conflicts with any other field in this example.

Both the “Country” dataset 302A and the “Language” dataset 302B include a field named “Name”. However, the field “Name” in the “Country” dataset 302A is the name of a country while the field “Name” in the “Language” dataset 302B is the name of language. Accordingly, there would be ambiguity if both fields were presented using only their field name “Name”. Thus, the data structure 220 does not include a link edge from the root node 322 to either of the data field nodes 326A, 326B representing respective fields “Name” of the “Country” dataset 302A and the “Language” dataset 202B. Rather, the root node 322 is: (1) connected to the node 326A representing field “Name” of the “Country” dataset 302A through the intermediate edge labeled “Country” between the root node 322 and the scope node 324B; and (2) connected to the node 326B representing field “Name” of the “Language” dataset 302B through the intermediate edge labeled “Language” between the root node 322 and the scope node 324C. Accordingly, the field identification module 102B generates the following references to the two “Name” fields: (1) “Name” from “Country”; and (2) “Name” from “Language”. These references 330 to the data fields available at the output of the component “C” 308 may be presented in a software application development GUI (e.g., by field presentation module 102C as described herein with reference to FIGS. 1A-2C). The references may allow a user to differentiate between the names of countries stored in the “Name” field of the “Country” dataset 302A and the names of languages stored in the “Name” field of the “Language” dataset 302B.

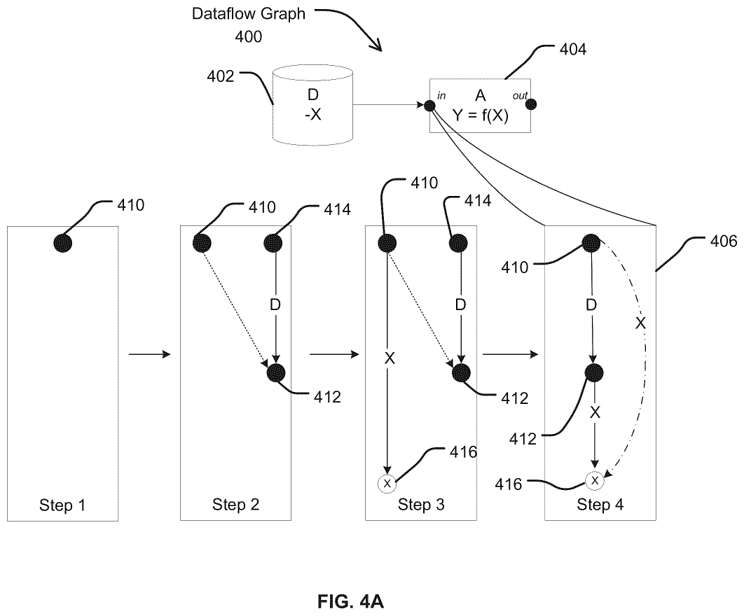

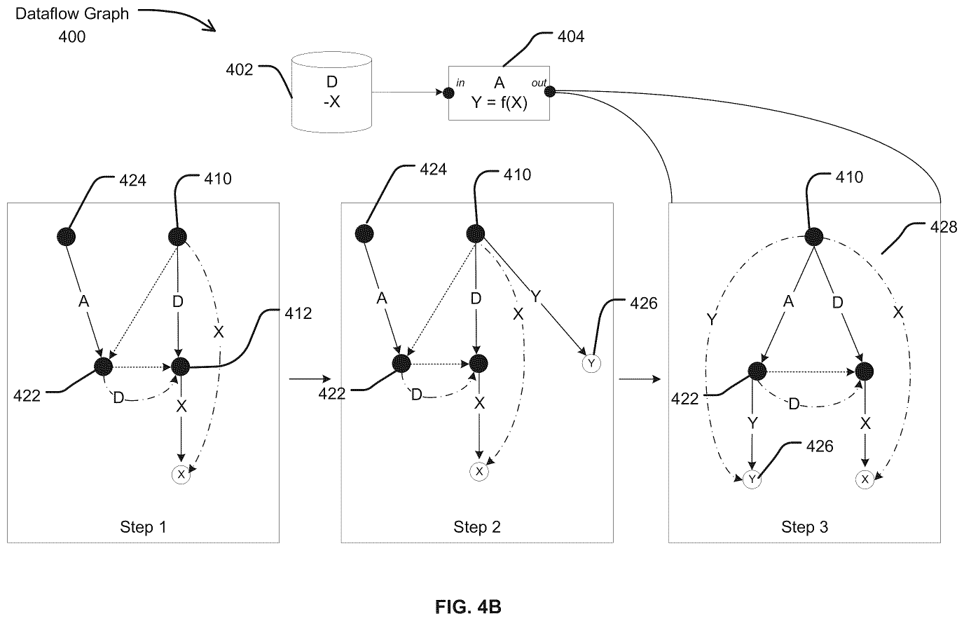

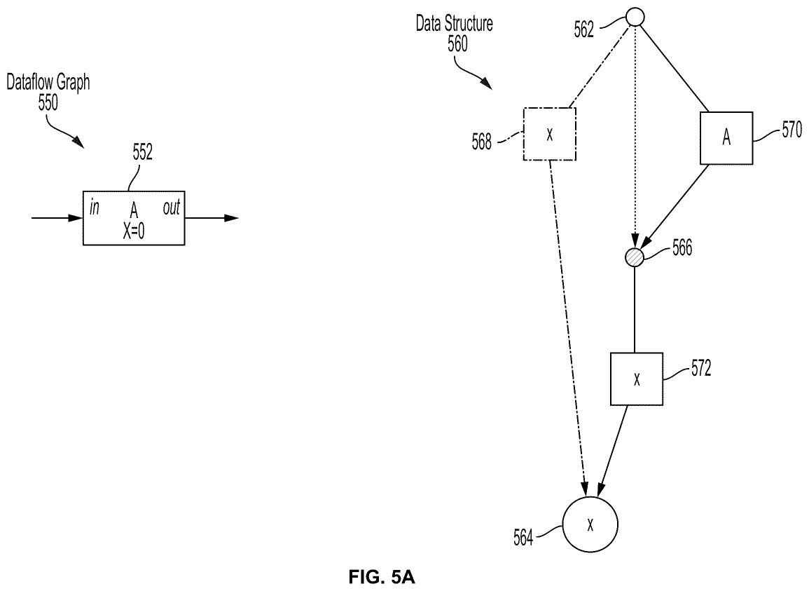

FIG. 4A illustrates an example of generating a data structure 406 indicating a path through which a data field becomes available at a first point in a dataflow graph 400, according to some embodiments of the technology described herein. The dataflow graph 400 includes a component 404 that can access data from the dataset “D” 402. The dataset “D” 402 includes a field “X”. In some embodiments, the data structure 406 may be generated by the field path analysis module 102A of the field resolver module 102 of data processing system 100 described herein with reference to FIGS. 2A-2E.

FIG. 4A shows a sequence of steps to generate the data structure 406 for the point corresponding to the input of the component “A” 404. At step 1, the system generating the data structure 406 (e.g., field path analysis module 102A) initiates the data structure with a root node 410. Next, in step 2, the system initiates a scope node “D” 412 associated with the dataset “D” 402 in the dataflow graph 400. The scope node is further connected to a temporary root node 414. The temporary root node 414 is introduced to prevent a conflict with any existing scope nodes with the same name (which do not exist in the current example). The temporary root node 414 remains the parent of the scope node 412 until the generation of the data structure 406 is completed.

In step 3, the system introduces a data field node 416 representing the field “X” of the dataset “D” 402 in the dataflow graph 400. The system adds the data field node 416 under the root node 410. The system adds the data field node 416 under the root node 410 to hide any node that shares the same name “X” without any other qualification. In this case, there is no such other node.

In step 4, the system transfers the scope node 412 generated for the dataset “D” 402 to the original root node 410 and removes the temporary root node 414. The system moves the data field node 416 representing the field “X” under the scope node 412. The system retains the connection between the root node 410 and the data field node 416 as a link edge (represented by the dashed line labeled “X” between the root node 410 and the data field node 416) because the value “X” does not conflict with the value of any other node. The data structure 406 thus indicates the data field “X” available at the input of the component 404 and the path through which the data field “X” reached the input of the component 404.

FIG. 4B illustrates an example of generating a data structure indicating paths through which data fields are available at a second point in the dataflow graph 400 of FIG. 4A downstream of the first node, according to some embodiments of the technology described herein. The second point is at the output of the component “A” 404. The component “A” 404 generates a data field “Y” using data from the field “X” of dataset “D” 402.

The system generates the data structure for the second point by propagating the data structure 406 generated for the first point forward. Accordingly, the system generates the data structure for the second point using the data structure 406. In step 1, the system introduces a temporary root node 424 and connects a new scope node 422 to the temporary root node 424. The scope node 422 represents the scope of data fields available at the output of component “A” 404. The system adds an edge represented by the dotted line between the new scope node 422 and the scope node 412 (which represents the scope of the dataset “D” 402). This indicates that the scope of the dataset “D” 402 is accessible by the component “A” 404. The system further adds the edge represented by the dashed line labeled “D” between the scope node 422 and the scope node 412 which represents that the name “D” at the component “A” 404 refers to the scope of the dataset “D” 402.

In step 2, the system adds a data field node 426 representing the data field “Y” introduced by the component “A” 404. The system adds an edge labeled “Y” between the root node 410 and the data field node 426. There is no other node with the name “Y” and thus the connection between node 426 and the root node 410 remains intact.

In step 3, the system removes the temporary root node 424 and transfers the scope node 422 for the component “A” to the root node 410. The system further adds an edge (labeled “Y”) between the scope node 422 and the data field node 426 (representing the field “Y”) indicating that the field “Y” reaches the point through the component “A” 404 (because the component “A” 404 generates the field “Y”). The link edge (dashed line labeled “Y”) between the root node 410 and the data field node 426 is maintained to indicate that the field “Y” can be referenced by its name of “Y” without any ambiguity (because no other node in the dataflow graph has a value of “Y”). The data structure 428 thus represents the data fields “X” and “Y” available at the output of the component “A” 404 and the paths through which the data fields “X” and “Y” reached the output of the component 404.

Although in the example of FIGS. 4A-4B, there are no scope nodes or data field nodes with conflicting names in the data structure 406, in other cases there may be conflicting names. In some embodiments, the data structure 428 may be updated by the system in response to changes in the dataflow graph 400 upstream of the output of component “A” 404. In some embodiments, the data structure 428 may be updated by generating a new data structure for a given point based on an updated dataflow graph 400. The new data structure may be generated using techniques described herein. In some embodiments, the data structure 428 may be updated by regenerating the data structure 428 based on the updated dataflow graph 400. In some embodiments, the data structure 428 may be updated by modifying a previously generated data structure that was previously generated for a point. This provides a user with an indication of current data fields available at a particular point based on a current state of the dataflow graph 400.

### Examples of Data Structure Generation

As described herein, in some embodiments, data structures may be used to determine references to data fields available at points in a dataflow graph. The data structure indicates unambiguous references to data fields available at a given point in the dataflow graph. In some embodiments, the system generates a hierarchical data structure. For example, the hierarchical data structure may be a tree structure that can also be referred to as a “watch-all tree”. The tree data structure encodes references to the data fields which may be used to present the available data fields (e.g., in a software application development GUI). A collection of references to data fields derived from a watch-all tree may be referred to as a “watch-all type”. In some embodiments, a data structure may be represented as code and/or as a graph.

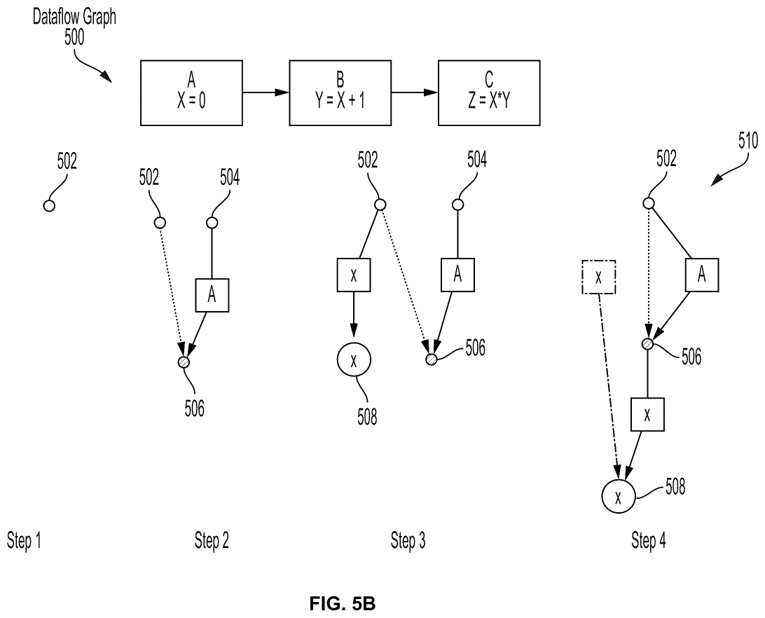

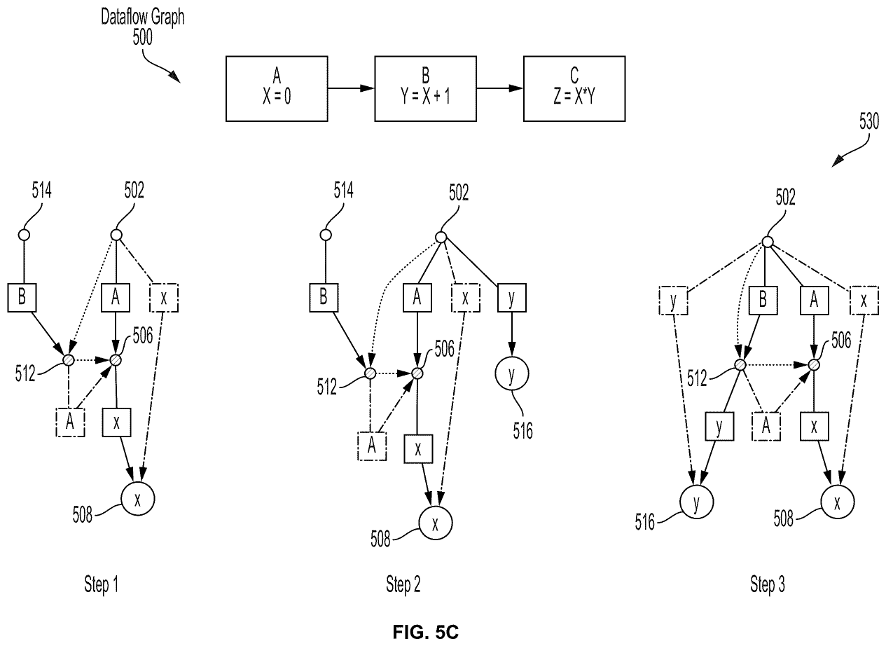

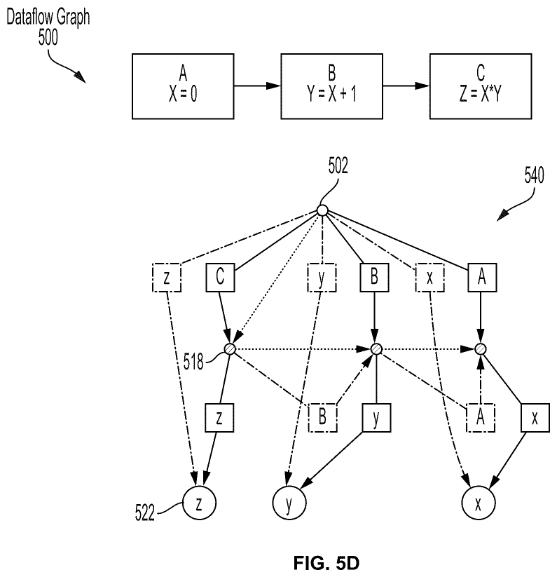

In some embodiments, a graph representing a data structure may include nodes which appear as circles or ovals in a data structure. There are three categories of nodes: root nodes, scope nodes, and data field nodes. The category of a node may also be referred to as its “disposition”. FIG. 5A shows an example depiction of a data structure 60 that may be generated by a system (e.g., by field path analysis module 102A) for a point in a dataflow graph.

FIG. 5A shows a dataflow graph 550 and an example data structure 560 indicating a path through which a data field becomes available at a point in the dataflow graph 550, according to some embodiments of the technology described herein. In the dataflow graph 550, the component “A” 552 generates a field “X” with a value of 0. The data structure 560 corresponds to a point at the output of the component “A” 552 in the dataflow graph.

In the data structure 560, there is a root node 562, a data field node 564 for the field “X” represented as a circle, and a scope node 566 represented as a circle for the processing component “A” in the dataflow graph. Besides nodes, the data structure 560 includes labels of edges. The labels are shown as boxes in the data structure 560. The labels include a label “X” 568 of the link edge between the root node 562 and the data field node 564, a label “A” 570 of the edge between the root node 562 and the scope node 566, and the label “X” 572 of the edge between the scope node 566 and the data field node 564.

In some embodiments, labels on edges emanating from a given node are all distinct. A given node may be represented by a key-value map indicating one or more nodes emanating from the given node. Labeled edges fall into two categories: child edges and link edges. If there is a child edge from a first node to a second node, the second node may be referred to as a “child node” of the first node. The source of a child edge is the parent of its target and is labeled with the name of its target. In some embodiments, each node in a data structure has zero or one parent nodes. Generally, only a root node lacks a parent. If a node is the parent of a child node, exactly one child edge must exist from the parent to the child. The child edges and link edges form a tree that indicates references to data fields available at a point in a dataflow graph associated with the data structure. A set of reference(s) to respective data field(s) available at a point in a dataflow graph may also be referred to as a “watch-all type”. In the example of FIG. 5A, the data structure 560 indicates the below watch-all type for the output of component “A” 552 in dataflow graph 550.
a. record
   i. record
      1. int X;
   ii. end A;
b. end

As shown above, the references indicate the data type of each data field. In the above example, the reference to the field “X” indicates that the data type for the field “X” is an integer. In some embodiments, the data type of each data field may be stored in association with the data structure 560. Accordingly, the data types of data fields referenced by the data structure may be accessed (e.g., for presentation in conjunction with references to the data fields). For example, a data type of a data field may be stored in association with a data field node representing the data field in a data structure.

In some embodiments, a data structure may have restrictions on which connections in the data structure are valid. A data structure may only have the following child edges:
a. Child edges from a root node to scope node;
b. Child edges from a scope node to data field nodes;
c. Child edges from a root node to data field nodes; and/or
d. Child edges from a data field node to other data field nodes.

In some embodiments, a data structure of child edges has a depth at most 2. Accordingly, a first layer of the data structure refers to either a scope name visible on the current canvas or a data field introduced at the point. In some embodiments, deeper trees of data field nodes come from values with hierarchical DML types. In such cases, the values that are children of values remain with their parents.

In some embodiments, a data structure may only have the following link edges.
a. A link edge from root node to data field node;
b. A link edge from scope node to a data field node; and/or
c. A link edge from a scope node to another scope node.

Note that link edges do not correspond to parts of the display watch-all type. In the above example, there is no “X” at top level, even though it is pointed to by a link edge from the root node. The displayed watch-all type would be determined by a technique used to generate references to data fields. For example, the display watch-all type may be generated by always using child edges. As another example, the display watch-all type may be generated by using the child edges only in cases where there is a potential ambiguity in references.

Another type of edge stored in a data structure may be referred to as an “include edge”. A root node or a scope node can include any number of other nodes. However, a node may be included by at most one other node. Like link edges, include edges are ignored when constructing a watch-all type. An include edge makes the named edge(s) of an included node visible at the node from which the include edge emanates. In some embodiments, an include edge may ignore any nodes that are ambiguous because they appear in multiple included nodes or that are hidden because an edge with that name exists on the current node. In some embodiments, the tree structure created by include edges flows in the opposite direction of path(s) in the dataflow graph.

Some embodiments use a recursive technique for resolving a reference to a data field. A data field corresponds to a data field node (from which a reference to a respective data field can be extracted). In some embodiments, a reference to a data field may be indicated as a sequence of identifiers separated by dots. The identifiers may each indicate a respective component of a dataflow graph. In some embodiments, the system resolves data fields available at a point by starting at a root node. The system may execute the following steps to resolve a field name for a particular point in a dataflow graph. The steps may begin at a root node of a data structure associated with the point.
a. If there are no further identifiers in the field name, then return the current node.
b. For a head identifier of the field name, determine whether the current node has an edge labeled with the name of the head identifier.
   i. If the current node has an edge labeled with the name of the head identifier, follow the edge to its target node and resolve the rest of the name from the target node. For example, the target node may be a data field node or another scope node.
   ii. If the current node does not have an edge labeled with the name of the head identifier, then resolve the head identifier from each node included by the current node. If exactly one of these is non-NULL, resolve the rest of the field name from the node.

In the example of FIG. 5A, when the system resolves the field name “X” starting from the root node 562, the system starts by looking for an edge labeled “X” emanating from the root node 562. The system identifies the edge with the label “X” 568 between the root node 562 and the data field node 564. After resolving the field name “X”, the system has no other portion of the field name remaining and the data field resolution is complete. In this example, the system may thus determine a reference to the field “X” as simply its field name of “X”.

FIG. 5B illustrates an example of generating a data structure 510 indicating a path through which a data field becomes available at a first point in a dataflow graph 500, according to some embodiments of the technology described herein. The first point for which the data structure 510 of FIG. 5B is generated is the point in the dataflow graph 500 at the output of the component “A”. The component “A” sets the value of a data field named “X” to 0. The output of the component “A” is connected to the component “B” which defines a data field named “Y” storing a value of the field “X” summed with 1. The output of the component “B” is connected to the component “C” which generates a field “Z” with a value equal to the value of the field “X” multiplied by the value of the field “Y”. The dataflow graph 500 may also be described by the below code:

```
branch {
  easy compute { label = “A”; let x = expr (o); }
  easy compute { label = “B”; let y = expr (x + 1); }
  easy compute { label = “C”; let z = expr (x y); }
  }
```

As shown in FIG. 5B, a system generating the data structure 510 (e.g., the field path analysis module 102A) begins by generating a primary root node 502 at step 1. Then, in step 2, the system enters the first component “A” by creating a new scope node 506 and connects the scope node with an edge labeled “A” to temporary root node 504. The system connects the scope node 506 to the temporary root node 504 because connecting it to the primary root node would hide any existing values/scopes with the unqualified name “A” (which there happen to be none of in this particular example). The scope node 506 has a parent node which it can query for its name and receive the correct answer (which is “A” in this example). The system further adds an include edge from the primary root node 502 to the new node 506, because this is now the most recent scope node and thus the first place to look for names that don't resolve in the root node.

Next, in step 3, the system adds in a data field node 508 for the field “X”. Its expression doesn't reference anything, so the system does not need to mutate it and only needs to create it under its name “X”. The system creates the data field node 508 (e.g., storing a mutable value pointer) and connects it to the primary root node 502 with the edge labeled “X”. This time the system does not hide anything that currently has the unqualified name of “X”.

Next, in step 4, the system leaves the scope node 506 for component “A”. The system transfers the scope node 506 to the primary root node 502, thereby hiding anything that previously had the name “A”. The system further connects data field node 508 to scope node 506 but retains previous edge between the root node 502 and the data field node 508 as a link edge (labeled “X”). This tree structure is also what would be used to determine references to the data fields available at the output of the component “A”, or the input for the component “B” and/or determine how the references to the data fields are displayed.

FIG. 5C illustrates an example of generating a data structure 530 indicating paths through which data fields become available at a second point in the dataflow graph 500 of FIG. 5C, according to some embodiments of the technology described herein. The second point is the output of the component “B” which generates a new data field “Y” with a value equal to the value of the field “X” summed with 1.

The system begins by entering a new scope node 512 for the component “B”. In step 1, the system connects the new scope node 512 to a temporary root node 514, under the name “B”. The system transfers the include edge of the primary root node 502 (i.e., the unlabeled edge between primary root node 502 and the scope node 506 of the data structure 510 shown in FIG. 5B) to the new scope node (so the new scope node now includes the “A” scope node) and adds a new include edge between the primary root node 502 and the new scope node 512. The system further ensures that everything that was visible from the root node 502 is now visible under the same name from the new scope node 512. Some of this was performed by way of transferring the include edge from the root node 502 to the scope node 512. The system may add a link edge from the new scope node 512 or move a child edge to the new scope node 512 for children value.

In the example of FIG. 5C, the field “X” is visible from the component “B”. Thus, the system adds an include edge between the scope node 512 and the scope node 506, which makes the scope of the component “A” visible to the scope node 512. The system further introduces a link edge between the scope node 512 and the scope node 506 to resolve names such as “B.A.X”. In some embodiments, the system may make a data field node visible by its name to hide a link edge (e.g., if B introduced a value named A, B.A would refer to the value, not the scope). Adding link edges, moving definitions, and rearranging include edges may also be referred to as snapshotting the root into the new scope.

In step 2, the system adds a data field node “Y” 516 and resolves a reference to the data field node “X” 508. The field “Y” has a reference in it to field “X” because it is defined based on the value of field “X”. Accordingly, the system uses the tree structure to identify a reference “Y” visible. The unqualified field name “X” resolves to the data field node 508, which may store a reference to a data field. The system makes the data field node “Y” 516 visible by adding it to the root node 502. Note that if there were an existing edge from the root node 502 labeled “Y”, the system would hide the data field node “Y” 516 from the current scope node and would hide a link edge between the root node 502 and the data field node 516 representing the field “Y”. In the case of an existing scope node named “Y”, the system would rename the scope node (which is also referred to as “rehoming” the scope node) and the system would allow the data field node to claim the unqualified name “Y”.

In step 3, the system transfers the scope node “B” 512 to the primary root node 502. In some embodiments, the system may perform further processing if there were any node connected to the primary root node 502 with the name “B”. For example, the system may hide a link edge to a data field node, rehome a scope node, and/or move a data field node edge to the current scope node without a link edge to the primary root node 502 (e.g., in the case of a scope node “B” introducing a value named “B”, where the system must give the unqualified name “B” to the scope node). After the scope node 512 is transferred to the primary root node 502, the system moves existing data field node definitions at the primary root node 502 to the scope node 512 and replaces them with link edges in their original position (e.g., the edge labeled “Y” between the primary root node 502 and the data field node 516). The system further removes the temporary root node 514.

FIG. 5D illustrates an example of generating a data structure indicating paths through which data fields become available at a third point in the dataflow graph 500 of FIGS. 5B-5C, according to some embodiments of the technology described herein. The third point is the output of the component “C” in the dataflow graph 500. The data structure 540 of FIG. 5D is generated using the data structure 530 generated in FIG. 5C. As shown in FIG. 5D, the system adds in a scope node “C” 518 and adds a data field node “Z” 522 representing the field “Z” generated by the component “C” in the dataflow graph 500. The system adds a link edge labeled “Y” between the root node 502 and the data field node “Z” 522. The data structure 540 has an include edge connecting the primary root node 502 to the scope node 518 indicating that it is the latest scope node.

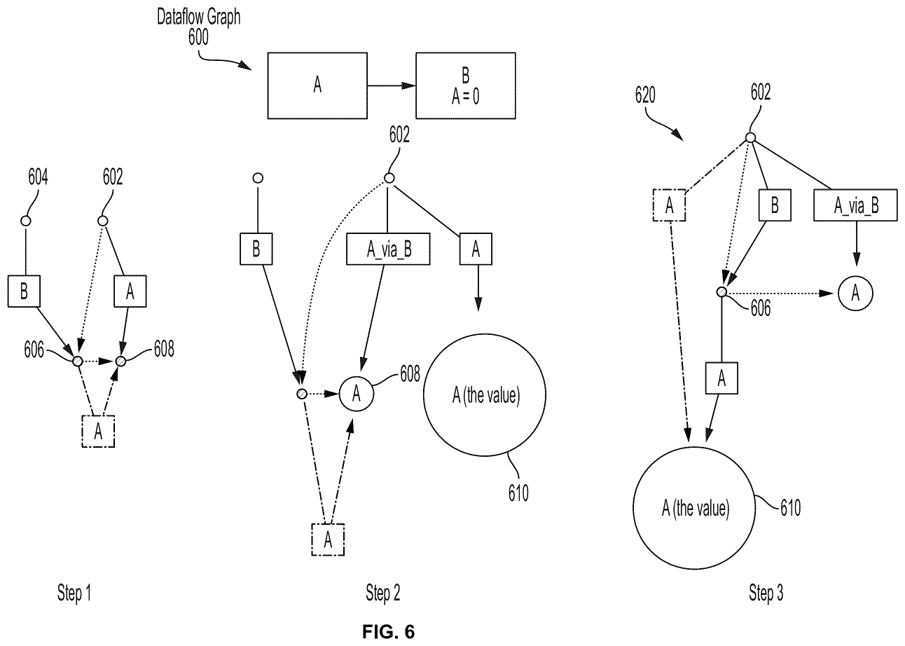

FIG. 6 illustrates an example of resolving ambiguity between a data field name and a name of a processing component of a dataflow graph 600 in a data structure 610 indicating data fields available at a point in the dataflow graph, according to some embodiments of the technology described herein. The point in the dataflow graph is the output of the component “B”. The dataflow graph 600 includes a component “A” which is connected to a component “B”. The component “B” generates a field with the name “A” and sets its value to 0. The dataflow graph 600 may also be represented by the below code.

| | |
|---|---|
| a. | branch { easy_compute { label = “A”; } easy_compute { label = |
| | “B”; let |
| | A = 0; } } |

In some embodiments, when a scope node or a data field node is to claim the unqualified name of the scope node, the system rehomes that scope node to remove any ambiguity. Rehoming refers to the system renaming a scope node based on its root. The system may retain the previous name of the scope node. The new name should still allow a user to tell which scope is being referred to.

In the example of FIG. 6, The field “A” is to be represented as a data field node named “A” in the data structure corresponding to the output of component “B”. However, the dataflow graph 600 includes a component “A”. Accordingly, there is a conflict in name between the field “A” generated by the component “B” and the component “A”.

In step 1, the system begins by introducing the scope node “B” 606 under a temporary root node 604. The system then needs to add a data field node “A”. However, the system recognizes that the data structure already includes a scope node “A” 608. Accordingly, in step 2, the system rehomes the scope node “A” 608. To do this, the system identifies an include edge pointing to the scope 608 to be rehomed. In the data structure shown in step 1, the identified edge is the edge labeled “A” between the root node 602 and the scope node 608. If there are none, rehoming fails. If there is one, the system follows the include edges backwards until there is none or the system reaches the root node 602. The system identifies the last scope node it reaches and uses it to determine a candidate name for the scope to be rehomed. In step 2, the system identifies scope node “B” and generates the candidate name as “A” (the current name of the scope node being rehomed) plus “_via_” plus the name of the includer (i.e., the scope node “B”). In this case, the unique candidate rehomed scope node name is “A_via_B”. If the candidate name is not in use at the root node, then rehoming succeeds and the scope node is renamed to the name. Otherwise, if the rehomed scope node name is in use and refers to another scope node, the system rehomes that other scope node. The system continues recursively until all the scope nodes are uniquely named. If that fails, then the system determines that rehoming fails.

The system changes the label on the child edge between the root node 602 and the rehomed scope node 608 (but not any link edges) to the chosen candidate name of “A_via_B”. This frees the name “A” at the root node 602 for the data field node “A” 610 while making the scope node “A_via_B” as indicated in the label between the root node 602 and the scope node 608. The disambiguation by another scope name is particularly helpful in cases where the name collision comes from graph topology (e.g., in the case of a join or gather). This allows the system to differentiate data fields from components of conflicting names.

In step 3, the system connects the scope node “B” 606 to the root node 602. The system creates a link edge between the root node 602 and the data field node “A” 610, which now does not have any conflict with a scope node due to the rehoming performed in step 2. The resulting data structure 620 of step 3 corresponds to the output of the component “B” and may be used to determine a reference to the field “A” (e.g., for display to a user in a software application development GUI).

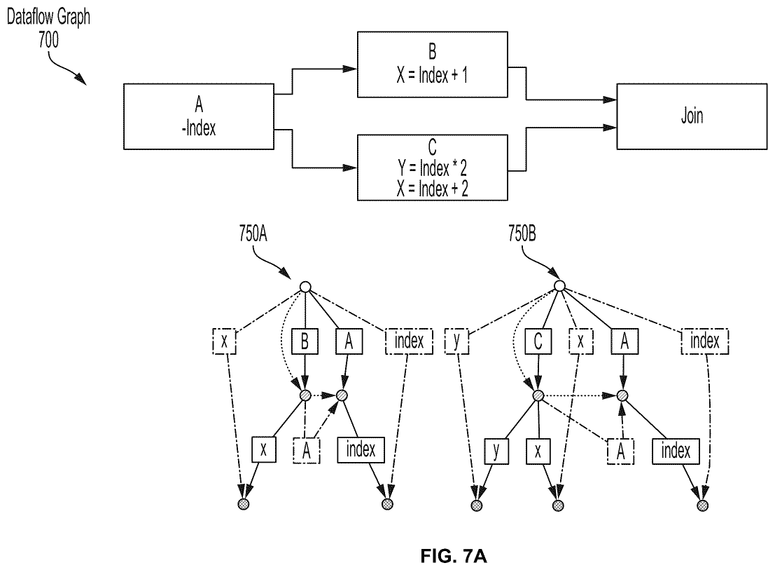

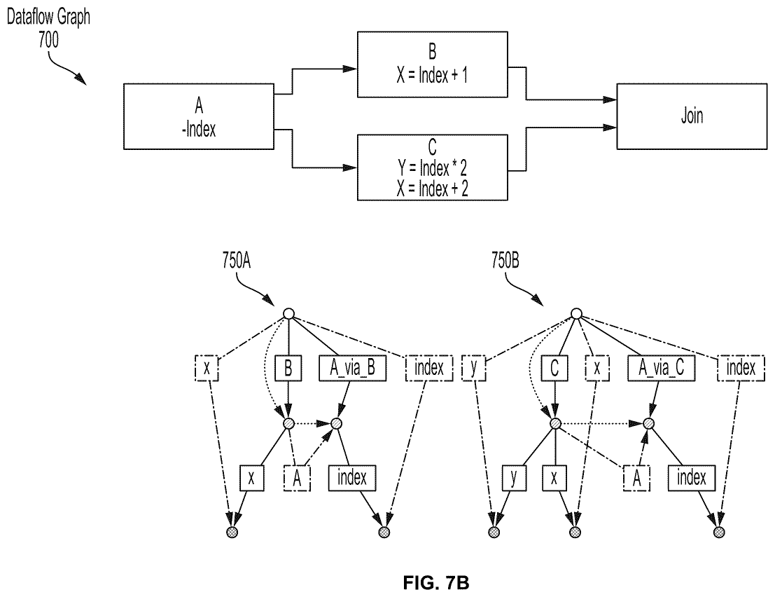

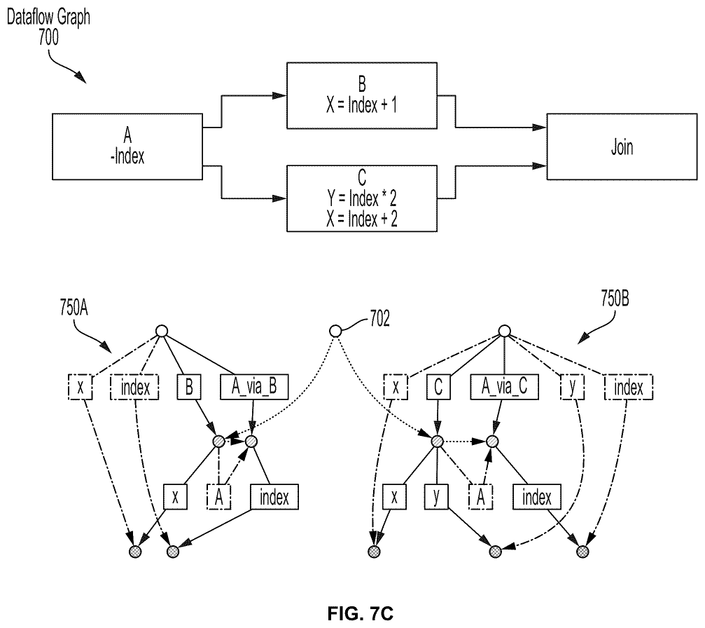

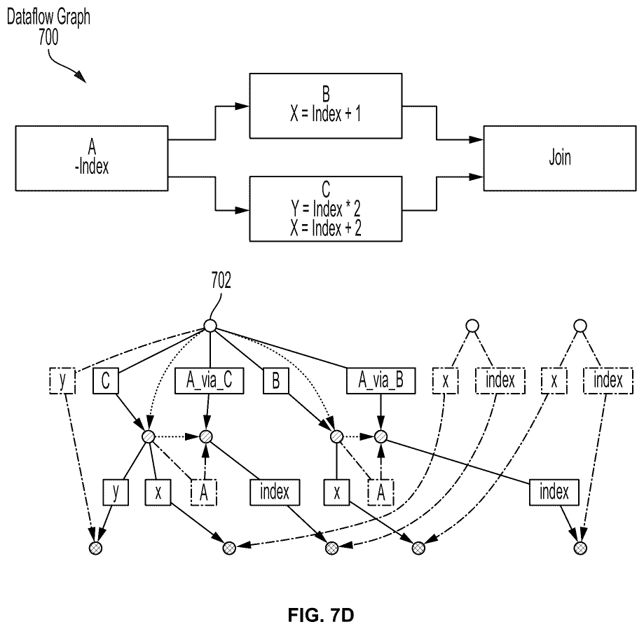

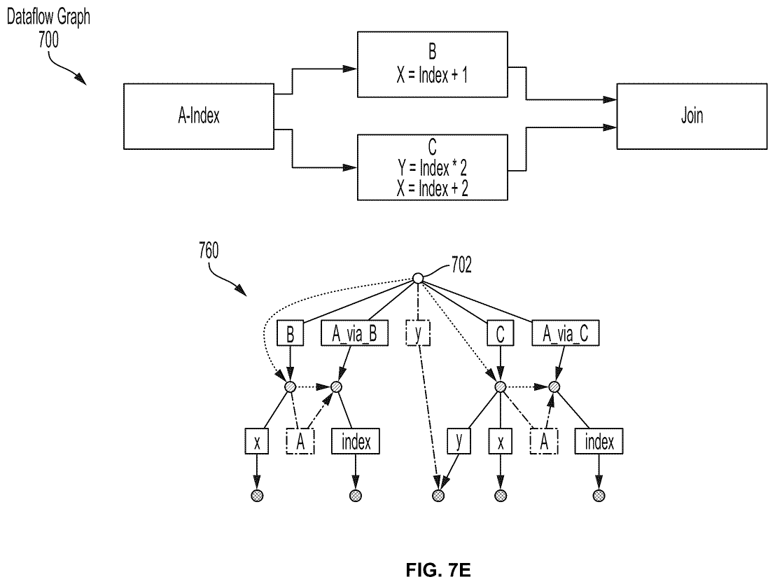

FIGS. 7A-7B illustrate an example of combining of two data structures 750A, 750B to generate a data structure 760 that indicates paths through which data fields reach an output of a join component in a dataflow graph 700, according to some embodiments of the technology described herein. The dataflow graph 700 includes a component “A” that generates a field “Index” storing the following set of values [1, 2, 3]. Components “B” and “C” in the dataflow graph 700 each accesses the “Index” field. Component “B” generates a field “X” with a value equal to the value of the field “Index” summed with 1. Component “C”: (1) generates a field “Y” with a value of the field “Index” multiplied by 2; and (2) generates a field “X” with a value of the field “Index” summed with 2. The outputs of the components “B” and “C” are inputs to a “Join” component in the dataflow graph 700. The “Join” component performs an inner join for records in which the value of field “X” equals the value of field “Y”. The dataflow graph 700 may also be represented with the following code.

| | |
|---|---|
| a. | node 0 easy_create { label = “A”; param record_count = 3; } # |
| | introduces |
| | field named “Index” |
| b. | node 1 easy_compute { label = “B”; flow from node 0; let X = |
| | expr (index |
| | + 1); } #introduces field named “X” |
| c. | node 2 easy_compute { label = “C”; flow from node 0; let Y = |
| | expr (index |
| | * 2); let X = expr (index + 2)} # introduces field named “Y” |
| d. | node easy_join { # inner join on X = Y |
| | label = “D”; |
| | flow from node easy_join_input { key (x); flow from node 1; } |
| | flow from node easy_join_input { key (y); flow from node 2; } |
| | } |

At a join point in a dataflow graph, multiple streams of data are combined in a Cartesian product or subset thereof. This means the meaningfully-referenceable fields after the join point are the disjoint union of the fields arriving on each input. Note that the union is always disjoint. Even if the same field is present on multiple input flows, each instance of it describes a different computation which can in general result in different values. Thus, a given field “X” input to a join operation may be different than a field “X” output from the join operation.

The system generates a data structure corresponding to each input to the join component. The two data structures are shown in FIG. 7A and include data structure 750A corresponding to the output of component “B” and data structure 750B corresponding to the output of component “C”. The system combines the data structures 750A, 750B by keeping any names which are unique among all inputs while modifying names that may have ambiguity. For data field nodes with a scope node as a parent, the system keeps the scope nodes as the parent and thus can be guaranteed that the canonical name, <scope's name>. <field name>, is unique. For scope nodes, the system determines a name that uniquely refers to the scope node. In this example, “A” does not uniquely refer to a scope node because it is present in both data structures 750A, 750B (i.e., because its output is connected to components “B” and “C”). However, the system determines that “B.A” uniquely refers to the scope of A flowing through component “B”. The system may flatten this name into a disambiguated name (e.g. “A_via_B”) which uniquely identifies the scope node.

In some embodiments, the system may ensure that each of the incoming data structures 750A, 750B has a unique scope included by the root. In cases such as this one where this is already true, the system does nothing. In cases where it is false for a given data structure, the system generates a named scope for the root node of the data structure. The system may choose a name for this scope (e.g., “_unnamed_scope_1”) that is distinct from all other names used in any of the input trees.

In FIG. 7B, the system rehomes scope nodes with non-unique names in both data structures 750A, 750B. In this example, both of the data structures 750A, 750B have a scope node “A” connected to its root node. Accordingly, the system rehomes the scope node “A” in each of the data structures 750A, 750B. In some embodiments, if rehoming fails, the system may generate an error. In this example, the system determines that the scope node “A” in the first data structure 750A can be disambiguated using the scope node “B” while in the second data structure 750B the scope node “A” can be disambiguated using the scope node “C”. Accordingly, in the first data structure 750A, the system renames the scope node “A” to “A_via_B”. In the second data structure 750B, the system renames the scope node “A” to “A_via_C”.

Next, as shown in FIG. 7C, the system begins combining the two data structures 750A, 750B. The system introduces a new root node 702 and transfers the include edges from each input's roots to the new root node 702. Accordingly, in the intermediate data structure of FIG. 7C, the new root node 702 is connected to the scope node “B” in data structure 750A and the scope node “C” in data structure 750B.

Next, as shown in FIG. 7D, the system transfers, to the new root node 702, all named edges from each input root node that are uniquely labeled among the combined set of edges from both data structures 750A, 750B. As shown in FIG. 7D, the system has transferred the following edges to the new root node 702: (1) the edge to the scope node “C”: (2) the edge to the rehomed scope node “A_via_C”; (3) the edge to the scope node “B”; (4) the edge to the rehomed scope node “A_via_B”; and (5) and the edge to the data field “Y”. The system does not transfer edges with labels that are shared between the two data structures 750A, 750B. Thus, each of the edges “X” and “Index” in each of the data structures 750A, 750B are not yet connected to the new root node 702.

Next, in FIG. 7E, the system disambiguates the edges with shared labels between the two data structures 750A, 750B. In this case, the ambiguous names are “X” and “Index”. In this case, the system removes the edges and the corresponding original root nodes to obtain the data structure 760. As the field “Y” is the only one that does not have ambiguity with any other field, it is the only one with a direct connection to the root node 702 (via the edge labeled “Y” between the root node 702 and the data field node for the field “Y”). Thus, the field “Y” is the only that would retain its unqualified name “Y”. The “X” data field nodes lost their unqualified names (as there are no longer edges going directly from the root node 702 to those fields). Each of the “X” data field nodes is connected by an edge to a respective one of the scope nodes “B” or “C”. Thus, the “X” fields may be referred to by canonical names “B.X” and “C.X” to disambiguate them. The “Index” data field nodes lost their unqualified names (as there are no longer edges going direction from the root node 702 to the “Index” fields in the data structure 760). Each of the “Index” data field nodes is connected by an edge to a respective one of the rehomed scope nodes “A_via_B” and “A_via_C” to disambiguate the field “Index” that flows out of component “B” from the field “Index” that flows out of component “C” to the join component. The Index fields' canonical names changed due to the rehoming of their parent scope.

In some embodiments, if there is more than one root with a child scope node of the same label, the system generates an error because the system may be unable to disambiguate between these scope nodes. Otherwise, the system ignores all link edges of the scope node and transfers the scope node to the output state. In some embodiments, for a data field node, the system checks for a unique link edge to the data field node. If the system finds one, the system generates a child edge between the source node and the data field node. Otherwise, the system removes the child edge from the tree entirely.

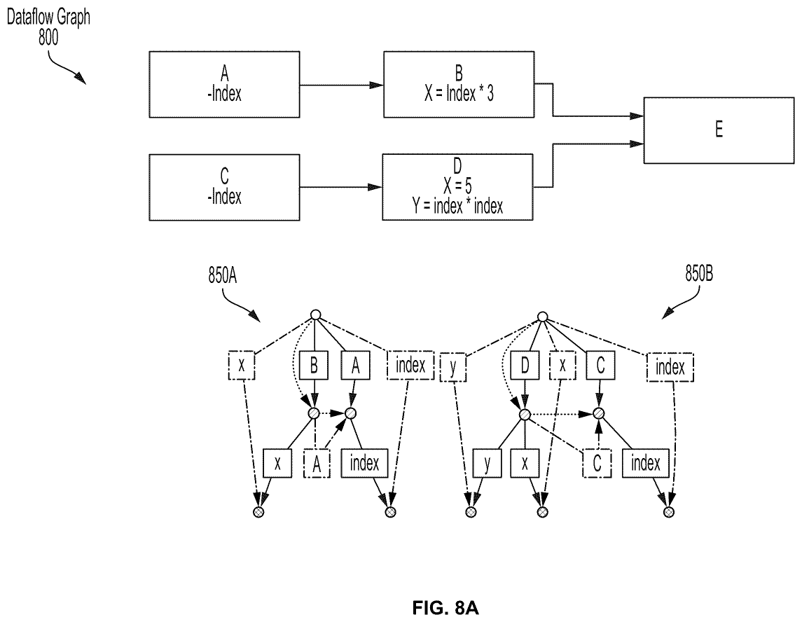

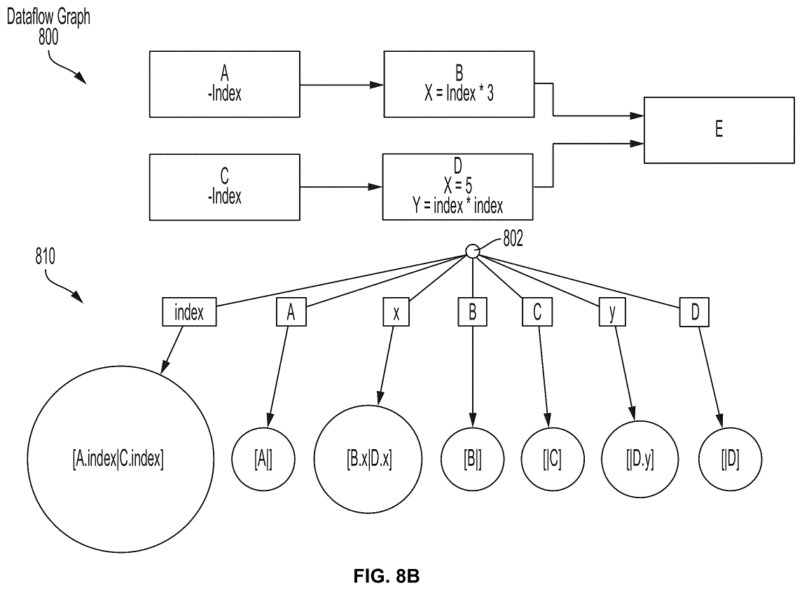

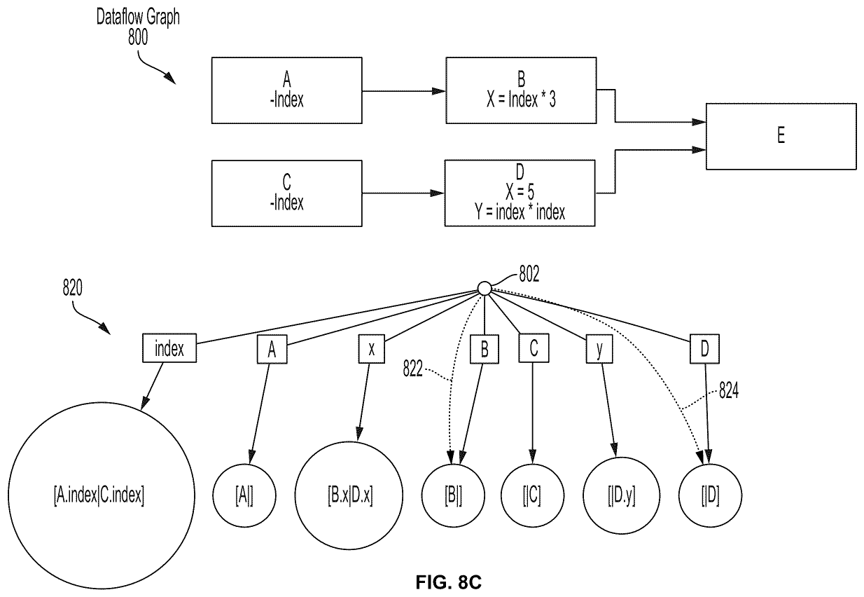

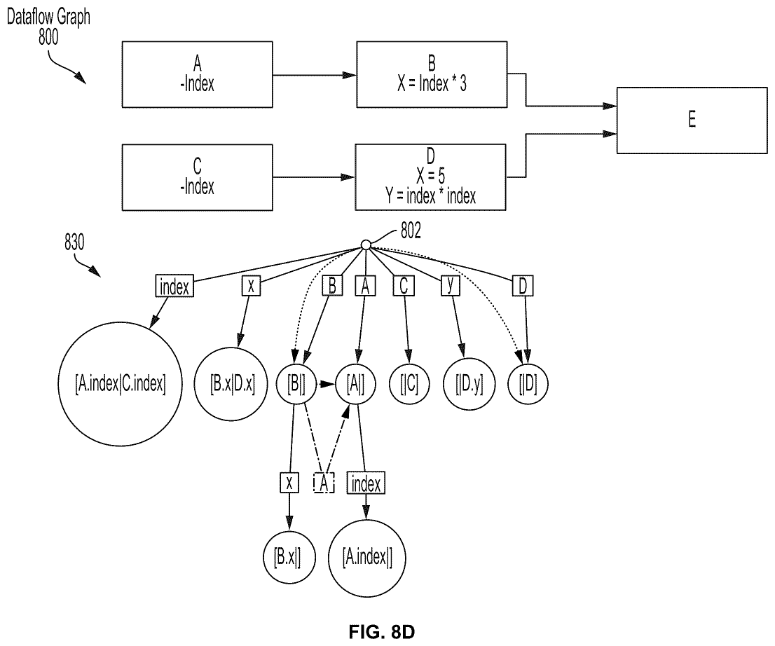

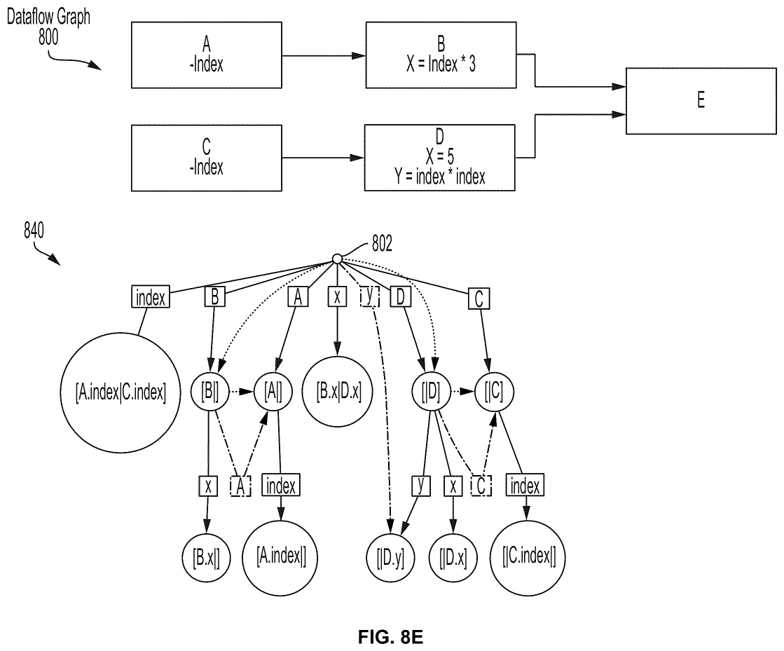

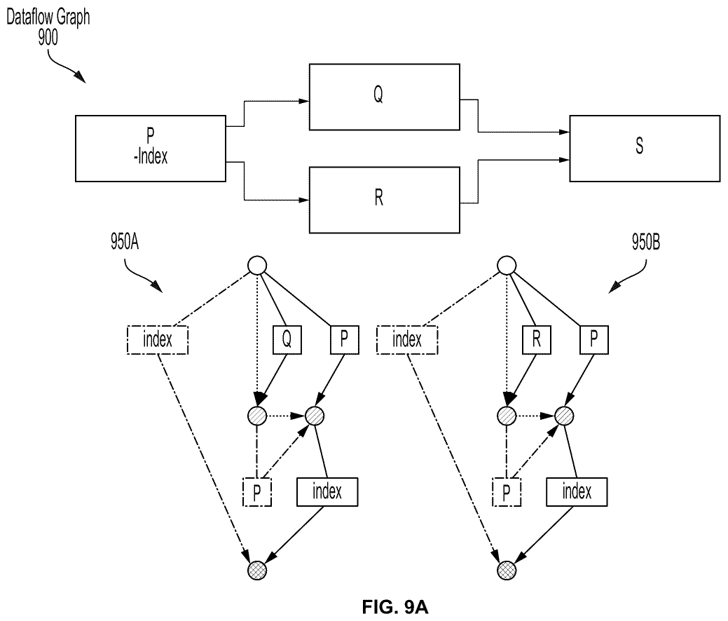

FIGS. 8A-8B illustrate an example of combining of two data structures 850A, 850B corresponding to inputs to a gather component “E” in a dataflow graph 800 to generate a data structure that indicates paths through which data fields reach the output of the gather component “E”, according to some embodiments of the technology described herein. The dataflow graph 800 includes a component “A” that generates a field “Index” which is used by the component “B” to generate a field “X” with a value defined as the value of the “Index” field multiplied by 3. The dataflow graph 800 includes another portion with a component “C” that generates another field “Index” which is used by the component “D” to generate a field “Y” with a value defined as the value of the “Index” field multiplied by itself. The component “D” also generates a field “X” with a value of 5. The outputs of components “B” and “D” are provided as input to the gather component “E”. The dataflow graph 800 may also be represented by the code below.

```
branch 0 {
  easy_create { label = “A”; param record_count = 2; } #introduces
    field name “index” taking on the values 1, 2
  easy_compute { label = “B”; let x = expr (index * 3); }
    #introduces field name “x” taking on the values 3, 6
  }
branch 1 {
  easy_create { label = “C”; param record_count = 3; } #introduces
    field named “index” taking on the values 1, 2, 3
  easy_compute { label = “D”; let x = expr(5); let y =
    expr)index*index); } #introduces field named “x” taking on
    the values 5, 5, 5, and “y” taking on the values 1, 4, 9
  }
node easy_compute {
  label = “E”’
  flow from branch 0;
  flow from branch 1;
  }
```

In this example, the “Index” field generated by component “A” stores values 1, 2. The “Index” field generated by component “C” stores values 1, 2, and 3. The output of the gather at the gather component “E” is shown in Table 1 below.

TABLE 1

| Index | A.Index | C.Index | X | B.X | D.X | Y |
|---|---|---|---|---|---|---|
| 1 | 1 | NULL | 3 | 3 | NULL | NULL |
| 2 | 2 | NULL | 6 | 6 | NULL | NULL |
| 1 | NULL | 1 | 5 | NULL | 5 | 1 |
| 2 | NULL | 2 | 5 | NULL | 5 | 4 |
| 3 | NULL | 3 | 5 | NULL | 5 | 9 |

In Table 1 above, the first two row records are generated from the input of the gather component “E” received from component “B”, while the three other row records are generated from the input of the gather component “E” received from component “D”. Note how each computation results in NULL when evaluated for a record from the other input, while names that make sense on either branch (e.g., “Index” and “X”) are never NULL but always take on a value from upstream (based on which input the record in question was generated from).

At the gather component “E” in the dataflow graph 800, multiple streams of data are combined in a disjoint union. Each record in the output stream corresponds to one record from one of the input streams. The meaning of a field name after a gather, for a given record in the gathered data, is whatever that name would have meant on the inflow that the record originated from. Therefore, the referenceable names are the union of the referenceable names of each inflow. However, some field names that were synonyms before the gather operation may no longer be, since they may now refer to new computations that select between results from multiple of the inflows.

FIG. 8A shows the data structures 850A, 850B representing the two inputs to the gather component “E”. Data structure 850A corresponds to the input from component “B” and data structure 850B corresponds to the input from component “D”. In some embodiments, unlike for joins, the system may not modify the two data structures 850A, 850B. Instead, the system may use them for reference to build an output data structure corresponding to the point at the output of the gather component “E”. In some embodiments, the system may perform a normalizing step: if either of the data structures 850A, 850B has a number of include edges greater than 1, or has a child data field node, the system enters and leaves a named scope node with a dummy name (e.g., “_unnamed_scope_3”). In this case, this is not necessary. The normalization step may be needed when attempting to handle a data structure where every edge (other than an include edge) is not labeled.

Next, the system avoids the case where the same unqualified name refers to a scope node in one data structure and a data field node in another data structure. The system checks each label of the edges emanating from the roots of the data structures 850A, 850B. If the system finds a scope node in one data structure matching the label of a data field node of the other data structure, the system rehomes each scope node with the label in question with the constraint that the rehomed label does not conflict with the label of any data field node.

As shown in FIG. 8B, the system generates a new data structure 810 with a root node 812. In the data structure 810, the data field nodes are all children of the root node 802. The notation used here is that “[foolbar]” means that on the first (left) input, the name resolves to the node with canonical name “foo” (if the left side of the bar is not empty) and the name resolves to the node with the canonical name “bar” on the second (right) input (if the right side of the bar is not empty). The system also uses this information to decide whether each new node should be a data field node or a scope node. The system does this by determining the common node type of all the nodes being unified (e.g., “Index” node is a data field node because it is a data field node in both input data structures 850A, 850B). Each of the nodes in the data structure 810 stores an indication of which of the two inputs to the gather component “E” the node originates from. In the example of FIG. 8B, the data field node connected by the edge labeled “Index” indicates that there is an Index field from both inputs to the gather component “E” with the name “[A. Index|C. Index]”. The scope node connected by the edge labeled “A” indicates that the scope “A” only arrives through a first input (the left side) and thus is named “A|”. The data field node connected by the edge labeled “X” indicates that the field “X” is available from both sides to the join component and thus has the name “B.X|D.X”. The scope node connected by the edge labeled “B” indicates that the scope “B” only arrives through the first input (the left side) and thus the scope node is labeled “B|”. The scope node connected by the edge labeled “C” indicates that the scope “C” only arrives through the second input (the right side) and thus the scope node is labeled “|C”. The data field node connected by the edge labeled “Y” indicates that the field arrives through the second input (the right side) through component “D” and thus the scope node is labeled “|D.y”. The scope node connected by the edge labeled “D” indicates that the field arrives through the second input (the right side) and thus the scope node is labeled “|D”. In some embodiments, if there is a name that is a data field node in one data structure and a scope node in the other, the system may generate an error.

Next, the system determines include edges that connect the root node 802 to the scope nodes that represent the scope of data fields that reach the gather component “E” through its two inputs. For each of the data structures 850A, 850B, the system identifies the unique scope node connected to its respective root node and identifies a scope node in the data structure 810 that has only that scope node as its corresponding bracketed tuple. In this example, “B” is the unique included scope node from the first data structure 850A corresponding to the first input (the left input), so the system identifies a scope node “[B|]” in the data structure 810 shown in FIG. 8B. In this case, the system finds it. The system adds an include from the root node 802 to the scope node “[B|]”. If it is not found, the system moves on to the next inflow. “D” is the unique included scope node from the second data structure 850B corresponding to the second input (the right input), so the system identifies a scope node “[|D]” in the data structure 810 shown in FIG. 8B. The resulting data structure 820 is shown in FIG. 8C. The data structure 820 has an include edge 822 from the root node 802 to the scope node “[B|]” and an include edge 824 from the root node 802 to the scope node “[|D]”.

Next, the system repeats the above steps for each scope node (based on the named edges and includes going out from the watch-all nodes in the appropriate bracketed tuple). For example, for the scope node labeled “A”, the system finds that an edge labeled “Index” should point to a data field node “[A.index|]”, which does not exist yet. Accordingly, the system generates a data field node “[A.index]”. For the scope node “B”, the system determines that an edge labeled “X” should point to a new data field node “[B.x|]” and generates such a data field node. The system further determines that the scope node “A” should point to a scope node “[A|]”. This already exists, so the system uses it rather than creating a new scope node. The system also finds that the scope node “B” should point to a scope node “[A|]”, which exists. Accordingly, the system adds an include edge between the scope node “[B|]” and the scope node “[A|”.

The system handles the scope nodes labelled “C” and “D” similarly as described for the scope nodes labeled “A” and “B”. The system determines that the scope node “D” includes the scope node “C” and thus generates an include edge from the scope node “D” to the scope node “C”. The system further determines that an edge “Y” from the scope node “D” should connect to a data field node “[|D. Y]”, which already exists in the data structure 820. The system makes the scope node “D” the parent of the data field node “[|D. Y]” and replaces all other child edges connected to it with link edges, preferring the scope node “D” as the parent over the root node 802. The system also prefers a scope node that was a parent of the data field node in the data structure 850B over another scope node. The system further determines that the scope node “D” is to via a child edge labeled “X” to a data field node “[|D.X]′. Accordingly, the system connects the scope node “D” to the data field node “[|D.X]” via an edge labeled “X”.

The resulting data structure 840 corresponding to the output of the gather component “B” is shown in FIG. 8E. Although in the example of FIG. 8E the nodes retain their bracketed-tuple names, in some embodiments, the system removes the bracketed-tuple names once the data structure 840 is generated. As shown in FIG. 8E, the resulting data structure 840 includes two data field nodes that are children of the root node 802. The two data field nodes are: (1) the data field node “[A.index|C.index]” representing the combination of the “Index” field from component “A” and the “Index” field from component “C”; and (2) the data field node “[B.x|D.x]” representing the combination of the “X” field from component “B” and the “X” field from component “D”. The data structure 840 further has a link edge “Y” between the root node 802 and the data field node “[|D.Y]” because the field “Y” does not conflict with any other data field node or scope node.

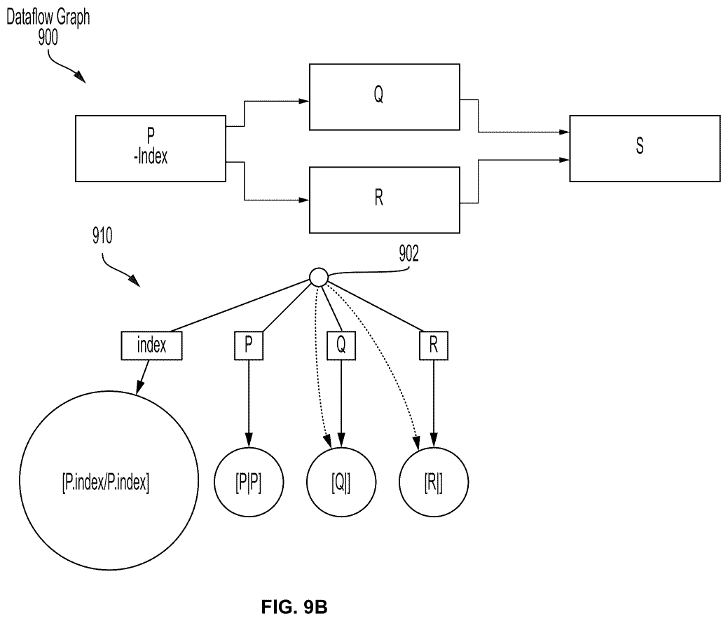

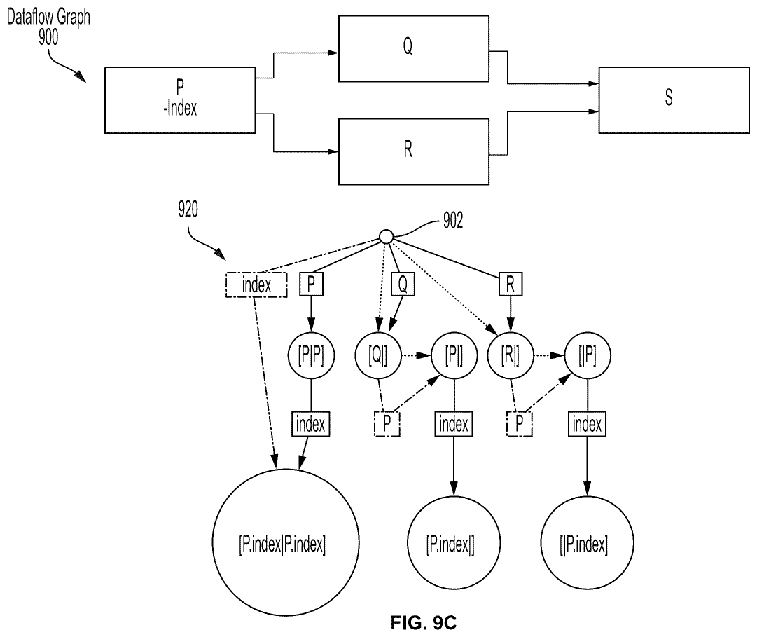

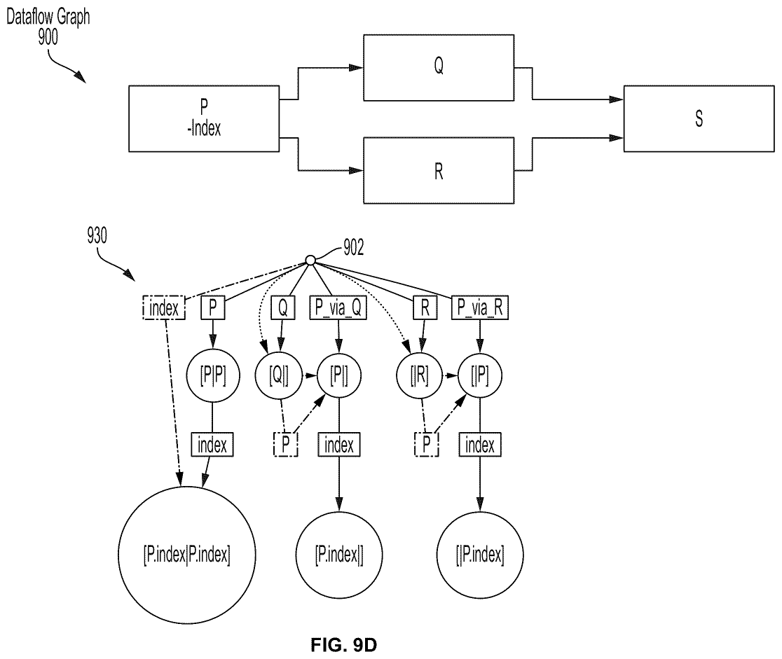

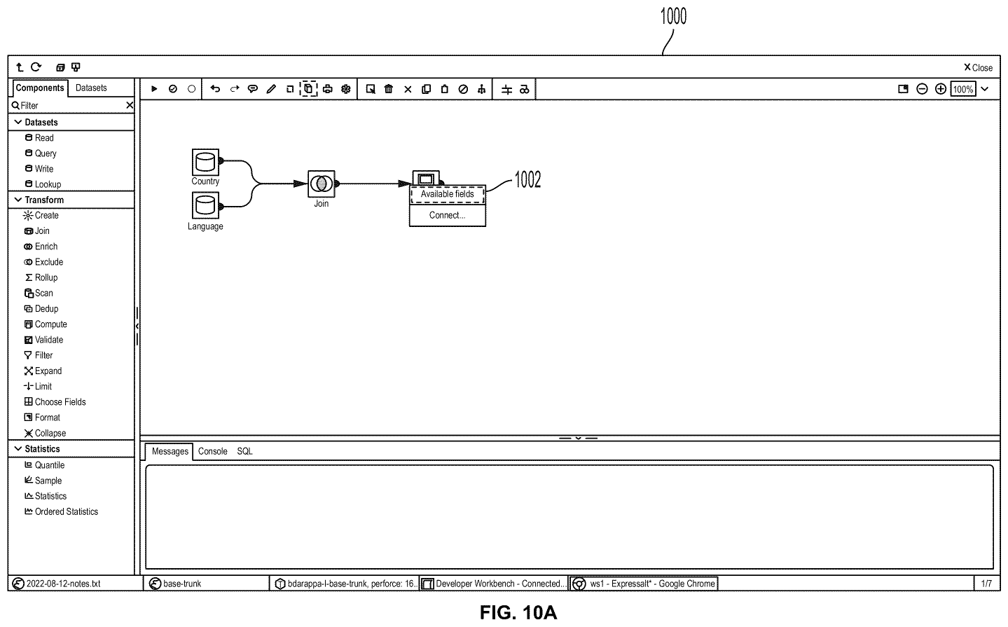

FIGS. 9A-9D illustrate another example of combining two data structures 950A, 950B to generate a data structure that indicates paths through which data fields reach the output of the gather component “S” in dataflow graph 900, according to some embodiments of the technology described herein. The dataflow graph 900 includes a component “P” that generates a field “Index” with two values of 1 and 2. The field “Index” flows to each of components “Q” and “R”. The output of component “Q” flows to a first input of gather component “S” and the output of component “R” flows to a second input of gather component “S”. The dataflow graph 900 can also be represented in code as shown below.

```
node 0 easy_create { label = “P”; param record_count = 2; }
  #introduces a field named index taking on the values 1, 2
node 1 easy_compute { label = “Q”; flow from node 0; }
node 2 easy_compute { label = “R”; flow from node 0; }
node 3 easy_compute { label = “S”; flow from node 1; flow from node
  2; }
```

FIG. 9A shows the data structures 950A, 950B corresponding to the two inputs to the gather component “S”. Data structure 950A corresponds to the output of component “Q” and data structure 950B corresponds to the output of component “R”. As shown in FIG. 9B, the system generates a new data structure 910 with a root node 902 that has labeled edges connecting the root node 902 to each unique scope node from the data structures 950A, 950B. The root node 902 is further connected by the edge “Index” to a new data field node “[P.index|P.index]” which refers to the field resulting from the combining the “Index” field flowing through the component “Q” and the “Index” field flowing through component “R”.

Once the system moves on to generating the edges from the three scope nodes, the system determines that since the bracketed-tuple at “[Q|]” is null on the right-hand side, the system determines that the name “P” at “Q” should correspond to a scope node “[P|]”, which does not exist. The system also determines that scope node “Q” should include such a node. Similarly at the scope node “R”, the system determines a need for a scope node corresponding to a scope node “[|P]”. The system generates these scope nodes, not yet connecting them to the root, and continues on to determining their named edges and include edges. The resulting data structure 920 is shown in FIG. 9C. The data structure 920 includes a new scope node “[P|]” connected by an include edge to the scope node labeled “Q” and a new scope node “[|P]” connected by an include edge to the scope node “R”. The scope node “[P|]” further has a child data field node “[P. Index|]” representing the “Index” field from component “P” that flows through component “Q” in the dataflow graph 900. The scope node “[|P]” has a child data field node “[|P. Index]” representing the “Index” field from component “P” that flows through component “R” in the dataflow graph 900.

Next, the system chooses canonical names for labeled edges of scope nodes that are not yet connected by a labeled edge to the root node 902. The system does this for a given scope node by starting from one of the scope nodes that has a link to the given scope node, at which the link edge-name must unambiguously refer to the scope to be placed, and following include edges backwards until the link edge-name becomes unambiguous or the system reaches the root. The scope immediately before either of these happen is called the disambiguator. In this case, starting from the scope node labeled “Q” and going backwards along blue include edges, the system reaches the root right away, so the disambiguator for “Q.P” is “Q”, and the disambiguator for “R.P” is “R”. In general, heading towards the root node 902 along the include edges means using a scope which is later in the dataflow graph, hence more likely to be relevant. The system then combines the link edge-name (“P”, in both cases) with the name of the disambiguator to get disambiguated scope nodess “P_via_Q” and “P_via_R”. Assuming these are available at the root node 902, the system uses them as labels of the child edges from the root node 902, leading to the final data structure 930 corresponding to the input of the gather component “S” shown in FIG. 9D. The data structure 930 includes scope nodes “P_via_Q” and “P_via_R”. These scope nodes disambiguate the “Index” field that reaches the gather component “S” through component “Q” and the “Index” field that reaches that gather component “S” through the component “R”.

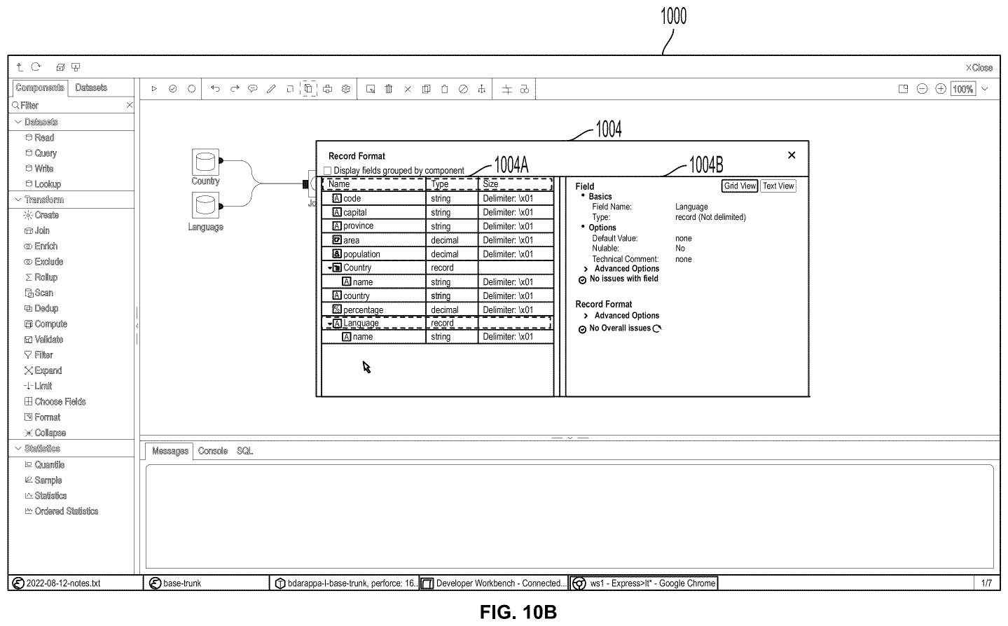

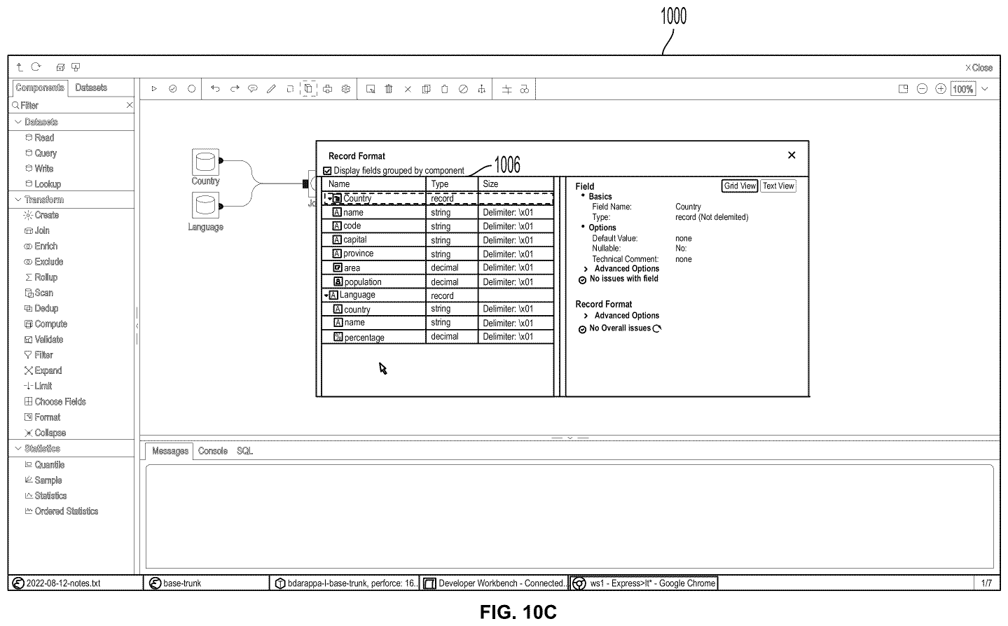

FIG. 10A shows an example GUI 1000 through which a user can provide input to specify a dataflow graph defining a SW application, according to some embodiments of the technology described herein. The dataflow graph includes two datasets “Country” and “Language” that are linked to a join component. The output of the join component is linked to a compute component.

FIG. 10B shows the GUI 1000 of FIG. 10A including a menu 1002 displayed in response to user selection of a point in the dataflow graph of FIG. 10A, according to some embodiments of the technology described herein. The selected point in the dataflow graph is the point at the output of the compute component. The menu 1002 displays an option to view available data fields at the point in the dataflow graph.

FIG. 10C shows the GUI 1000 of FIG. 10A with a display 1004 of references to data fields available at the point in the dataflow graph, according to some embodiments of the technology described herein. The display includes a listing 1004A of data field names along with attributes including the data type and size of each field. The display includes a section 1004B displaying additional information about a selected field. The listing 1004A disambiguates field with the same name by showing them underneath their source (which in this example is their source datasets). For example, the “name” field of the dataset “Country” is indicated a hierarchy as a field the “Country” dataset. Likewise, the “name” field of the dataset is indicated in a hierarchy as a field in the “Language” dataset. The view thus disambiguates the two data fields named “name” from one another.

In some embodiments, the display may show a hierarchical view with each data field name listed under its source dataset. The display may, for example, include the name of the data fields in each of the “Country” and “Language” datasets. The display may further show a data type for each of the data fields.

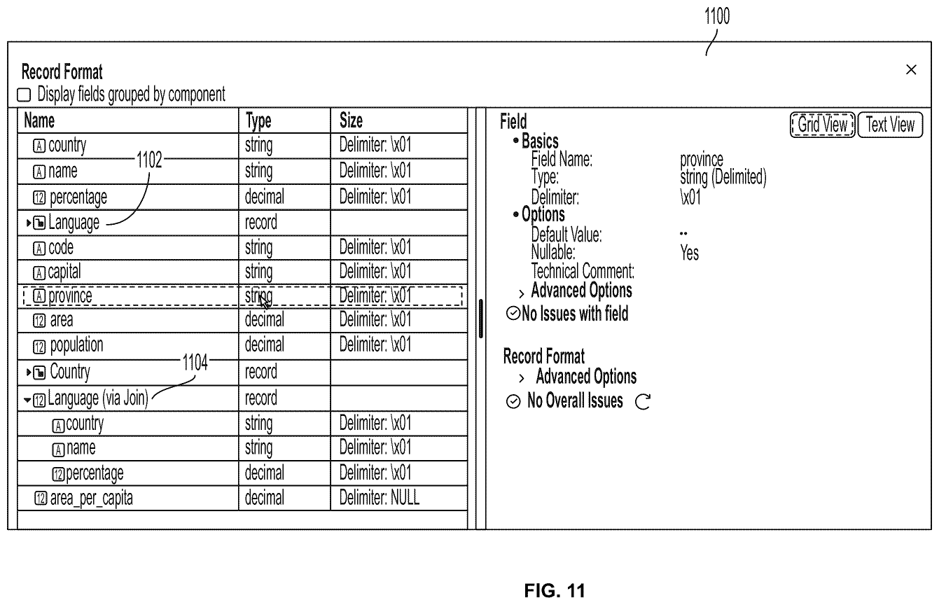

FIG. 11 shows an example display 1100 of references to data fields available at a point in a dataflow graph, according to some embodiments of the technology described herein. To disambiguate certain data fields, the system includes a hierarchical display 1102 showing a source dataset for some fields. The system also includes an indication 1104 of a component from which certain data fields reached a point. For example, the “via Join” string next to the “Language” dataset name indicates that the data fields listed under it arrived through the join component in a dataflow graph.

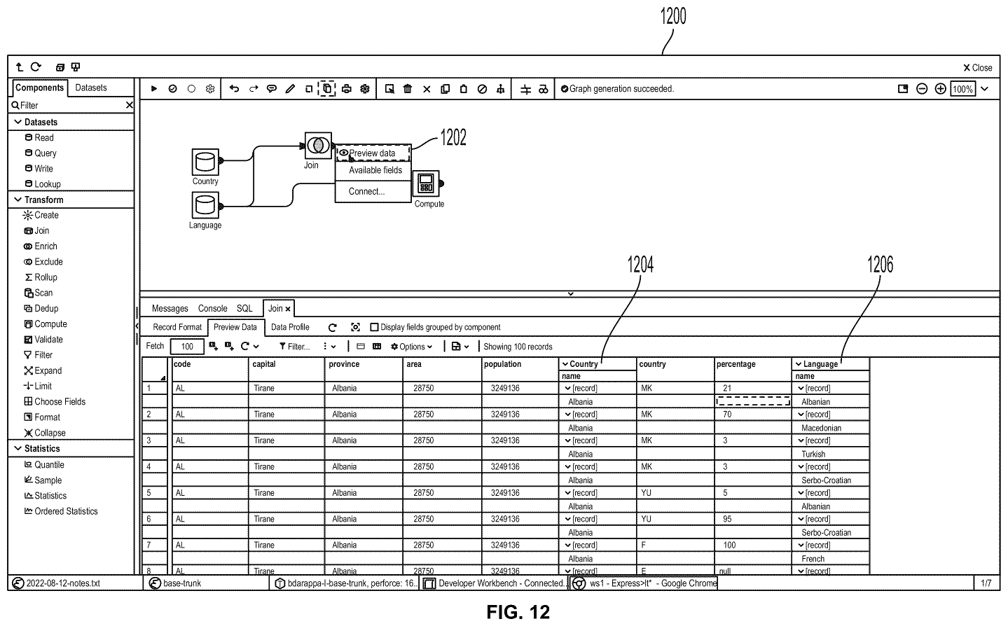

FIG. 12 shows a GUI 1420 displaying a preview of data from data fields available at a selected point in a dataflow graph, according to some embodiments of the technology described herein. The preview disambiguates data field names. The name field of the Country dataset is indicated at reference 1204 as being part of the country dataset while the name field of the Language dataset is indicated at reference 1206 as being part of the language dataset. The indication is done by creating an extra row in the column header.

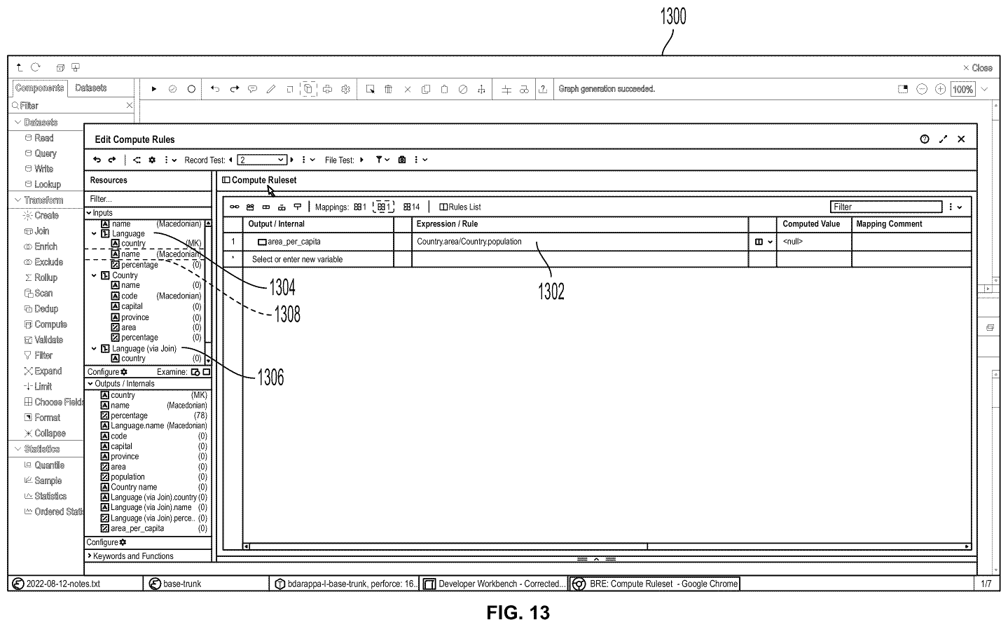

FIG. 13 shows a GUI 1300 for specifying an operation performed by a processing component of a dataflow graph, according to some embodiments of the technology described herein. The GUI 1300 includes an area 1302 for specifying an expression or rule for an operation to be performed by the component. The GUI 1300 displays available data fields for the component in a side pane. For example, the GUI 1300 indicates data fields of the dataset Language 1304. The GUI 1300 displays a value 1308 taken from a sample record from the dataset. The system also displays an indication 1306 of an instance of the Language dataset that arrives from a Join component (and thus may be different from the original Language dataset).

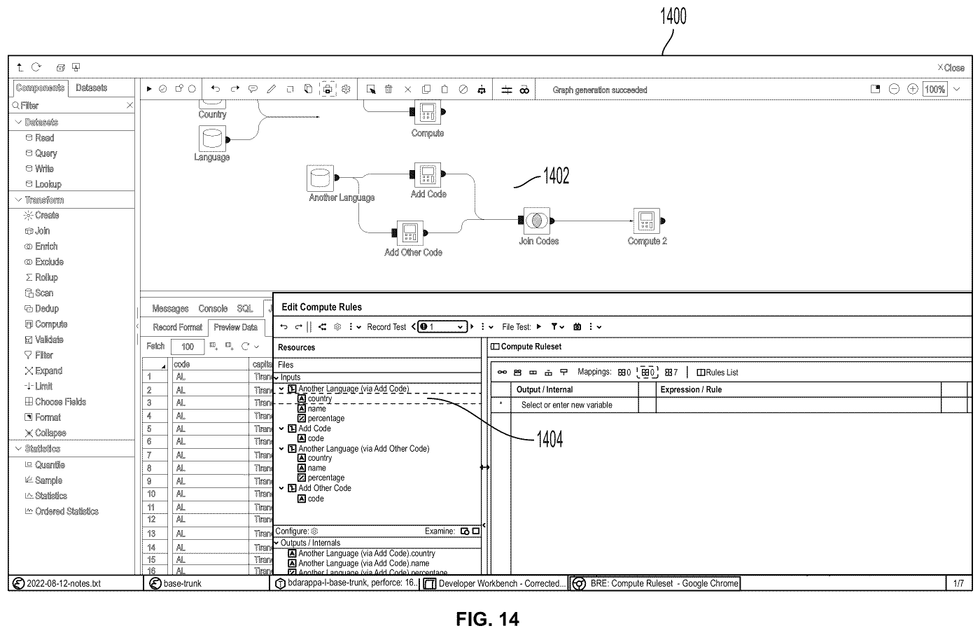

FIG. 14 shows another GUI 1400 for specifying an operation performed by a processing component of a dataflow graph, according to some embodiments of the technology described herein. The GUI 1400 includes a display 1404 of data fields available at an input of the “Compute 2” component in the dataflow graph 1402.

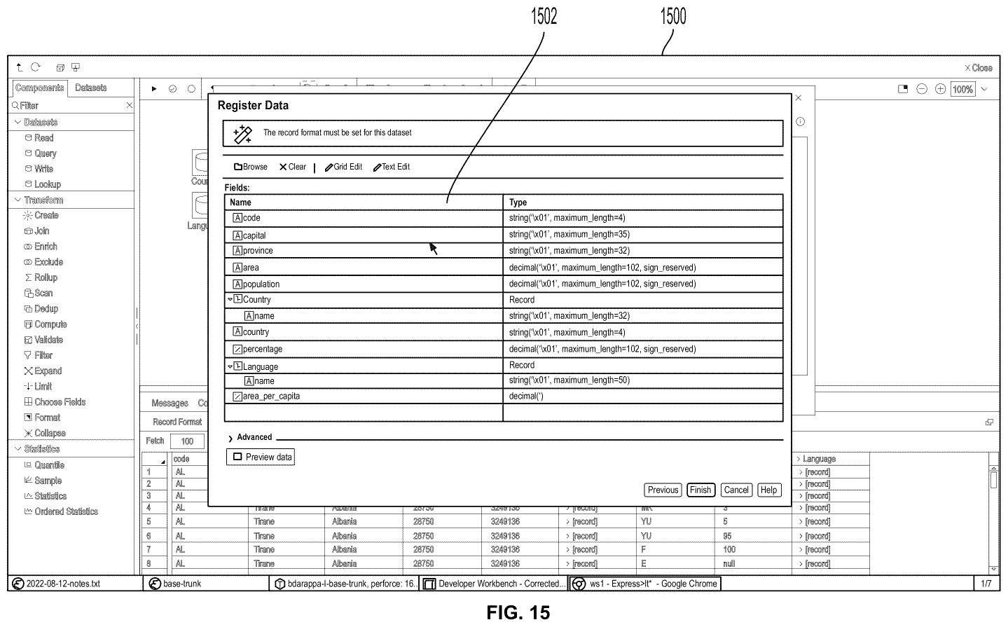

FIG. 15 shows a GUI 1500 with a suggested structure 1502 in which to store data output by a dataflow graph, according to some embodiments of the technology described herein. The structure is determined based on the data structure associated with a point at the output of the dataset. The fields of the suggested structure 1502 may be organized based on the data structure associated with the point.

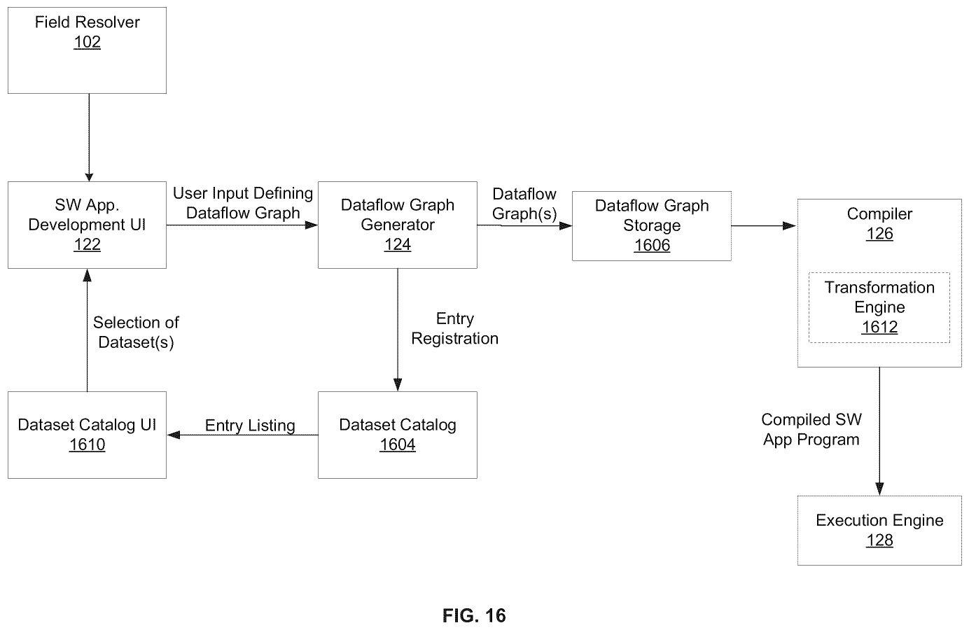

FIG. 16 shows interactions among the components of the data processing system 100 of FIGS. 2A-2B, according to some embodiments of the technology described herein. As shown in FIG. 16, the system modules perform graph generation and graph execution.

The software application development user interface module 122 may allow a user to develop a software application program as a dataflow graph (e.g., in a graphical development environment). The dataflow graph generator 124 may generate a dataflow graph based on a user definition in a GUI. The GUI may further allow a user to store a subgraph of a dataflow graph as a catalogued dataflow graph.

As shown in FIG. 16, the field resolver module 102 may interact with the SW application development UI module 122 to present data fields available at points in a dataflow graph to a user (e.g., as described herein with reference to FIGS. 2A-2E).

As shown in FIG. 16, a dataflow graph generated by the dataflow graph generator 124 may be stored in data storage of the data processing system 100. In some embodiments, the compiler module 126 may include a transformation engine 1612. A dataflow graph may be transformed by the transformation engine 1612 to obtain a transformed dataflow graph (e.g., an optimized version of another dataflow graph). The compiler module 126 may compile the transformed dataflow graph generated by the transformation engine 1612 to obtain a compiled software application program (e.g., an executable program), The execution engine 128 may then execute the compiled software application program.

In some embodiments, the field resolver module 102 may be used by the transformation engine 1612 to transform a dataflow graph to obtain a transformed dataflow graph. The transformation engine 1612 may use the field resolver module 102 to identify data fields from input dataset(s) that are not used in the dataflow graph. The transformation engine 1612 may optimize the dataflow graph by removing the data fields from processing of the dataflow graph. The transformation engine 1612 may: (1) use the field resolver module 102 to identify which fields are referenceable at points in the dataflow graph (e.g., by resolving the data fields available at each of the points); and (2) removing data fields that are not referenceable at the points in the dataflow graph. The transformation engine 1612 may thus use the field resolver module 102 to reduce the amount of data that needs to be processed when executing a software application compiled from the transformed dataflow graph relative to the original dataflow graph.

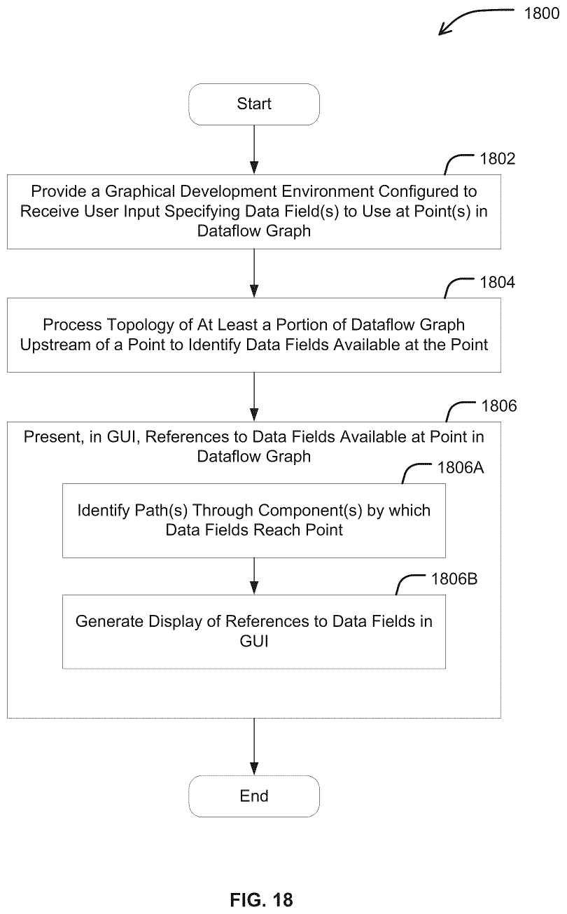

FIG. 18 shows an example process 1800 for presenting references to data fields available at a point in a dataflow graph displayed in a GUI of a software development environment, according to some embodiments of the technology described herein. In some embodiments, process 1800 may be performed by data processing system 100 described herein with reference to FIGS. 12 to 2E. For example, process 1800 may be performed by the field resolver module 102 of the data processing system 100 to present references to data fields available at a point in the dataflow graph 160 as described herein with reference to FIGS. 2A-2E.

Process 1800 begins at block 1802, where the system provides a graphical development environment configured to receive user input specifying data field(s) to use at point(s) in a dataflow graph. In some embodiments, the graphical development environment may include a GUI (e.g., SW application development GUI 142 described herein with reference to FIGS. 2A-2E). The GUI may receive user input specifying a dataflow graph. For example, the GUI may receive user input (e.g., mouse clicks, haptic input, keyboard inputs, and/or other inputs) specifying datasets (e.g., input datasets for use in downstream processing), processing components (e.g., join components, gather components, filter components, rollup components, user-defined operation components), and outputs where data is written into a location. The GUI may receive user input indicating data fields to use at components of the dataflow graph.

In some embodiments, the system may present the graphical development environment on a display of a user device. For example, the system may present the graphical development environment in a GUI of an application executed by the user device. As another example, the system may present the graphical development environment in a web application accessible through an Internet browser application.

Next, process 1800 proceeds to block 1804, where the system processes a topology of at least a portion of the dataflow graph upstream of a point to identify data fields available at the point. In some embodiments, the system may process the topology of at least the portion of the dataflow graph upstream of the point by generating a data structure indicating one or more paths through one or more components of the dataflow graph by which the data fields reach the point. Example techniques for generating such a data structure are described herein with reference to FIG. 4A to FIG. 9D.

In some embodiments, the system may process the topology of at least the portion of the dataflow graph as the system receives input specifying aspects of the dataflow graph. For example, the system may process the topology as a user adds in components to the dataflow graph and/or connects components in the dataflow graph. Accordingly, the system may dynamically process the topology of the dataflow graph as a user is developing a software application in the graphical development environment. In some embodiments, the system may periodically perform the processing to ensure that the identified data fields and references to the data fields are up to date. In some embodiments, the system may process the topology to identify the data fields available at the point in response to a command. For example, the system may perform the processing in response to a user command (e.g., to view the available data fields) at the point. As another example, the system may perform the processing in response to detecting a particular trigger condition (e.g., connection of a new component in the dataflow graph, saving of the dataflow graph, and/or another condition).

Next, process 1800 proceeds to block 1806, where the system presents, in the GUI, references to data fields available at the point in the data flow graph. Block 1806 includes two sub-blocks 1806A, 1806B.

At block 1806A, the system identifies one or more paths through one or more components of the dataflow graph by which the data fields reach the point. In some embodiments, the system may identify the path(s) in a data structure corresponding to the point that indicates the path(s). For example, the system may identify path(s) based on connections between a root node in the data structure and data field nodes in the data structure that represent the data fields.

At block 1806B, the system generates a display of the references to the data fields based on the path(s) through the component(s) of the dataflow graph by which the data fields reached the point. In some embodiments, the system may generate the display of references by: (1) determining a conflict between a name of a first data field and a name of a second data field (e.g., determining that the name of the first data field matches the name of the second data field); and (2) disambiguating the first data field from the second data field in the display. In some embodiments, the system may identify different paths in the dataflow graph by which different data fields reach the point and differentiate between the data fields based on their different paths (e.g., by identifying their respective source dataset(s) and/or source component(s) in the different paths).

For example, the system may disambiguate the data fields by determining source datasets of the data fields and indicating a source dataset of each data field in the display. For a data field that has an ambiguous name (e.g., because it matches the name of another data field), the system may indicate its source dataset (while not indicating source datasets of data fields that do not have ambiguous names). The system may identify the source dataset of a given data field in a path by which the data field reached the point.

As another example, the system may disambiguate data fields by determining source components of the data fields and indicating the source component(s) of each data field in the display (e.g., as a string indicating the source component(s)). The system may identify the source component(s) of a given data field in a path through which the data field reached the point.

In some embodiments, the system may generate the display of the references by: (1) accessing a data structure indicating paths in the dataflow graph through which the data fields reached the point; and (2) generating the display of the references to the data fields using the data structure. An example of using a data structure to determine references to data fields is described herein with reference to FIGS. 3A-3B.

In some embodiments, the system may generate the display of the references to the data fields available at the point in response to receiving user input requesting to view data fields available at the point. In some embodiments, the system may display information about the data fields in the display. For example, the system may display a data type of information stored in each of the data fields. To illustrate, the display may show a listing with a first column for data field names and a second column for data type associated with each data field name. In some embodiments, the system may generate the display of the references by generating a view in which references to the data fields are grouped by source dataset. For example, each data field may be listed in the view under a source dataset of the data field.

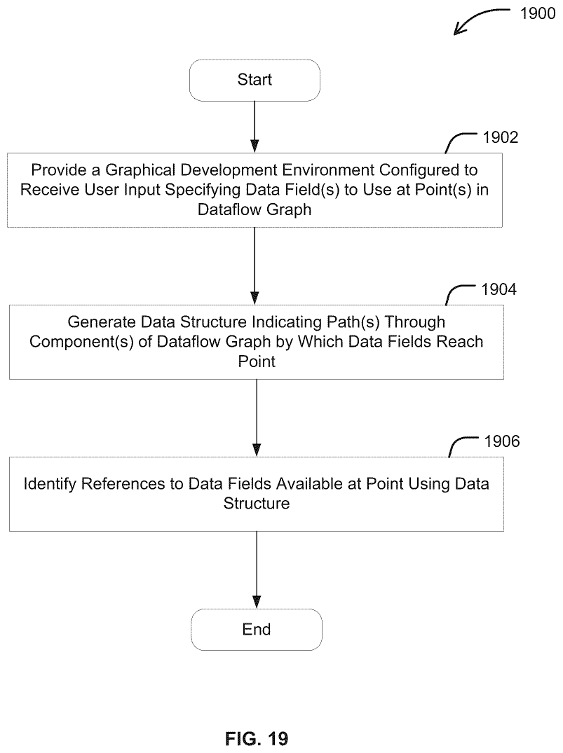

FIG. 19 shows an example process 1900 for processing a topology of at least a portion of a dataflow graph to identify data fields available at a point in the dataflow graph, according to some embodiments of the technology described herein. In some embodiments, process 1900 may be performed by data processing system 100 described herein with reference to FIGS. 2A-2E. For example, process 1900 may be performed by the field resolver module 102 of the data processing system 100 to present references to data fields available at a point in the dataflow graph 160. In some embodiments, process 1900 may be performed as part of process 1800 described with reference to FIG. 18. For example, process 1900 may be performed at block 1804 of process 1800.

Process 1900 begins at block 1902, where the system provides a graphical development environment configured to receive user input specifying data field(s) to use at point(s) in a dataflow graph. The system may provide a graphical development environment as described at block 1802 process 1800.

Next, process 1900 proceeds to block 1904, where the system generates a data structure indicating path(s) through component(s) of the dataflow graph by which data fields reach the point. The system may include, in the data structure, scope nodes representing scopes of data fields accessible by components in the dataflow graph and data field nodes representing the data fields available at the point. In some embodiments, the system may include, in the data structure, edges from which references can be identified for the data fields. In some embodiments, the data structure may be a tree structure that comprises a root node, one or more scope nodes, and data field nodes. The scope node(s) may be at a first level of the data tree structure and the data field nodes may be at a second level beneath the first level. The data structure may include edges/connections that form routes between the root node and the data field nodes. Example data structures and techniques of generating data structures are described herein with reference to FIG. 4A to FIG. 9D.

Next, process 1900 proceeds to block 1906, where the system identifies references to the data fields available at the point using the data structure. In some embodiments, the system may identify the references to the data fields by identifying routes between a root node of the data structure and the data fields. For each data field, the system may: (1) identify a shortest route (e.g., that has the fewest number of edges) between the root node and a data field node representing the data field; and (2) identify the reference to the data field based on the shortest route. For example, if there is a single edge between the root node and a data field node, the system may identify a reference to the data field to be the name of the data field node (e.g., the name of the data field). As another example, the system may identify a route to a data field node that traverses a scope node associated with a component. The system may identify a reference to the data field that indicates the component associated with the scope node (e.g., “B.X”). As another example, the system may identify a route to a data field that traverses a rehomed scope node. As another example, the system may identify a route to a data field node that indicates multiple components in a path through which a data field reaches the point. The system may identify a reference to the data field that indicates the multiple components in the path (e.g., “P_via_Q.X”).

After block 1906, process 1900 may end. In some embodiments, the identified references may be presented in the graphical development environment For example, the identified references may be presented as described at block 1806 of process 1800.

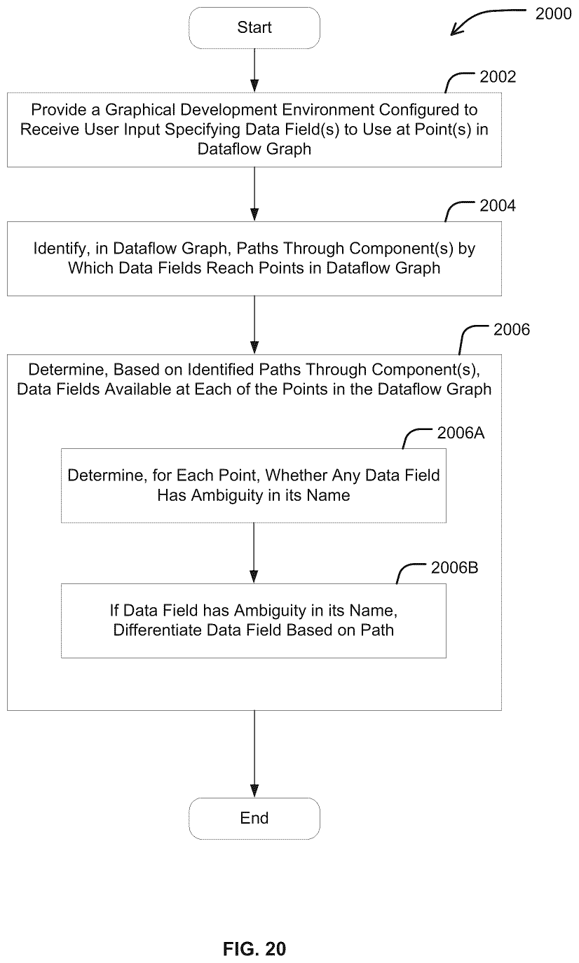

FIG. 20 shows an example process 2000 for determining data fields available at points in a dataflow graph, according to some embodiments of the technology described herein. In some embodiments, process 2000 may be performed by data processing system 100 described herein with reference to FIGS. 2A to 2E. For example, process 2000 may be performed by the field resolver module 102 of the data processing system 100 to determine data fields available at various points in the dataflow graph.

Process 2000 begins at block 2002, where the system provides a graphical development environment configured to receive user input specifying data field(s) to use at point(s) in the dataflow graph. The system may provide the graphical development environment as described at block 1802 of process 1800 described herein with reference to FIG. 18.

Next, process 2000 proceeds to block 2004, where the system identifies, in the dataflow graph, paths through component(s) of the dataflow graph by which data fields reach points in the dataflow graph. In some embodiments, the system may identify the paths by processing, for each point, a topology of a portion of the dataflow graph upstream of the point (e.g., by performing process 1900 described herein with reference to FIG. 19). For example, the system may perform the processing for each point to generate a data structure for the point that indicates data fields available at the point and paths through which the data fields reach the point. The data structure may indicate component(s) in each path.

In some embodiments, the system may generate a data structure for a point using one or more data structures generated for one or more upstream points in the dataflow graph. Thus, the system may propagate a data structure to a downstream point to generate a data structure for the downstream point. For example, the system may add to the data structure (e.g., as described herein with reference to FIG. 4A to FIG. 6). As another example, the system may combine multiple data structures from multiple upstream points (e.g., as described herein with reference to FIG. 7A to FIG. 7E). As another example, the system may use one or more data structures to generate a separate new data structure (e.g., as described herein with reference to FIG. 8A to FIG. 9D).

Next, process 2000 proceeds to block 2006, where the system determines, based on the identified paths, references to the data fields available at each of the points. Block 2006 includes two sub-blocks 2006A, 2006B.

At block 2006A, the system determines, for each point, whether any data field available at the point has ambiguity in its name. The system may determine whether the data field has the same name as another data field, has the same name as a component in the dataflow graph, and/or arrives at the point through multiple different paths with different components. In some embodiments, the system may determine whether the data field has ambiguity in its name at the point as part of generating a data structure for the point. The system may identify that two nodes of the data structure share the same name. For example, the system may identify that two data field nodes share the same name, that a data field node and a scope node share the same name, and/or that two scope nodes share the same name. As another example, the system may determine that a particular data field arrives at a point through multiple different paths that have different processing components.

At block 2006B, if a data field available at a point has ambiguity in its name, the system may differentiate the data field based on a path through which the data field reached the point. In some embodiments, the system may differentiate the data field by modifying edges in a data structure associated with the point to indicate references that differentiate the data field from other data field(s) and/or component(s). For example, the system may remove edge(s) in the data structure to eliminate the ambiguity. As another example, the system may rehome node(s) in the data structure to eliminate the ambiguity (e.g., so that a reference derived from the data structure indicates a path through which the data field reaches the point). Techniques for resolving ambiguities in data structures are described herein in descriptions of FIG. 4A to FIG. 9D.

### Example Embodiments

Some embodiments provide method, performed by a data processing system, for efficient development of a software application program that processes data from one or more datasets, the software application program developed as a dataflow graph having components representing operations and links representing flows of data, the method comprising: using at least one computer hardware processor to perform: providing a graphical development environment configured to receive user input specifying one or more data fields to use at one or more points in the dataflow graph, the graphical development environment including a graphical user interface (GUI) displaying the dataflow graph; processing a topology of at least a portion of the dataflow graph upstream of a point in the dataflow graph to identify a plurality of data fields available at the point in the dataflow graph; and presenting, in the GUI, references to the plurality of data fields available at the point in the dataflow graph, the presenting comprising: identifying one or more paths through one or more of the components of the dataflow graph by which the plurality of data fields reaches the point; and generating a display of the references to the plurality of data fields based on the one or more paths through one or more of the components of the dataflow graph by which the plurality of data fields reaches the point.

In some embodiments, generating the display of the references to the plurality of data fields based on the one or more paths through one or more of the components of the dataflow graph by which the plurality of data fields reaches the point comprises: determining that a name of a first one of the plurality of data fields that matches a name of a second one of the plurality of data fields; and when it is determined that the name of the first data field matches the name of the second data field, disambiguating the first data field from the second data field in the display.

In some embodiments, the first data field reaches the point through a first path of the one or more paths and the second data field reaches the point through a second path of the one or more paths. In some embodiments, disambiguating the first data field from the second data field in the display comprises: identifying a first source of the first data field in the first path and a second source of the second data field in the second path; and including, in the display, an indication that the first data field is from the first source and that the second data field is from the second source. In some embodiments, identifying the first source of the first data field in the first path and the second source of the second data field in the second path comprises: identifying, in the first path, a first upstream component as the first source of the first data field; and identifying, in the second path, a second upstream component as the second source of the second field. In some embodiments, identifying the first source of the first data field in the first path and the second source of the second data field in the second path comprises: identifying, in the first path, a first dataset as the first source of the first data field; and identifying, in the second path, a second dataset as the second source of the second field.

In some embodiments, presenting, in the GUI, references to the plurality of data fields available at the point in the dataflow graph comprises: accessing a data structure indicating paths in the dataflow graph through which data fields are accessed by one or more components in a portion of the dataflow graph upstream of the point; and generating the display of the references to the plurality of data fields using the data structure.

In some embodiments: identifying the one or more paths by which the plurality of data fields reaches the point comprises identifying at least one path indicated by the data structure through which at least one of the plurality of data fields reaches the point; and generating the display of the references to the plurality of data fields comprises generating the display of the references based on the at least one path indicated by the data structure. In some embodiments: generating the display of the references based on the at least one path indicated by the data structure comprises generating the display to show a name of the at least one data field in association with a source of the at least one data field. In some embodiments: the source of the at least one data field comprises a dataset from which the at least one data field is accessible. In some embodiments: the source of the at least one data field comprises at least one component of the dataflow graph through which the at least one data field reached the point.

In some embodiments, the method further comprises: receiving, through the GUI, user input indicating a request to view data fields that are available at the point; and presenting, in the GUI, the references to the plurality of data fields available at the point in response to receiving the user input indicating the request to view the data fields that are available at the point. In some embodiments, a first data field of the plurality of data fields is from a first source and a second data field of the plurality of data fields is from a second source, and generating the display of the references to the plurality of data fields based on the one or more paths in the dataflow graph through which the plurality of data fields reaches the point comprises: generating a view in which the references to the plurality of data fields are grouped by source, wherein a reference to the first data field is displayed in association with an identifier of the first source and a reference to the second data field is displayed in association with an identifier of the data source.

In some embodiments, generating the display of the references to the plurality of data fields based on the one or more paths in the dataflow graph through which the plurality of data fields reaches the point comprises: generating a view in which references to at least some of the plurality of data fields are displayed without association with a source. In some embodiments, the plurality of data fields includes first and second data fields, separate from the at least some data fields, with matching names, and generating the view further comprises: displaying, in the view, the first data field in association with an identifier of a source of the first data field and the second data field in association with an identifier of a source of the second data field.

Some embodiments provide a system for efficient development of a software application program that processes data from one or more datasets, the software application program developed as a dataflow graph having components representing operations and link representing flows of data, the system comprising: at least one processor; and at least one non-transitory computer-readable storage medium storing instructions that, when executed by the at least one processor, cause the at least one processor to perform: providing a graphical development environment configured to receive user input specifying one or more data fields to use at one or more points in the dataflow graph, the graphical development environment including a graphical user interface (GUI) displaying the dataflow graph; processing a topology of at least a portion of the dataflow graph upstream of a point in the dataflow graph to identify a plurality of data fields available at the point in the dataflow graph; and presenting, in the GUI, references to the plurality of data fields available at the point in the dataflow graph, the presenting comprising: identifying one or more paths through one or more of the components of the dataflow graph by which the plurality of data fields reaches the point; and generating a display of the references to the plurality of data fields based on the one or more paths through one or more of the components of the dataflow graph by which the plurality of data fields reaches the point.

Some embodiments provide at least one non-transitory computer-readable storage medium storing instructions that, when executed by at least one processor, cause the at least one processor to perform a method for efficient development of a software application program that processes data from one or more datasets, the software application program developed as a dataflow graph having components representing operations and links representing flows of data, the method comprising: providing a graphical development environment configured to receive user input specifying one or more data fields to use at one or more points in the dataflow graph, the graphical development environment including a graphical user interface (GUI) displaying the dataflow graph; processing a topology of at least a portion of the dataflow graph upstream of a point in the dataflow graph to identify a plurality of data fields available at the point in the dataflow graph; and presenting, in the GUI, references to the plurality of data fields available at the point in the dataflow graph, the presenting comprising: identifying one or more paths through one or more of the components of the dataflow graph by which the plurality of data fields reaches the point; and generating a display of the references to the plurality of data fields based on the one or more paths through one or more of the components of the dataflow graph by which the plurality of data fields reaches the point.

Some embodiments provide method, performed by a data processing system, for efficient development of a software application program that processes data from one or more data sources, the software application program developed as a dataflow graph having components representing operations and links representing flows of data, the method comprising: using at least one computer hardware processor to perform: providing a graphical development environment configured to receive user input specifying one or more data fields to use at one or more points in the dataflow graph, the graphical development environment including a graphical user interface (GUI) displaying the dataflow graph; and processing a topology of at least a portion of the dataflow graph upstream of a point in the dataflow graph to identify a plurality of data fields available at the point in the dataflow graph, the processing comprising: identifying different paths in the dataflow graph by which two of the plurality of data fields reach the point, the two data fields sharing a common name; and differentiating between the two data fields based on the different paths by which the two data fields reach the point.

Some embodiments provide a system for efficient development of a software application program that processes data from one or more datasets, the software application program developed as a dataflow graph having components representing operations and links representing flows of data, the system comprising: at least one processor; and at least one non-transitory computer-readable storage medium storing instructions that, when executed by the at least one processor, cause the at least one processor to perform: providing a graphical development environment configured to receive user input specifying one or more data fields to use at one or more points in the dataflow graph, the graphical development environment including a graphical user interface (GUI) displaying the dataflow graph; and processing a topology of at least a portion of the dataflow graph upstream of a point in the dataflow graph to identify a plurality of data fields available at the point in the dataflow graph, the processing comprising: identifying different paths in the dataflow graph by which two of the plurality of data fields reach the point, the two data fields sharing a common name; and differentiating between the two data fields based on the different paths by which the two data fields reach the point.

Some embodiments provide at least one non-transitory computer-readable storage medium storing instructions that, when executed by at least one processor, cause the at least one processor to perform a method for efficient development of a software application program that processes data from one or more datasets, the software application program developed as a dataflow graph having components representing operations and links representing flows of data, the method comprising: providing a graphical development environment configured to receive user input specifying one or more data fields to use at one or more points in the dataflow graph, the graphical development environment including a graphical user interface (GUI) displaying the dataflow graph; and processing a topology of at least a portion of the dataflow graph upstream of a point in the dataflow graph to identify a plurality of data fields available at the point in the dataflow graph, the processing comprising: identifying different paths in the dataflow graph by which two of the plurality of data fields reach the point, the two data fields sharing a common name; and differentiating between the two data fields based on the different paths by which the two data fields reach the point.

Some embodiments provide a method, performed by a data processing system, for efficient development of a software application program that processes data from one or more data sources, the software application program developed as a dataflow graph having components representing operations and links representing flows of data, the method comprising: using at least one computer hardware processor to perform: providing a graphical development environment configured to receive user input specifying one or more data fields to use at one or more point in the dataflow graph, the graphical development environment including a graphical user interface (GUI) displaying the dataflow graph; processing a topology of at least a portion of the dataflow graph upstream of a point in the dataflow graph to identify a plurality of data fields available at the point, the processing comprising: generating a data structure indicating one or more paths through one or more components of the dataflow graph by which the plurality of data fields reach the point; and identifying references to the plurality of data fields available at the point using the data structure; and presenting, in the GUI, the references to the plurality of data fields available at the point.

In some embodiments, the data structure is a tree data structure. In some embodiments, the data structure indicates a scope of data fields accessible by each of one or more components in the portion of the dataflow graph upstream of the point. In some embodiments, the data structure includes a first level comprising a first plurality of nodes each representing a respective scope of data fields accessible by a respective component in the dataflow graph. In some embodiments, the data structure includes connections among the first plurality of nodes of the first level, each of the connections representing a path through which one component of the dataflow graph accesses a scope of data fields of another component of the dataflow graph. In some embodiments, the data structure includes a second level comprising a second plurality of nodes, each of the second plurality of nodes representing a respective one of the plurality of data fields available at the point in the dataflow graph. In some embodiments, the data structure includes a root node and a plurality of connections among nodes of the data structure, the plurality of connections forming routes between the root node and the second plurality of nodes in the second level.

In some embodiments, identifying the references to the plurality of data fields available at the point using the data structures comprises identifying paths by which the plurality of data fields reach the point in the data structure.

In some embodiments, identifying the references to the plurality of data fields available at the point using the data structure comprises, for each of the second plurality of nodes: identifying a route in the data structure between the root node and the node; and generating a reference to a respective data field represented by the node based on the identified route.

In some embodiments, a route between the root node and a particular node of the second plurality of nodes is formed by a direct connection between the root node and the particular node, and identifying the references to the plurality of data fields available at the point using the data structure comprises: setting a reference to a data field represented by the particular node as a name of the data field.

In some embodiments, a route between the root node and a particular node of the second plurality of nodes is formed by a first connection between the root node and a first one of the first plurality of nodes of the first level and a second connection between the first node and the particular node, and identifying the references to the plurality of data fields available at the point using the data structure comprises: identifying, in the data structure, a reference to a data field represented by the particular node that indicates that the data field reaches the point through a component associated with the first node.

In some embodiments, the method further comprises: detecting a change in an existing component in the portion of the dataflow graph upstream of the point; and in response to detecting the change, performing the processing of the topology of at least the portion of the dataflow graph that is upstream of the point to identify the plurality of data fields available at the point. In some embodiments, detecting the change comprises detecting user input, through the GUI, indicating an addition of a component and/or configuration of an existing component in the portion of the dataflow graph upstream of the point.

In some embodiments, the method further comprises: after performing the processing of the topology of at least the portion of the dataflow graph that is upstream of the point to identify the plurality of data fields available at the point: receiving, through the GUI, user input indicating an update to the portion of the dataflow graph that is upstream of the point; and in response to receiving the user input, processing of the topology of at least the portion of the dataflow graph that is upstream of the point to identify an updated plurality data fields available at the point and updated paths in the dataflow graph through which the updated plurality of data fields reach the point.

Some embodiments provide a system for efficient development of a software application program that processes data from one or more data sources, the software application program developed as a dataflow graph having components representing operations and links representing flows of data, the system comprising: at least one processor; and at least one non-transitory computer-readable storage medium storing instructions that, when executed by the at least one processor, cause the at least one processor to perform: providing a graphical development environment configured to receive user input specifying one or more data fields to use at one or more point in the dataflow graph, the graphical development environment including a graphical user interface (GUI) displaying the dataflow graph; processing a topology of at least a portion of the dataflow graph upstream of a point in the dataflow graph to identify a plurality of data fields available at the point, the processing comprising: generating a data structure indicating one or more paths through one or more components of the dataflow graph by which the plurality of data fields reach the point; and identifying references to the plurality of data fields available at the point using the data structure; and presenting, in the GUI, the references to the plurality of data fields available at the point.

Some embodiments provide at least one non-transitory computer-readable storage medium storing instructions that, when executed by at least one processor, cause the at least one processor to perform a method for efficient development of a software application program that processes data from one or more data sources, the software application program developed as a dataflow graph having components representing operations and links representing flows of data, the method comprising: providing a graphical development environment configured to receive user input specifying one or more data fields to use at one or more point in the dataflow graph, the graphical development environment including a graphical user interface (GUI) displaying the dataflow graph; processing a topology of at least a portion of the dataflow graph upstream of a point in the dataflow graph to identify a plurality of data fields available at the point, the processing comprising: generating a data structure indicating one or more paths through one or more components of the dataflow graph by which the plurality of data fields reach the point; and identifying references to the plurality of data fields available at the point using the data structure; and presenting, in the GUI, the references to the plurality of data fields available at the point.

Some embodiments provide a method, performed by a data processing system, for efficient development of a software application program that processes data from one or more data sources, the software application program developed as a dataflow graph having components representing operations and links representing flows of data, the method comprising: using at least one computer hardware processor to perform: providing a graphical development environment configured to receive user input specifying one or more data fields to use at one or more points in the dataflow graph, the graphical development environment including a graphical user interface (GUI) displaying the dataflow graph; identifying, in the dataflow graph, paths through one or more components of the dataflow graph by which data fields reach a plurality of points in the dataflow graph; and determining, based on the paths through one or more components of the dataflow graph by which the data fields reach the plurality of points in the dataflow graph, data fields available at each of the plurality of points in the dataflow graph, the determining comprising: for each of the plurality of points: determining whether any data field available at the point shares its name with another data field available at the point; and when it is determined that at least two data fields available at the point share a common name, differentiating the at least two data fields based on respective source datasets and/or paths in the dataflow graph from which the at least two data fields arrive at the point.

In some embodiments, determining, based on the through one or more components of the dataflow graph by which the data fields reach the plurality of points in the dataflow graph, the data fields available at each of the plurality of points in the dataflow graph comprises: determining a first set of data fields available at a first point and a second set of data fields available at a second point, wherein the first set of data fields is different from the second set of data fields.

In some embodiments, determining, based on the through one or more components of the dataflow graph by which the data fields reach the plurality of points in the dataflow graph, the data fields available at each of the plurality of points in the dataflow graph comprises: for each of the plurality of points: generating a data structure indicating one or more paths through which a respective set of one or more data fields reached the point; and determining references to the respective set of one or more data fields for display in the GUI.

In some embodiments, identifying, in the dataflow graph, paths through one or more components of the dataflow graph by which data fields reach a plurality of points in the dataflow graph comprises: identifying a first set of one or more paths by which a first set of one or more data fields reaches a first one of the plurality of points by processing a topology of a first portion of the dataflow graph upstream of the first point; and identifying a second set of one or more paths by which a second set of one or more data fields reaches a second one of the plurality of points downstream of the first point using results of processing the topology of the first portion of the dataflow graph upstream of the first point.

In some embodiments, processing the topology of the first portion of the dataflow graph upstream of the first point comprises generating a first data structure indicating the first set of one or more paths by which the first set of one or more data fields reaches the first point; and identifying the second set of one or more paths by which the second set of one or more data fields reaches the second point using results of processing the topology of the first portion of the dataflow graph upstream of the first point comprise generating a second data structure indicating the second set of one or more paths by which the second set of one or more data fields reaches the second point using the first data structure.

In some embodiments, generating the second data structure indicating the second set of one or more paths by which the second set of one or more data fields reaches the second point using the first data structure comprises updating the first data structure to obtain the second data structure.

Some embodiments provide a system for efficient development of a software application program that processes data from one or more data sources, the software application program developed as a dataflow graph having components representing operations and links representing flows of data, the system comprising: at least one processor; and at least one non-transitory computer-readable storage medium storing instructions that, when executed by the at least one processor, cause the at least one processor to perform: providing a graphical development environment configured to receive user input specifying one or more data fields to use at one or more points in the dataflow graph, the graphical development environment including a graphical user interface (GUI) displaying the dataflow graph; identifying, in the dataflow graph, paths through one or more components of the dataflow graph by which data fields reach a plurality of points in the dataflow graph; and determining, based on the paths through one or more components of the dataflow graph by which the data fields reach the plurality of points in the dataflow graph, data fields available at each of the plurality of points in the dataflow graph, the determining comprising: for each of the plurality of points: determining whether any data field available at the point shares its name with another data field available at the point; and when it is determined that at least two data fields available at the point share a common name, differentiating the at least two data fields based on respective source datasets and/or paths in the dataflow graph from which the at least two data fields arrive at the point.

Some embodiments provide at least one non-transitory computer-readable storage medium storing instructions that, when executed by at least one processor, cause the at least one processor to perform a method for efficient development of a software application program that processes data from one or more data sources, the software application program developed as a dataflow graph having components representing operations and links representing flows of data, the method comprising: providing a graphical development environment configured to receive user input specifying one or more data fields to use at one or more points in the dataflow graph, the graphical development environment including a graphical user interface (GUI) displaying the dataflow graph; identifying, in the dataflow graph, paths through one or more components of the dataflow graph by which data fields reach a plurality of points in the dataflow graph; and determining, based on the paths through one or more components of the dataflow graph by which the data fields reach the plurality of points in the dataflow graph, data fields available at each of the plurality of points in the dataflow graph, the determining comprising: for each of the plurality of points: determining whether any data field available at the point shares its name with another data field available at the point; and when it is determined that at least two data fields available at the point share a common name, differentiating the at least two data fields based on respective source datasets and/or paths in the dataflow graph from which the at least two data fields arrive at the point.

### Example Computer System

FIG. 21 illustrates an example of a suitable computing system environment 2100 on which the technology described herein may be implemented. The computing system environment 2100 is only one example of a suitable computing environment and is not intended to suggest any limitation as to the scope of use or functionality of the technology described herein. Neither should the computing environment 2100 be interpreted as having any dependency or requirement relating to any one or combination of components illustrated in the exemplary operating environment 2100.

The technology described herein is operational with numerous other general purpose or special purpose computing system environments or configurations. Examples of well-known computing systems, environments, and/or configurations that may be suitable for use with the technology described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The technology described herein may also be practiced in distributed computing environments where tasks are performed by remote processing devices that are linked through a communications network. In a distributed computing environment, program modules may be located in both local and remote computer storage media including memory storage devices.

With reference to FIG. 21, an exemplary system for implementing the technology described herein includes a general purpose computing device in the form of a computer 2110. Components of computer 2110 may include, but are not limited to, a processing unit 2120, a system memory 2130, and a system bus 2121 that couples various system components including the system memory to the processing unit 2120. The system bus 2121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus, Computer 2110 typically includes a variety of computer readable media.

Computer readable media can be any available media that can be accessed by computer 2110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 2110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 2130 includes computer storage media in the form of volatile and/or nonvolatile memory such as read only memory (ROM) 2131 and random access memory (RAM) 2132. A basic input/output system 2133 (BIOS), containing the basic routines that help to transfer information between elements within computer 2110, such as during start-up, is typically stored in ROM 2131. RAM 2132 typically contains data and/or program modules that are immediately accessible to and/or presently being operated on by processing unit 2120. By way of example, and not limitation, FIG. 19 illustrates operating system 2134, application programs 2135, other program modules 2136, and program data 2137.

The computer 2110 may also include other removable/non-removable, volatile/nonvolatile computer storage media. By way of example only, FIG. 19 illustrates a hard disk drive 2141 that reads from or writes to non-removable, nonvolatile magnetic media, a flash drive 2151 that reads from or writes to a removable, nonvolatile memory 2152 such as flash memory, and an optical disk drive 2155 that reads from or writes to a removable, nonvolatile optical disk 2156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 2141 is typically connected to the system bus 2121 through a non-removable memory interface such as interface 2140, and magnetic disk drive 2151 and optical disk drive 2155 are typically connected to the system bus 2121 by a removable memory interface, such as interface 2150.

The drives and their associated computer storage media described above and illustrated in FIG. 21, provide storage of computer readable instructions, data structures, program modules and other data for the computer 2110. In FIG. 19, for example, hard disk drive 2141 is illustrated as storing operating system 2144, application programs 2145, other program modules 2146, and program data 2147. Note that these components can either be the same as or different from operating system 2134, application programs 2135, other program modules 2136, and program data 2137. Operating system 2144, application programs 2145, other program modules 2146, and program data 2147 are given different numbers here to illustrate that, at a minimum, they are different copies. An actor may enter commands and information into the computer 2110 through input devices such as a keyboard 2162 and pointing device 2161, commonly referred to as a mouse, trackball or touch pad. Other input devices (not shown) may include a microphone, joystick, game pad, satellite dish, scanner, or the like. These and other input devices are often connected to the processing unit 2120 through a user input interface 2160 that is coupled to the system bus, but may be connected by other interface and bus structures, such as a parallel port, game port or a universal serial bus (USB). A monitor 2191 or other type of display device is also connected to the system bus 2121 via an interface, such as a video interface 2190. In addition to the monitor, computers may also include other peripheral output devices such as speakers 2197 and printer 2196, which may be connected through an output peripheral interface 2195.

The computer 2110 may operate in a networked environment using logical connections to one or more remote computers, such as a remote computer 2180. The remote computer 2180 may be a personal computer, a server, a router, a network PC, a peer device or other common network node, and typically includes many or all of the elements described above relative to the computer 2110, although only a memory storage device 2181 has been illustrated in FIG. 19. The logical connections depicted in FIG. 19 include a local area network (LAN) 2171 and a wide area network (WAN) 2173, but may also include other networks. Such networking environments are commonplace in offices, enterprise-wide computer networks, intranets and the Internet.

When used in a LAN networking environment, the computer 2110 is connected to the LAN 2171 through a network interface or adapter 2170. When used in a WAN networking environment, the computer 2110 typically includes a modem 2172 or other means for establishing communications over the WAN 2173, such as the Internet. The modem 2172, which may be internal or external, may be connected to the system bus 2121 via the actor input interface 2160, or other appropriate mechanism. In a networked environment, program modules depicted relative to the computer 2110, or portions thereof, may be stored in the remote memory storage device. By way of example, and not limitation, FIG. 21 illustrates remote application programs 2185 as residing on memory device 2181. It will be appreciated that the network connections shown are exemplary and other means of establishing a communications link between the computers may be used.

The techniques described herein may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

Having thus described several aspects of at least one embodiment of the technology described herein, it is to be appreciated that various alterations, modifications, and improvements are possible.

For example, any suitable type of GUI element may be used in the various GUIs described herein. As another example, the techniques described herein may be used to discover keys for any suitable type of relational dataset or other type of dataset.

Such alterations, modifications, and improvements are intended to be part of this disclosure, and are intended to be within the spirit and scope of disclosure. Further, though advantages of the technology described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. However, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, aspects of the technology described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments described above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the technology as described above. As used herein, the term “computer-readable storage medium” encompasses only a non-transitory computer-readable medium that can be considered to be a manufacture (i.e., article of manufacture) or a machine. Alternatively or additionally, aspects of the technology described herein may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the technology as described above. Additionally, it should be appreciated that according to one aspect of this embodiment, one or more computer programs that when executed perform methods of the technology described herein need not reside on a single computer or processor, but may be distributed in a modular fashion amongst a number of different computers or processors to implement various aspects of the technology described herein.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the technology described herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the technology described herein may be embodied as a method, of which examples are provided herein including with reference to FIGS. 18 to 20. The acts performed as part of any of the methods may be ordered in any suitable way.

Accordingly, embodiments may be constructed in which acts are performed in an order different than illustrated, which may include performing some acts simultaneously, even though shown as sequential acts in illustrative embodiments.

Further, some actions are described as taken by an “actor” or a “user”. It should be appreciated that an “actor” or a “user” need not be a single individual, and that in some embodiments, actions attributable to an “actor” or a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, performed by a data processing system, for efficient development of a software application program that processes data from one or more datasets, the software application program developed as a dataflow graph having components representing operations and links representing flows of data, the method comprising:
using at least one computer hardware processor to perform:
providing a graphical development environment configured to receive user input specifying one or more data fields to use at one or more points in the dataflow graph, the graphical development environment including a graphical user interface (GUI) displaying the dataflow graph;
processing a topology of at least a portion of the dataflow graph upstream of a point in the dataflow graph to identify a plurality of data fields available at the point in the dataflow graph; and
presenting, in the GUI, references to the plurality of data fields available at the point in the dataflow graph, the presenting comprising:
identifying one or more paths through one or more of the components of the dataflow graph by which the plurality of data fields reaches the point; and
generating a display of the references to the plurality of data fields based on the one or more paths through one or more of the components of the dataflow graph by which the plurality of data fields reaches the point.

2. The method of claim 1, wherein generating the display of the references to the plurality of data fields based on the one or more paths through one or more of the components of the dataflow graph by which the plurality of data fields reaches the point comprises;
determining that a name of a first one of the plurality of data fields that matches a name of a second one of the plurality of data fields; and
when it is determined that the name of the first data field matches the name of the second data field, disambiguating the first data field from the second data field in the display.

3. The method of claim 2, wherein the first data field reaches the point through a first path of the one or more paths and the second data field reaches the point through a second path of the one or more paths.

4. The method of claim 3, wherein disambiguating the first data field from the second data field in the display comprises:
identifying a first source of the first data field in the first path and a second source of the second data field in the second path; and
including, in the display, an indication that the first data field is from the first source and that the second data field is from the second source.

5. The method of claim 4, wherein identifying the first source of the first data field in the first path and the second source of the second data field in the second path comprises:
identifying, in the first path, a first upstream component as the first source of the first data field; and
identifying, in the second path, a second upstream component as the second source of the second field.

6. The method of claim 4, wherein identifying the first source of the first data field in the first path and the second source of the second data field in the second path comprises:
identifying, in the first path, a first dataset as the first source of the first data field; and
identifying, in the second path, a second dataset as the second source of the second field.

7. The method of claim 1, wherein presenting, in the GUI, references to the plurality of data fields available at the point in the dataflow graph comprises:
accessing a data structure indicating paths in the dataflow graph through which data fields are accessed by one or more components in a portion of the dataflow graph upstream of the point; and
generating the display of the references to the plurality of data fields using the data structure.

8. The method of claim 7, wherein:
identifying the one or more paths by which the plurality of data fields reaches the point comprises identifying at least one path indicated by the data structure through which at least one of the plurality of data fields reaches the point; and
generating the display of the references to the plurality of data fields comprises generating the display of the references based on the at least one path indicated by the data structure.

9. The method of claim 8, wherein:
generating the display of the references based on the at least one path indicated by the data structure comprises generating the display to show a name of the at least one data field in association with a source of the at least one data field.

10. The method of claim 9, wherein the source of the at least one data field comprises a dataset from which the at least one data field is accessible.

11. The method of claim 9, wherein the source of the at least one data field comprises at least one component of the dataflow graph through which the at least one data field reached the point.

12. The method of claim 1, further comprising:
receiving, through the GUI, user input indicating a request to view data fields that are available at the point; and
presenting, in the GUI, the references to the plurality of data fields available at the point in response to receiving the user input indicating the request to view the data fields that are available at the point.

13. The method of claim 1, wherein a first data field of the plurality of data fields is from a first source and a second data field of the plurality of data fields is from a second source, and generating the display of the references to the plurality of data fields based on the one or more paths in the dataflow graph through which the plurality of data fields reaches the point comprises:
generating a view in which the references to the plurality of data fields are grouped by source, wherein a reference to the first data field is displayed in association with an identifier of the first source and a reference to the second data field is displayed in association with an identifier of the data source.

14. The method of claim 1, wherein generating the display of the references to the plurality of data fields based on the one or more paths in the dataflow graph through which the plurality of data fields reaches the point comprises:
generating a view in which references to at least some of the plurality of data fields are displayed without association with a source.

15. The method of claim 14, wherein the plurality of data fields includes first and second data fields, separate from the at least some data fields, with matching names, and generating the view further comprises:
displaying, in the view, the first data field in association with an identifier of a source of the first data field and the second data field in association with an identifier of a source of the second data field.

16. A system for efficient development of a software application program that processes data from one or more datasets, the software application program developed as a dataflow graph having components representing operations and link representing flows of data, the system comprising:
at least one processor; and
at least one non-transitory computer-readable storage medium storing instructions that, when executed by the at least one processor, cause the at least one processor to perform:
providing a graphical development environment configured to receive user input specifying one or more data fields to use at one or more points in the dataflow graph, the graphical development environment including a graphical user interface (GUI) displaying the dataflow graph;
processing a topology of at least a portion of the dataflow graph upstream of a point in the dataflow graph to identify a plurality of data fields available at the point in the dataflow graph; and
presenting, in the GUI, references to the plurality of data fields available at the point in the dataflow graph, the presenting comprising:
identifying one or more paths through one or more of the components of the dataflow graph by which the plurality of data fields reaches the point; and
generating a display of the references to the plurality of data fields based on the one or more paths through one or more of the components of the dataflow graph by which the plurality of data fields reaches the point.

17. The system of claim 16, wherein generating the display of the references to the plurality of data fields based on the one or more paths through one or more of the components of the dataflow graph by which the plurality of data fields reaches the point comprises:
determining that a name of a first one of the plurality of data fields that matches a name of a second one of the plurality of data fields; and
when it is determined that the name of the first data field matches the name of the second data field, disambiguating the first data field from the second data field in the display.

18. The system of claim 17, wherein the first data field reaches the point through a first path of the one or more paths and the second data field reaches the point through a second path of the one or more paths.

19. The system of claim 18, wherein disambiguating the first data field from the second data field in the display comprises:
identifying a first source of the first data field in the first path and a second source of the second data field in the second path; and
including, in the display, an indication that the first data field is from the first source and that the second data field is from the second source.

20. At least one non-transitory computer-readable storage medium storing instructions that, when executed by at least one processor, cause the at least one processor to perform a method for efficient development of a software application program that processes data from one or more datasets, the software application program developed as a dataflow graph having components representing operations and links representing flows of data, the method comprising:
providing a graphical development environment configured to receive user input specifying one or more data fields to use at one or more points in the dataflow graph, the graphical development environment including a graphical user interface (GUI) displaying the dataflow graph;
processing a topology of at least a portion of the dataflow graph upstream of a point in the dataflow graph to identify a plurality of data fields available at the point in the dataflow graph; and
presenting, in the GUI, references to the plurality of data fields available at the point in the dataflow graph, the presenting comprising:
identifying one or more paths through one or more of the components of the dataflow graph by which the plurality of data fields reaches the point; and
generating a display of the references to the plurality of data fields based on the one or more paths through one or more of the components of the dataflow graph by which the plurality of data fields reaches the point.
